(19) United States
(12) Patent Application Publication
(10) Pub. No.: US 2026/0303844 A1
(43) Pub. Date: Oct. 1, 2026

(54) INFORMATION PROCESSING APPARATUS AND METHOD

(71) Applicant: Sony Group Corporation, Tokyo (JP)

(72) Inventors: Mitsuhiro HIRABAYASHI, Tokyo (JP); Mitsuru KATSUMATA, Tokyo (JP)

(73) Assignee: Sony Group Corporation, Tokyo (JP)

(21) Appl. No.: 19/481,176

(22) PCT Filed: Jun. 18, 2024
(86) PCT No.: PCT/JP2024/021961

§ 371 Date: Nov. 4, 2025

Related U.S. Application Data
(60) Provisional application No. 63/522,457, filed on Jun. 22, 2023.
(60) Provisional application No. 63/522,748, filed on Jun. 23, 2023.

(51) Int. Cl. H04N 19/423; G06F 16/178; H04N 19/70

(52) U.S. Cl. CPC H04N 19/423; G06F 16/178; H04N 19/70

(57) ABSTRACT

The present disclosure relates to an information processing apparatus and method that enable unauthorized reproduction of an asynchronous media to be suppressed.

Media encoded data of an asynchronous media and asynchronous media information that indicates that media data is of the asynchronous media and requires parsing for reproducing the asynchronous media are stored in a container file. Further, the asynchronous media information is parsed, the media encoded data of the asynchronous media is decoded in accordance with a result of the parsing and a reproduction condition, media data obtained by the decoding is rendered to generate output information, and an output unit is caused to output the output information, as reproduction of the asynchronous media. The present disclosure can be applied to, for example, an information processing apparatus, an information processing method, and the like.

### TECHNICAL FIELD

The present disclosure relates to an information processing apparatus and method, more particularly, to an information processing apparatus and method that enable unauthorized reproduction of an asynchronous media to be suppressed.

### BACKGROUND ART

From the past, there has been ISOBMFF (International Organization for Standardization Base Media File Format) as a container format for storing media typified by images, sounds, and the like (see, for example, Non-Patent Literatures 1 to 4), for example. As a format conforming to this ISOBMFF, a format (Image File Format) for storing a still image, which is one frame of encoded video data, has also been proposed (see, for example, Non-Patent Literature 5).

Incidentally, as the media, in addition to images, sounds, and the like, there is also a haptics media, which expresses a tactile sense and/or the like by vibration, for example. As a reproduction method for this haptics media, for example, an interaction-type reproduction method in which reproduction is executed with some kind of an event being a trigger is applied in many cases.

There has been proposed a method of extending “sync track reference” so as to handle an asynchronous media to which such interaction-type reproduction is applied in ISOBMFF (i.e., a method that realizes the interaction-type reproduction of media using ISOBMFF) (see, for example, Non-Patent Literature 6 and Patent Literature 1).

### CITATION LIST

### Non-Patent Literature

Non-Patent Literature 1:“14496-12_Ed8_DIS_potential_improvements”, ISO/IEC JTC 1/SC 29/WG 03 N22316 , WG3_N000792, 2023 Feb. 11
Non-Patent Literature 2:“Revised Text of ISO/IEC FDIS 14496-15 6th edition Carriage of NAL unit structured video in the ISO Base Media File Format”, ISO/IEC JTC 1/SC 29/WG 03 N0561 , WG3_N00561 (WG3_N00234), 2022 Apr. 29
Non-Patent Literature 3: David Singer, “Text of ISO/IEC FDIS 14496-14 2nd edition including minor revision”, ISO/IEC JTC1/SC29/WG11 MPEG01/N17593, W18729, 2019 Jul. 12
Non-Patent Literature 4:“Text of ISO/IEC CD 23090-32 Carriage of haptics data”, ISO/IEC JTC 1/SC 29/WG 7 N868, WG3_N00868, 2023 May 10
Non-Patent Literature 5:“Information technology-MPEG systems technologies-Part 12: Image File Format”, ISO/IEC JTC 1/SC 29/WG 3 MPEG N20585, ISO/IEC 23008-12:2022(E), WG3_N00749, 140th MPEG meeting, July 2022, Mainz, 2022-09
Non-Patent Literature 6: Mitsuhiro Hirabayashi, Kazunobu Ohkuri (Sony Corporation), “[Haptics] [7.3] [ISOBMFF] On signalling for event-based haptics and other interactive media in ISOBMFF”, ISO/IEC JTC 1/SC 29/WG 3 m 62599, 142nd MPEG meeting, April 2023, Antalya

### Patent Literature

Patent Literature 1: WO 2023/204289

### DISCLOSURE OF INVENTION

### Technical Problem

Incidentally, a track reference box is a box that indicates a relationship between tracks. Therefore, when unable to interpret a signal indicating the relationship between tracks, a reproduction device should not reproduce that track that cannot be interpreted. However, there has been no description in the conventional standard regarding such a behavior of the reproduction device. Therefore, there has been a fear that the reproduction device will execute reproduction while ignoring the relationship between tracks that is indicated in the track reference box. Therefore, there has been a fear that the reproduction device will incorrectly reproduce an asynchronous media.

The present disclosure has been made in view of the circumstances as described above, and aims at enabling unauthorized reproduction of an asynchronous media to be suppressed.

### Solution to Problem

An information processing apparatus according to an aspect of the present technology is an information processing apparatus including: an encoding unit which encodes media data of an asynchronous media to be reproduced asynchronously, to generate media encoded data; and a file generation unit which generates a container file and stores the media encoded data and asynchronous media information in the container file, in which the asynchronous media information indicates that the media data is of the asynchronous media, and requires parsing for reproducing the asynchronous media.

An information processing method according to an aspect of the present technology is an information processing method including: encoding media data of an asynchronous media to be reproduced asynchronously, to generate media encoded data; and generating a container file and storing the media encoded data and asynchronous media information in the container file, in which the asynchronous media information indicates that the media data is of the asynchronous media, and requires parsing for reproducing the asynchronous media.

An information processing apparatus according to another aspect of the present technology is an information processing apparatus including: a parse processing unit which parses asynchronous media information stored in a container file; a decoding unit which decodes media encoded data stored in the container file in accordance with a result of the parsing and a reproduction condition, to generate media data of an asynchronous media to be reproduced asynchronously; and an output control unit which renders the media data to generate output information, and causes an output unit to output the output information, as reproduction of the asynchronous media, in which the asynchronous media information indicates that the media data is of the asynchronous media, and requires the parsing for reproducing the asynchronous media.

An information processing method according to another aspect of the present technology is an information processing method including: parsing asynchronous media information stored in a container file; decoding media encoded data stored in the container file in accordance with a result of the parsing and a reproduction condition, to generate media data of an asynchronous media to be reproduced asynchronously; and rendering the media data to generate output information, and causing the output information to be output, as reproduction of the asynchronous media, in which the asynchronous media information indicates that the media data is of the asynchronous media, and requires the parsing for reproducing the asynchronous media.

In the information processing apparatus and method according to the aspect of the present technology, media data of an asynchronous media to be reproduced asynchronously is encoded, to generate media encoded data, and a container file is generated so as to store the media encoded data and asynchronous media information in the container file. The asynchronous media information indicates that the media data is of the asynchronous media. It is essential to parse the asynchronous media information for reproducing the asynchronous media.

In the information processing apparatus and method according to the another aspect of the present technology, asynchronous media information stored in a container file is parsed, media encoded data stored in the container file is decoded in accordance with a result of the parsing and a reproduction condition, to generate media data of an asynchronous media to be reproduced asynchronously, and the media data is rendered to generate output information, and the output information is caused to be output, as reproduction of the asynchronous media. The asynchronous media information indicates that the media data is of the asynchronous media. It is essential to parse the asynchronous media information for reproducing the asynchronous media.

### BRIEF DESCRIPTION OF DRAWINGS

FIG. 1 A diagram showing an example of a box structure of ISOBMFF.

FIG. 2 Diagrams each showing an example of a multi-track structure.

FIG. 3 A diagram for explaining a handler type.

FIG. 4 A diagram for explaining a fragment movie.

FIG. 5 A diagram showing an example of a structure in a sample table box.

FIG. 6 Diagrams for explaining flag information set in a sample group description box.

FIG. 7 Diagrams for explaining an essential sample group description.

FIG. 8 Diagrams each showing an example of codec information.

FIG. 9 Diagrams each showing an example of the codec information.

FIG. 10 Diagrams each showing an example of the codec information.

FIG. 11 A diagram for explaining a sync track reference.

FIG. 12 A diagram for explaining an image file format.

FIG. 13 A diagram for explaining an asynchronous media notification method that uses a sync track reference.

FIG. 14 A diagram showing an example of the asynchronous media notification method.

FIG. 15 Diagrams showing an example of an asynchronous media notification method that uses a handler type.

FIG. 16 A diagram showing an example of the asynchronous media notification method.

FIG. 17 Diagrams for explaining an asynchronous media notification method that uses an essential track reference.

FIG. 18 A diagram for explaining an example of a state where a track reference is referenced by the essential track reference.

FIG. 19 Diagrams for explaining the asynchronous media notification method that uses the essential track reference.

FIG. 20 A diagram for explaining an example of a state where the track reference is referenced by the essential track reference.

FIG. 21 A diagram for explaining an example of a definition of the flag information in the sample group description box.

FIG. 22 A diagram showing an example of the asynchronous media notification method.

FIG. 23 Diagrams each showing an example of a timed meta item property.

FIG. 24 Diagrams showing an example of ss_flags, as well as time information, access information, and the like of sub-samples.

FIG. 25 Diagrams for explaining details of sub_sample_flags.

FIG. 26 A diagram showing an example of a state of storing a timed meta item.

FIG. 27 Diagrams for explaining an initial value setting of the time information and access information of sub-samples.

FIG. 28 A diagram showing an example of the asynchronous media notification method.

FIG. 29 Diagrams each showing an example of the timed meta item property.

FIG. 30 Diagrams showing an example of time information, access information, and the like of a sample.

FIG. 31 A diagram showing an example of the state of storing a timed meta item.

FIG. 32 Diagrams for explaining the initial value setting of the time information and access information of a sample.

FIG. 33 A diagram showing a configuration example of a Matryoshka media container.

FIG. 34 A block diagram showing a main configuration example of a file generation device.

FIG. 35 A flowchart showing an example of a flow of file generation processing.

FIG. 36 A flowchart showing an example of the flow of the file generation processing.

FIG. 37 A flowchart showing an example of the flow of the file generation processing.

FIG. 38 A block diagram showing a main configuration example of a reproduction device.

FIG. 39 A flowchart showing an example of a flow of reproduction processing.

FIG. 40 A flowchart showing an example of the flow of the reproduction processing.

FIG. 41 A flowchart showing an example of the flow of the reproduction processing.

FIG. 42 A flowchart showing an example of the flow of the reproduction processing.

FIG. 43 A block diagram showing a main configuration example of a computer.

### MODES FOR CARRYING OUT THE INVENTION

Hereinafter, modes for carrying out the present disclosure (hereinafter, will be referred to as embodiments) will be described. It is noted that descriptions will be given in the following order.
1. Literatures that support technical contents and technical terms, etc.
2. Media distribution technology
3. Method 1
4. Method 1-1
5. Method 1-2
6. Method 2
7. Method 3
8. Combination
9. Matryoshka media container
10. First embodiment (file generation device)
11. Second embodiment (reproduction device)
12. Notes

### 1. Literatures That Support Technical Contents and Technical Terms, etc.

The range disclosed in the present technology includes not only contents described in the embodiments but also contents described in the following non-patent literatures and the like that have already been known at the time of the application, contents of other literatures that are referenced in the following non-patent literatures, and the like.
Non-Patent Literature 1: (described above)
Non-Patent Literature 2: (described above)
Non-Patent Literature 3: (described above)
Non-Patent Literature 4: (described above)
Non-Patent Literature 5: (described above)
Non-Patent Literature 6: (described above)
Patent Literature 1: (described above)
In other words, the contents described in any of the non-patent literatures and patent literature described above, the contents of other literatures that are referenced in the non-patent literatures or patent literature described above, and the like also become grounds in determining supporting conditions. For example, even in a case where a syntax or term described in any of the non-patent literatures and patent literature described above is not directly defined in the present disclosure, the syntax or term is within the scope of the present disclosure and satisfies the supporting conditions in the scope of claims. Similarly, for example, technical terms such as parsing, syntax, and semantics are also within the scope of the present disclosure and satisfy the supporting conditions in the scope of claims even when not directly defined in the present disclosure.

### 2 . Media Distribution Technology

### ISOBMFF

From the past, there has been ISOBMFF (International

Organization for Standardization Base Media File Format) as a container format for storing media typified by images, sounds, and the like as described in, for example, Non-Patent Literatures 1 to 4.

ISOBMFF stores data of a media (also referred to as media data) and management information of the media data. The management information may include, for example, time information, access information, codec information, and the like of the media data. ISOBMFF is a general-purpose file format that does not depend on a media type or a type of codec. ISOBMFF is widely used as, for example, a recording format for video data, a content distribution format, and the like. It is noted that in the present specification, encoded data generated by encoding media data will also be referred to as media encoded data. In addition, a file that stores media data or media encoded data will also be referred to as a media file. In addition, a file that stores a media file will also be referred to as a container file. For example, ISOBMFF described above is (a standard related to) a format of the container file. It is noted that in the present specification, a container file conforming to this ISOBMFF will also be referred to as an ISOBMFF file.

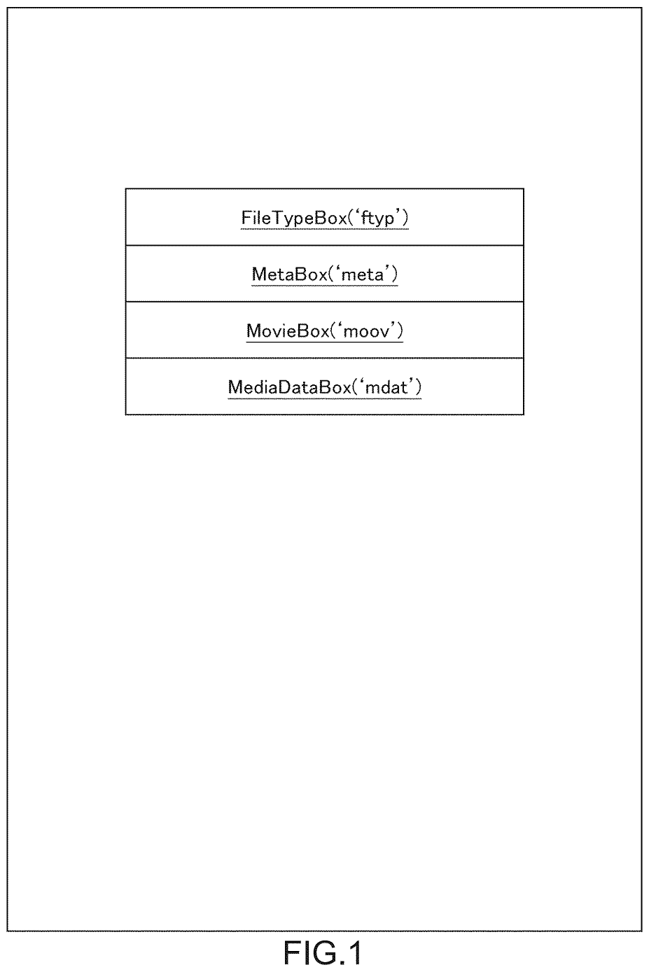

At a file level of ISOBMFF, four boxes, that is, a file type box (FileTypeBox(‘ftyp’)), a meta box (MetaBox(‘meta’)), a movie box (MovieBox(‘moov’)), and a media data box (MediaDataBox(‘mdat’)), are defined as shown in FIG. 1.

The file type box (FileTypeBox(‘ftyp’)) is a box that stores brand information indicating a type of a box group used in a file. The meta box (MetaBox(‘meta’)) is a box that stores metadata. The MetaBox is optional. The meta box may also be defined under the movie box or under a track box (TrackBox) under the movie box. The movie box (MovieBox(‘moov’)) is a box that stores management information of media data, such as time information, access information, and codec information. The codec information is defined by a different standard for each codec. The media data box (MediaDataBox(‘mdat’)) is a box that stores media data. The access information of the media data (e.g., offset, size, and the like) is defined under the movie box.

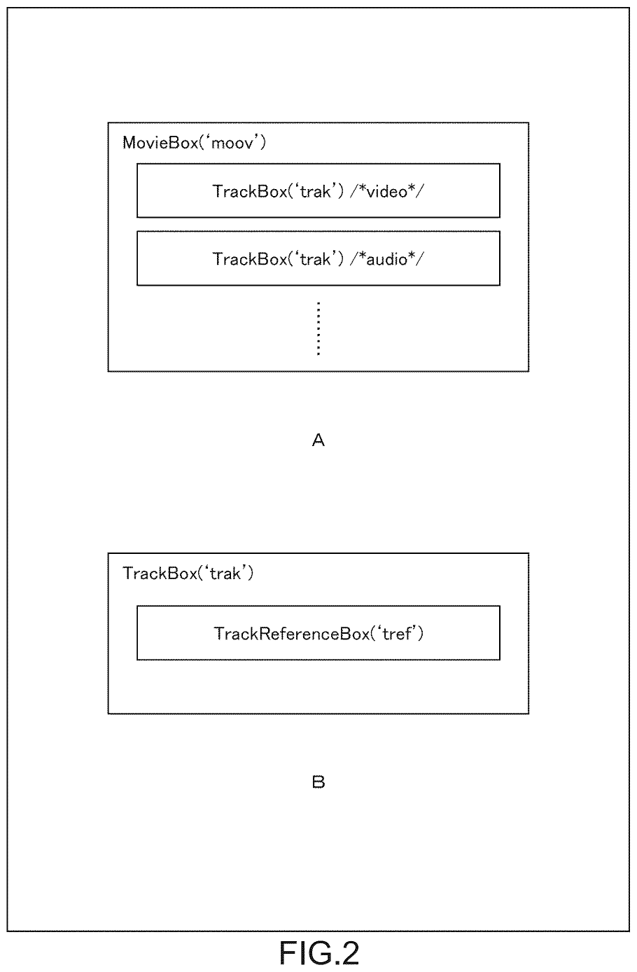

In the ISOBMFF file, the media data is managed in a track (Track). A track box (TrackBox(‘trak’)) is a box that stores track information. As shown in FIG. 2A, a plurality of track boxes can be stored in a movie box. That is, the media data can be managed while being divided into a plurality of tracks. In the example shown in FIG. 2A, a track box (TrackBox(‘trak’)/*video*/) that manages video media data and a track box (TrackBox(‘trak’)/*audio*/) that manages audio media data are stored in the movie box. In the present specification, the video media data refers to media data of a still image and/or a moving image. The audio media data refers to media data of audio. With the configuration constituted of the plurality of tracks as described above, it is possible to manage reproduction of a media of each track.

The media of each track can also be reproduced in synchronization with a predetermined common clock (i.e., a progression (change) of a scene (a state in a three-dimensional space) in a time direction). In the present specification, such a reproduction method will also be referred to as synchronous reproduction. For example, the synchronous reproduction includes reproduction of media such as sounds, images, vibration, and the like that is executed in conjunction with a state of a scene change involving a time change, such as a state where wind blows or a state where a 3D object moves (so as to express that state of a scene change). Further, the media to be reproduced synchronously will also be referred to as a synchronous media.

Further, the plurality of tracks can be reproduced in synchronization without being synchronized with such a common clock (the state of a scene change). In the present specification, such a reproduction method will also be referred to as asynchronous reproduction. For example, there is an interaction-type reproduction method in which a media is reproduced when a predetermined condition is satisfied in a scene by a user operation and/or the like. That is, in the interaction-type reproduction, a media is reproduced with respect to a predetermined event. For example, in a case where an avatar of a user touches a 3D object, in a case where the avatar moves a 3D object, in a case where the avatar collides with a 3D object, and the like, media such as sounds, images, vibration, and the like are reproduced so as to express senses in such cases. Such interaction-type reproduction is included in this asynchronous reproduction. Further, the media to be reproduced asynchronously will also be referred to as an asynchronous media.

When synchronizing other tracks, as shown in FIG. 2B, a track reference box (TrackReferenceBox(‘tref’)) for indicating a relationship between the tracks is defined in the track box. According to information in this track reference box, a media of this track is reproduced in synchronization with the reproduction of media of other tracks. It is noted that when the track reference box is not stored, the media of that track is reproduced synchronously as a default operation.

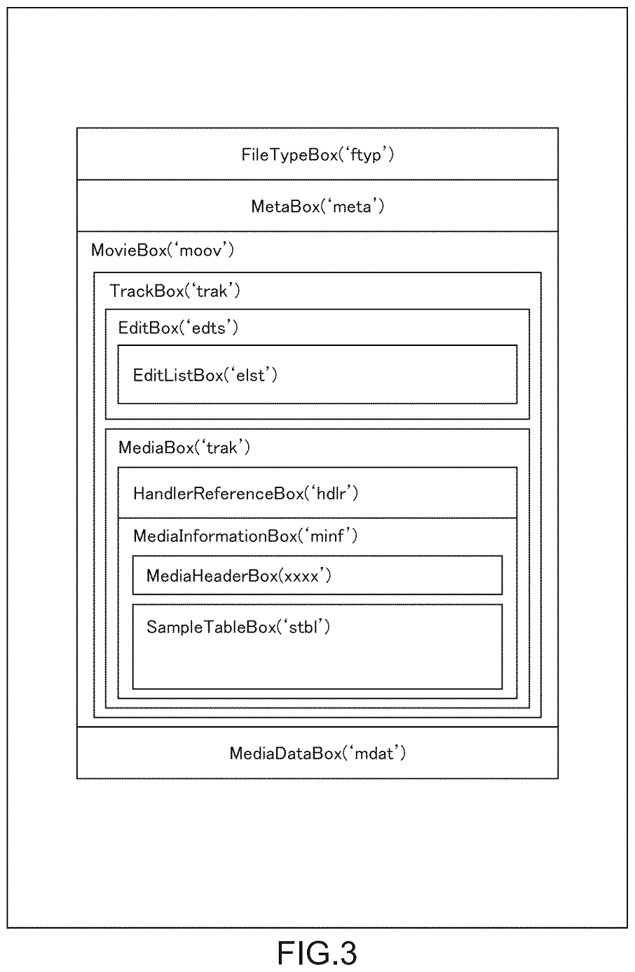

Further, as shown in FIG. 3, a media box (MediaBox(‘trak’)) is defined in the track box. A handler reference box (HandlerReferenceBox(‘hdlr’)) is defined in the media box. In the handler reference box, information called a handler type (HandlerType) indicating a media type is defined. For example, the handler type of a video media such as a still image or a moving image is defined as ‘vide’. The handler type of an audio media such as audio is defined as ‘soun’. The handler type of a text media such as text data is defined as ‘text’. The handler type of a haptics media such as vibration is defined as ‘hapt’. Of course, these are mere examples, and any handler type may be defined for any media.

Furthermore, in the media box, a media information box (MediaInformationBox(‘minf’)) that stores information related to the media is defined. For example, in the media information box, a media header box (MediaHeaderBox(‘xxxx’)) that stores header information of the media is defined for each media based on the handler type described above. For example, header information of a video media will also be referred to as a video media header. Header information of an audio media will also be referred to as an audio media header. Header information of a text media and/or haptics media will also be referred to as a null media header.

Furthermore, a sample table box (SampleTabkeBox(‘stbl’)) is defined in the media box. A sample description box (SampleDescriptionBox) is defined in the sample table box. A basic structure of a sample entry (SampleEntry), which is codec information stored in the sample description box, is defined by the handler type described above. For example, a sample entry of a video media will also be referred to as a visual sample entry. A sample entry of an audio media will also be referred to as an audio sample entry. A sample entry of a text media will also be referred to as a plain text sample entry. A sample entry of a haptics media will also be referred to as a haptics sample entry. Access information of a sample (Sample) is stored in a time to sample box (TimeToSampleBox), a sample size box (SampleSizeBox), a sample to chunk box (SampleToChunkBox), a sync sample box (SyncSampleBox), and/or the like that are stored in the sample table box.

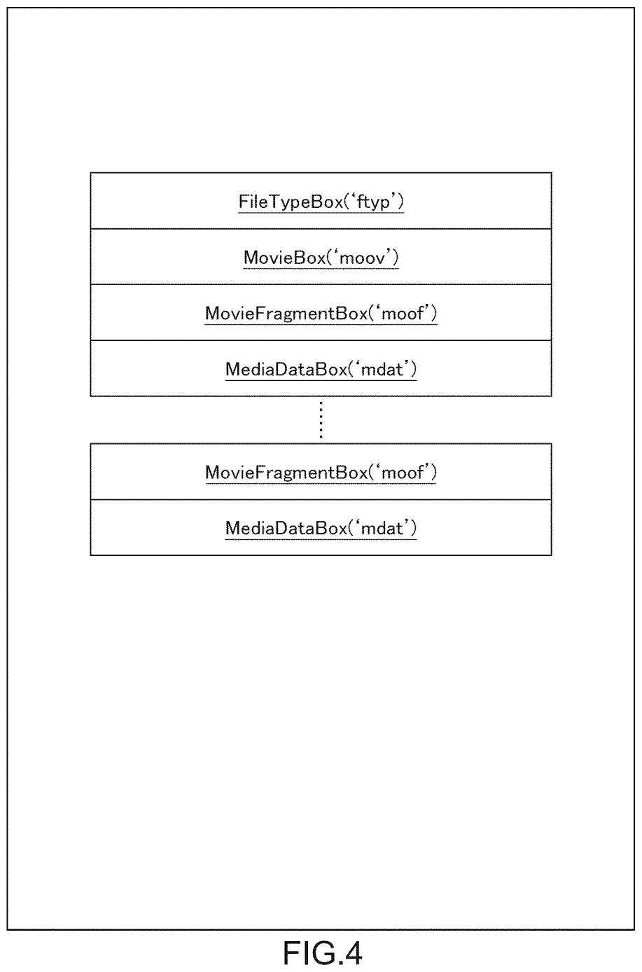

In ISOBMFF, a method called fragment movie (FragmentMovie) for managing dynamic data such as a moving image by time division (e.g., in units of 10 seconds) is defined. In the fragment movie, as shown in FIG. 4, a movie fragment box (MovieFragmentBox(‘moof’)) and a media data box (MediaDataBox(‘mdat’)) are defined for each piece of time-divided media data. The codec information is stored as a sample entry in the sample description box of the movie box. As the access information of a sample, information equivalent to the time to sample box, the sample size box, the sample to chunk box, and the sync sample box may be stored in a track fragment run box (TrackFragmentRunBox) of the movie fragment box in units of samples.

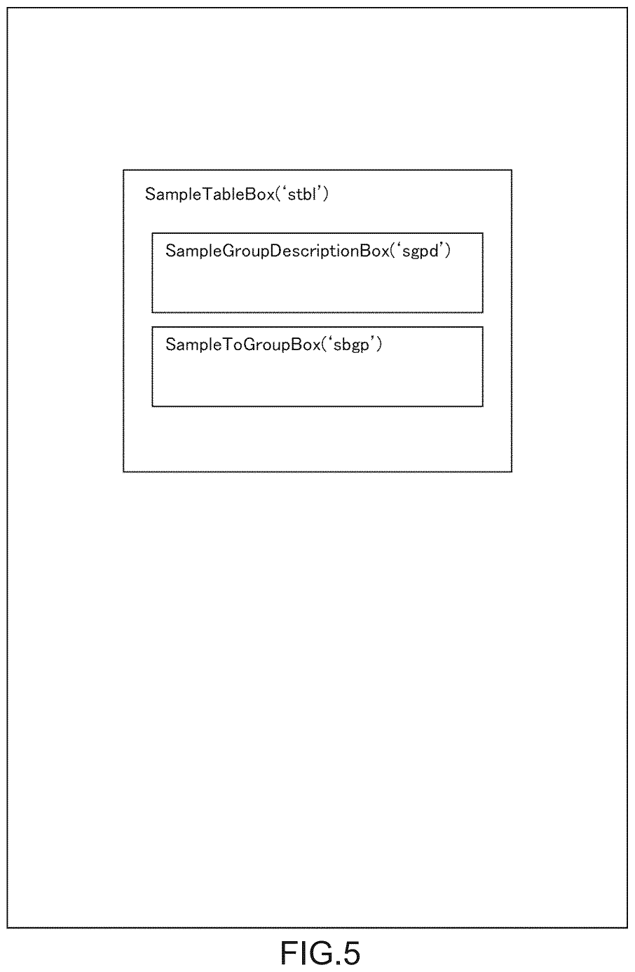

In the sample table box, boxes for managing codec information, access information, and time information of a sample are defined. One sample is usually associated with one piece of codec information that is required for decoding the sample. For example, in order to reproduce from an intra-coded sample, it is necessary to manage information for specifying the intra-coded sample. As shown in FIG. 5, a sample group description box (SampleGroupDescriptionBox(‘sgpd’)) and a sample to group box (SampleToGroupBox(‘sbgp’)) may be defined in the sample table box. The sample group description box is a general-purpose box that can store sample information by a grouping type (grouping_type) separately from the codec information and/or intra-coded information. This information can be associated with any sample by the information stored in the sample to group box.

That is, in the sample table box, samples can be grouped for defining a reproduction method different from the sample entry. This group of samples will be referred to as a sample group. In addition, the reproduction method is defined by the information stored in the sample group description box. Then, the reproduction method is associated with the sample by the information stored in the sample to group box. That is, the information stored in the sample group description box and the sample to group box realizes reproduction processing of the sample that is different from normal reproduction. For example, in a temporary level entry (TemporalLevelEntry), a sample with an appropriate frame rate can be selected. A plurality of sample group description boxes can store a plurality of pieces of sample information.

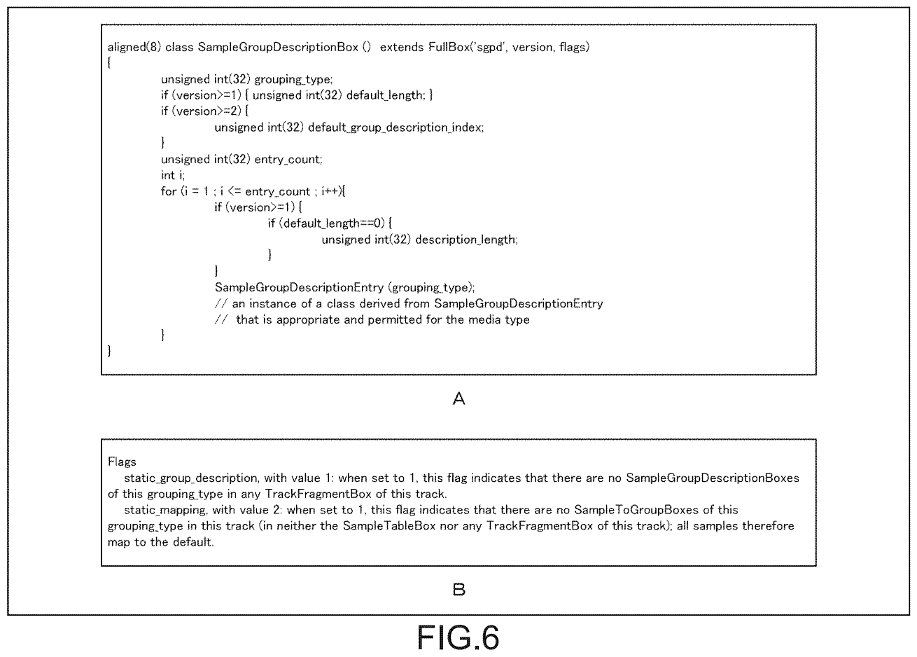

An example of a syntax of the sample group description box is shown in FIG. 6A. As shown in the first line from the top in this syntax example, flag information (flags) is defined in the sample group description box. This flag information may include flag information such as static_group_description and static_mapping, for example, as shown in FIG. 6B. When the value of static_group_description is true (e.g., “1”), it indicates that no sample group description box (SampleGroupDescriptionBoxes) of this grouping type (grouping_type) exists in any track fragment box (TrackFragmentBox) of this track. When the value of static_mapping is true (e.g., “1”), it indicates that no sample to group box (SampleToGroupBoxes) of this grouping type exists in this track (in neither the sample table box nor the track fragment box of this track). Therefore, all samples are mapped to the default.

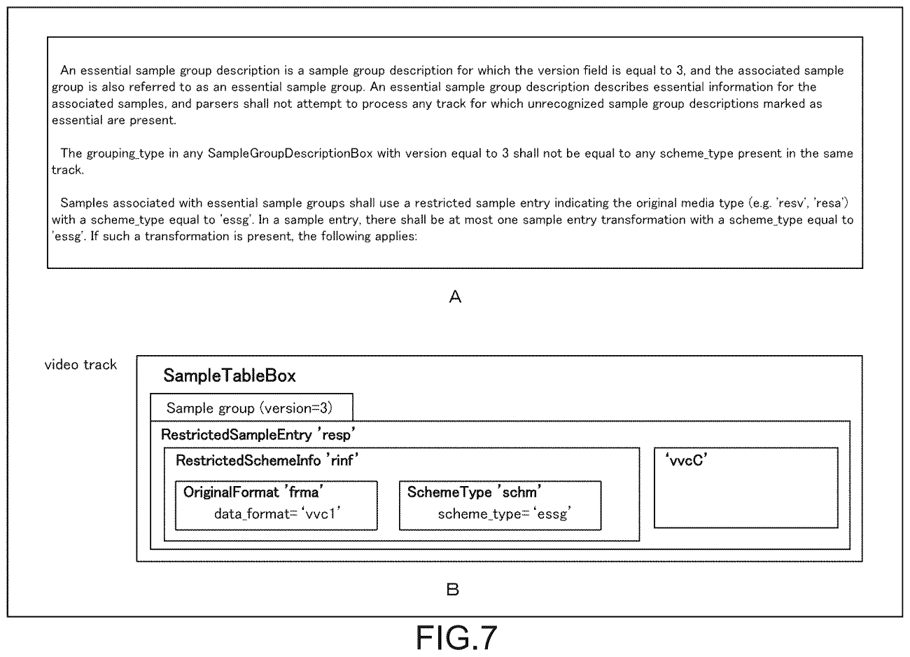

As shown in FIG. 7A, an essential sample group description is a sample group description having a version field set to “3”. The sample group associated with this essential sample group description is a sample group that needs be interpreted (hereinafter, will also be referred to as “parsing”), and will also be referred to as an essential sample group. That is, the essential sample group description box stores information of a related sample that needs to be interpreted. When a parser cannot interpret the information, reproduction is stopped. The grouping type (grouping_type) stored in this essential sample group description box (a sample group description box having the version field set to “3”) does not match with any scheme type (Schema_type(‘schm’)) present in the same track.

As shown in FIG. 7B, samples associated with the essential sample groups need to use a restricted sample entry (RestrictedSampleEntry(‘resp’)) indicating an original media type such as ‘resv’ or ‘resa’, with the scheme type being set to ‘essg’.

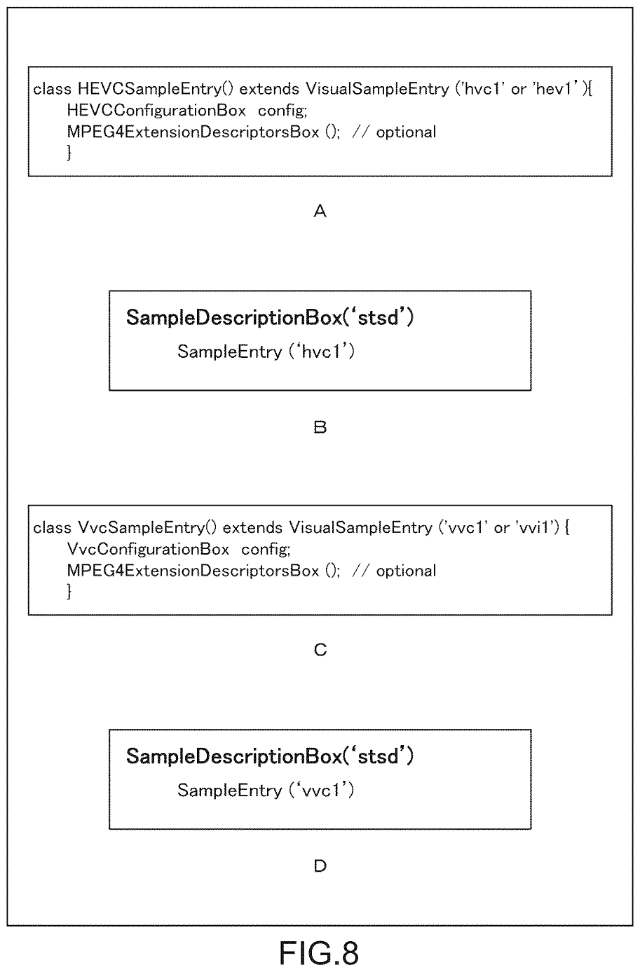

In the sample table box, codec identification 4CC information and codec configuration information for decoder initialization are defined as the sample entry. An example of a syntax of a sample entry (HEVCSampleEntry) in a case where the media is a video encoded by HEVC (High Efficiency Video Coding) is shown in FIG. 8A. In this case, ‘hvc1’ or ‘hev1’ representing the sample entry (HEVCSampleEntry) of the HEVC video is defined as the codec identification 4CC information. As shown in FIG. 8B, the sample entry (‘hvc1’) is stored in the sample description box. In addition, configuration information (HEVCConfigurationBox) is stored in the sample entry.

An example of a syntax of a sample entry (VvcSampleEntry) in a case where the media is a video encoded by VVC (Versatile Video Coding) is shown in FIG. 8C. In this case, ‘vvc1’ or ‘vvi1’ representing the sample entry (VvcSampleEntry) of the VVC video is defined as the codec identification 4CC information. As shown in FIG. 8D, the sample entry (‘vvc1’) is stored in the sample description box. In addition, configuration information (VvcConfigurationBox) is stored in the sample entry.

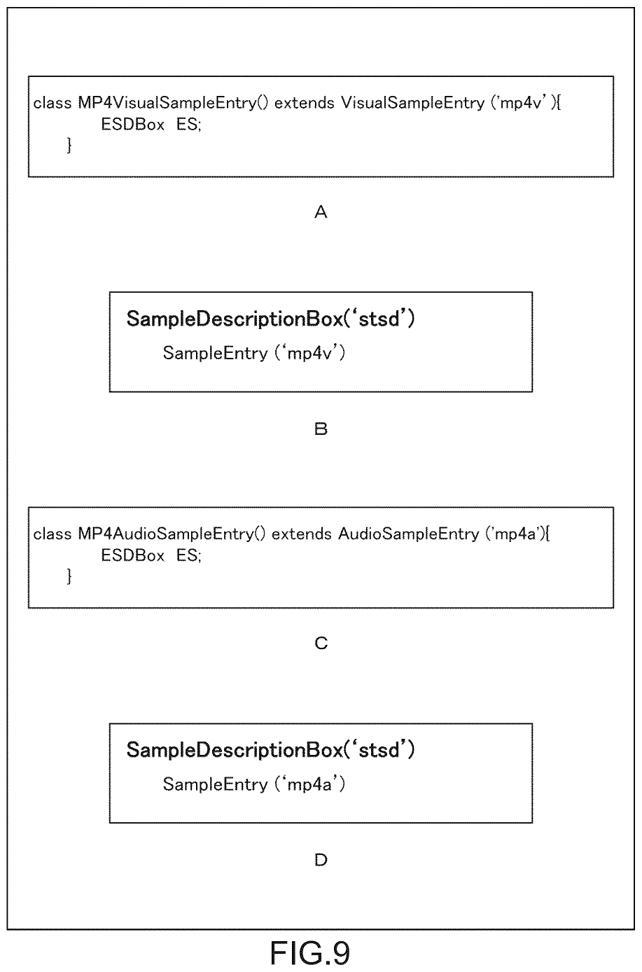

An example of a syntax of a sample entry (MP4VisualSampleEntry) in a case where the media is a video encoded by MPEG4 (Moving Picture Experts Group 4) is shown in FIG. 9A. In this case, ‘mp4v’ representing the sample entry (MP4VisualSampleEntry) of the MPEG4 video is defined as the codec identification 4CC information. As shown in FIG. 9B, the sample entry (‘mp4v’) is stored in the sample description box. In addition, configuration information (ESDBox ES) is stored in the sample entry.

An example of a syntax of a sample entry (MP4AudioSampleEntry) in a case where the media is audio encoded by MPEG4 is shown in FIG. 9C. In this case, ‘mp4a’ representing the sample entry (MP4AudioSampleEntry) of the MPEG4 audio is defined as the codec identification 4CC information. As shown in FIG. 9D, the sample entry (‘mp4a’) is stored in the sample description box. In addition, configuration information (ESDBox ES) is stored in the sample entry.

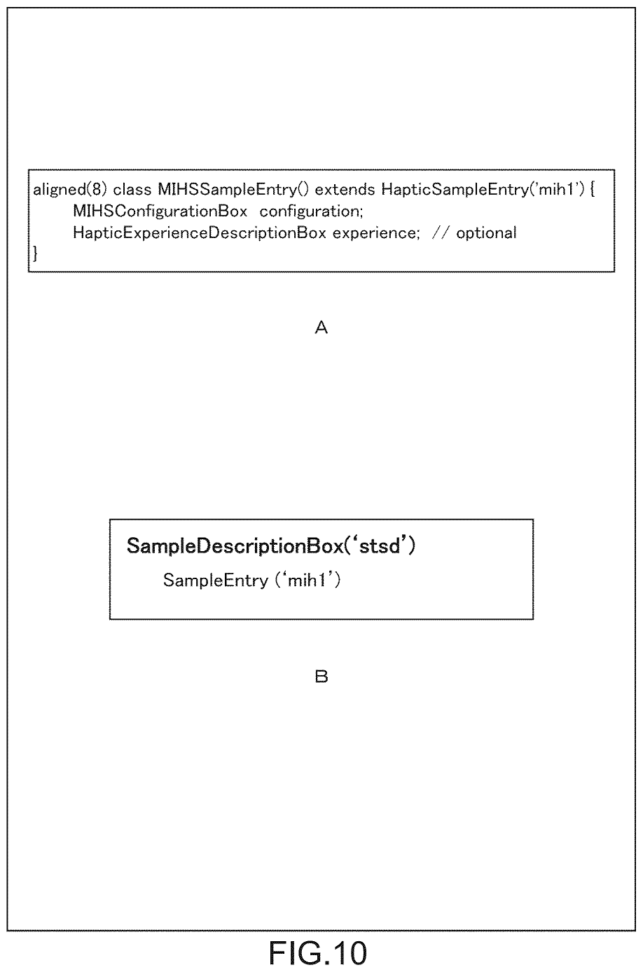

An example of a syntax of a sample entry (MIHSSampleEntry) in a case where the media is a haptics media encoded by a haptics encoding method is shown in FIG. 10A. In this case, ‘mih1’ representing the sample entry (MIHSSampleEntry) of the haptics media is defined as the codec identification 4CC information. As shown in FIG. 10B, the sample entry (‘mih1’) is stored in the sample description box. In addition, configuration information (MIHSConfigurationBox) is stored in the sample entry.

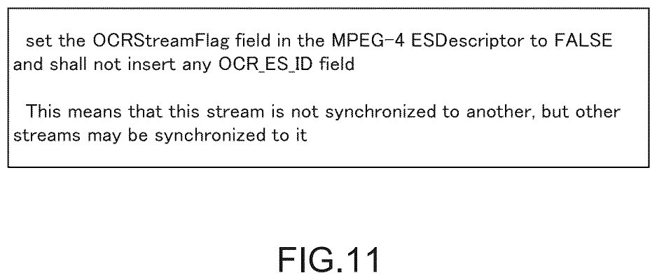

Further, Non-Patent Literature 3 proposes a “‘sync’ track reference” as a function of synchronizing reproduction of a track of an MP4 media and reproduction of other tracks. This ‘sync’ track reference is a variable that indicates whether or not to synchronize the reproduction of the track with the reproduction of other tracks of the same file. In other words, the ‘sync’ track reference is track reference information for determining whether or not to synchronize the reproduction clock with the clock on the transmission side. The behavior in a case where the value of this ‘sync’ track reference is “0”, that is, in a case where track_id to be referenced is 0 or there is no value of track_id, is defined as in FIG. 11. In other words, in that case, the OCR stream flag (OCRStreamFlag) field of the MPEG-4ES descriptor (MPEG-4ESDescriptor) is set to “FALSE”, and the OCR_ES_ID field is not inserted. This means that this stream is not synchronized with another stream, but other streams may be synchronized to this stream. It is noted that the OCR (Object Clock Reference) is a reference clock of each media object, and conveys the OTB (Object Time Stamp) on the transmission side to the reception side.

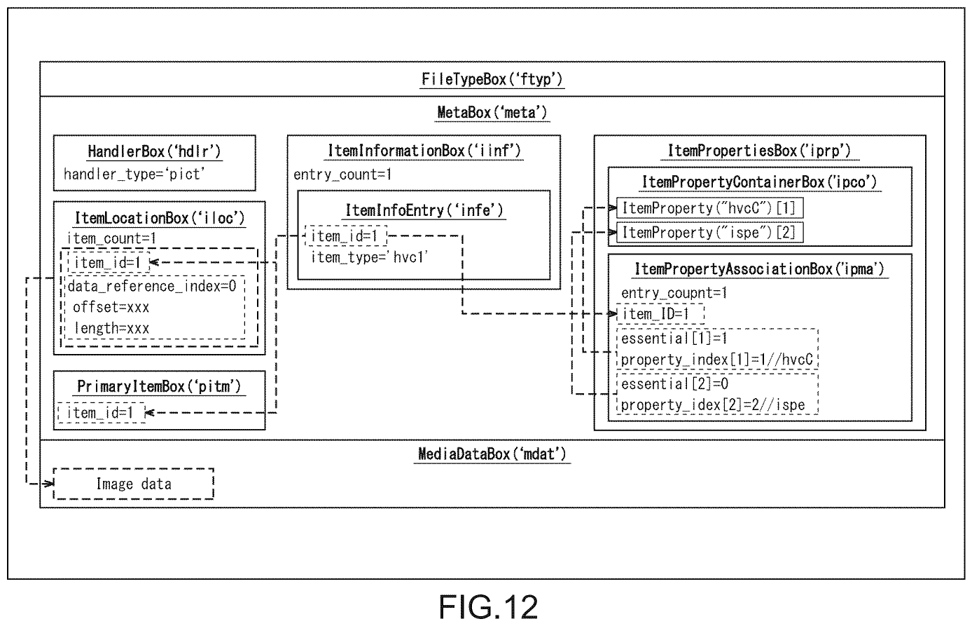

Further, Non-Patent Literature 5 has also proposed a format (Image File Format) for storing a still image, which is encoded video data of one frame, as a format conforming to this ISOBMFF (see, for example, Non-Patent Literature 5). That is, in this format, image data of a still image encoded by an encoding method for moving images is stored as metadata in the ISOBMFF file. FIG. 12 shows an example of the meta box (MetaBox(‘meta’)) in this case.

As shown in FIG. 12, the item type (handler type) is defined in the handler box (HandlerBox(‘hdlr’)) of the meta box. In this case, since the item is a still image, “handler_type=‘pict’” is defined. In addition, the item identification information (item_id) is defined in the item info entry (ItemInfoEntry(‘infe’)) of the item information box (ItemInformationBox(‘iinf’)) (item_id=1). This identification information (item_id) associates information related to this item in the meta box. In addition, the encoding tool (item_type) required for this item is defined. In this case, since the item is encoded by HEVC, “item_type=hvc1” is defined. In addition, in the item location box (ItemLocationBox(‘iloc’)), the storage location (offset and length) of the item is indicated. The item associated as the metadata (in this case, image data) is stored in the media data box (MediaDataBox(‘mdat’)).

Further, the item property container box (ItemPropertyContainerBox(‘ipco’)) defines the configuration information (itemProperty(“hvcC”)) and size information (itemProperty(“ispe”)) of the item. Then, in the item property association box (ItemPropertyAssociationBox(‘ipma’)), the item and the information required for decoding the item (information defined in the item property container box) are associated with each other.

Incidentally, in addition to images, audio, and the like, there has also been a haptics media that expresses a tactile sense by vibration, for example. As the reproduction method for this haptics media, for example, the interaction-type reproduction method in which reproduction is executed with some kind of an event being a trigger has been applied in many cases.

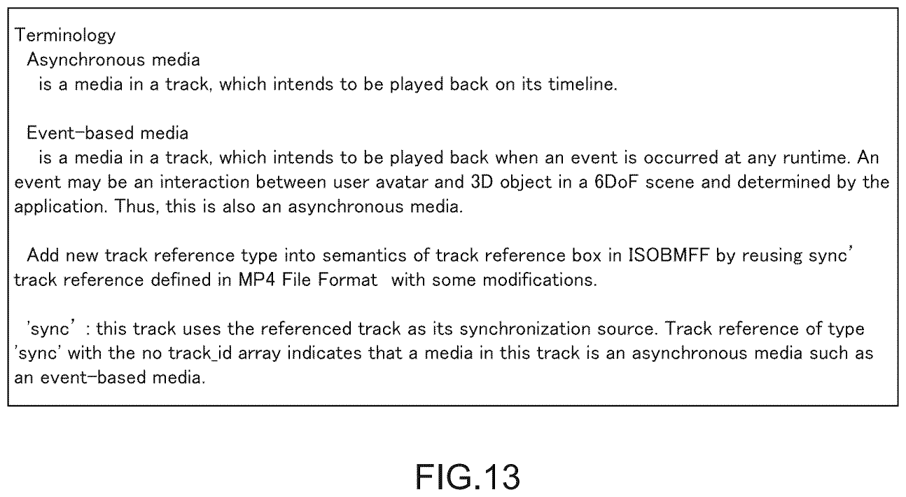

Non-Patent Literature 6 and/or Patent Literature 1 have proposed a method of extending “sync track reference” so as to handle an asynchronous media to which such interaction-type reproduction is applied in ISOBMFF (i.e., a method that realizes the interaction-type reproduction of media using ISOBMFF), as shown in FIG. 13.

Incidentally, the track reference box is a box that indicates a relationship between tracks. Therefore, when unable to interpret a signal indicating the relationship between tracks, a reproduction device should not reproduce that track that cannot be interpreted. However, there has been no description in the conventional standard regarding such a behavior of the reproduction device, and reproduction has been performed by a method that depends on the implementation of the reproduction device. Therefore, there has been a fear that the reproduction device will execute reproduction while ignoring the relationship between tracks that is indicated in the track reference box. Therefore, there has been a fear that the reproduction device will incorrectly reproduce an asynchronous media. Therefore, there has been a fear that a user experience that a content creator does not intend will be provided, such as a media that should be reproduced by an interaction being reproduced in synchronization with other media, for example.

### 3 . Method 1

### Transmission of Information Indicating That Media is Asynchronous Media That Requires Parsing

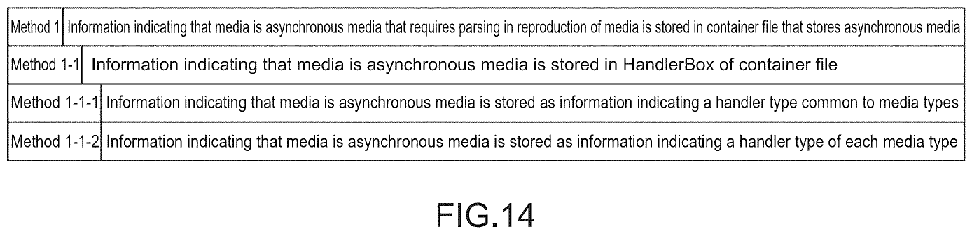

In this regard, as shown on the top row of the table shown in FIG. 14, information indicating that the media is an asynchronous media that requires parsing in reproduction of the media is stored in a distribution file that stores the asynchronous media (Method 1). Here, “requires parsing” means that the reproduction device and the like that are guaranteed to be capable of reproducing a target media by conforming to a codec standard and/or the like or guarantee of the compatibility by a specific manufacturer, organization, and/or the like, are required to analyze target information for sure.

For example, a file generation device that generates a file for storing media data is assumed to be a first information processing apparatus. This first information processing apparatus includes: an encoding unit which encodes media data of an asynchronous media to be reproduced asynchronously, to generate media encoded data; and a file generation unit which generates a container file and stores the media encoded data and asynchronous media information in the container file. It is noted that the asynchronous media information is information that indicates that the media data is of the asynchronous media, and requires parsing for reproducing the asynchronous media.

Further, a first information processing method executed by the first information processing apparatus includes: encoding media data of an asynchronous media to be reproduced asynchronously, to generate media encoded data; and generating a container file and storing the media encoded data and asynchronous media information in the container file. It is noted that the asynchronous media information is information that indicates that the media data is of the asynchronous media, and requires parsing for reproducing the asynchronous media.

With such a configuration, the reproduction device that reproduces the media data stored in the container file parses the asynchronous media information for sure for reproduction. Therefore, the reproduction device performs reproduction while grasping for sure that the media data is of the asynchronous media. In other words, when the asynchronous media information cannot be parsed, reproduction is stopped. Therefore, the first information processing apparatus can suppress unauthorized reproduction of the asynchronous media. Accordingly, the first information processing apparatus can suppress an occurrence of a problem that a user experience not intended by a content creator is provided.

For example, a reproduction device that reproduces media data stored in a file is assumed to be a second information processing apparatus. The second information processing apparatus includes: a parse processing unit which parses asynchronous media information stored in a container file; a decoding unit which decodes media encoded data stored in the container file in accordance with a result of the parsing and a reproduction condition, to generate media data of an asynchronous media to be reproduced asynchronously; and an output control unit which renders the media data to generate output information, and causes an output unit to output the output information, as reproduction of the asynchronous media. It is noted that the asynchronous media information is information that indicates that the media data is of the asynchronous media, and requires parsing for reproducing the asynchronous media.

Furthermore, a second information processing method executed by the second information processing apparatus includes: parsing asynchronous media information stored in a container file; decoding media encoded data stored in the container file in accordance with a result of the parsing and a reproduction condition, to generate media data of an asynchronous media to be reproduced asynchronously; and rendering the media data to generate output information, and causing the output information to be output, as reproduction of the asynchronous media. It is noted that the asynchronous media information is information that indicates that the media data is of the asynchronous media, and requires parsing for reproducing the asynchronous media.

With such a configuration, the second information processing apparatus can perform reproduction while grasping that the media data is of the asynchronous media. Therefore, the second information processing apparatus can suppress unauthorized reproduction of the asynchronous media. Accordingly, the second information processing apparatus can suppress an occurrence of a problem that a user experience not intended by a content creator is provided.

It is noted that in the second information processing apparatus, the parse processing unit may determine whether or not the asynchronous media information can be parsed, and when the asynchronous media information cannot be parsed, omit reproduction of the asynchronous media. For example, the second information processing apparatus may not be able to parse the asynchronous media information (correctly), for example, when the asynchronous media information includes a description that the second information processing apparatus does not support, and/or the like. By determining whether or not the asynchronous media information can be parsed and omitting the reproduction of the asynchronous media when the asynchronous media information cannot be parsed as described above, the second information processing apparatus can parse the asynchronous media information more correctly, and reproduce the asynchronous media more correctly. Therefore, the second information processing apparatus can suppress unauthorized reproduction of the asynchronous media.

### 4 . Method 1-1

### Notification by Handler Type

Descriptions below will be given using ISOBMFF as an example of the container format. When Method 1 described above is applied, for example, as shown on the second row from the top of the table shown in FIG. 14, information indicating that the media is the asynchronous media may be stored in the handler box (HandlerBox) of the container file (Method 1-1). For example, in the ISOBMFF file, the handler box is a box in which information called the handler type (HandlerType) indicating a media type is defined. In other words, this box needs to be parsed for reproducing the media of the handler type defined herein. In other words, by storing the asynchronous media information in this handler box, the asynchronous media information may be set as information that needs to be parsed for reproducing the asynchronous media.

For example, the first information processing apparatus may include: an encoding unit which encodes media data of an asynchronous media to be reproduced asynchronously, to generate media encoded data; and a file generation unit which generates a container file, stores the media encoded data in the container file, and further stores asynchronous media information indicating that the media data is of the asynchronous media in a handler box of the container file.

Further, the first information processing method executed by the first information processing apparatus may include: encoding media data of an asynchronous media to be reproduced asynchronously, to generate media encoded data; and generating a container file, storing the media encoded data in the container file, and further storing asynchronous media information that indicates that the media data is of the asynchronous media in a handler box of the container file.

By storing the asynchronous media information in the handler box in this manner, the reproduction device parses the asynchronous media information for sure when reproducing the asynchronous media. Therefore, the reproduction device performs reproduction while grasping for sure that the media data is of the asynchronous media. In other words, when the asynchronous media information cannot be parsed, reproduction of the asynchronous media is stopped. Therefore, the first information processing apparatus can suppress unauthorized reproduction of the asynchronous media. Accordingly, the first information processing apparatus can suppress an occurrence of a problem that a user experience not intended by a content creator is provided.

For example, the second information processing apparatus may include: a parse processing unit which parses asynchronous media information that is stored in a handler box of a container file and indicates that media encoded data stored in the container file is an asynchronous media to be reproduced asynchronously; a decoding unit which decodes the media encoded data in accordance with a result of the parsing and a reproduction condition, to generate media data of the asynchronous media; and an output control unit which renders the media data to generate output information, and causes an output unit to output the output information, as reproduction of the asynchronous media.

Further, the second information processing method executed by the second information processing apparatus may include: parsing asynchronous media information that is stored in a handler box of a container file and indicates that media encoded data stored in the container file is an asynchronous media to be reproduced asynchronously; decoding the media encoded data in accordance with a result of the parsing and a reproduction condition, to generate media data of the asynchronous media; and rendering the media data to generate output information, and causing the output information to be output, as reproduction of the asynchronous media.

With such a configuration, the second information processing apparatus can perform reproduction while grasping that the media data is of the asynchronous media. Therefore, the second information processing apparatus can suppress unauthorized reproduction of the asynchronous media. Accordingly, the second information processing apparatus can suppress an occurrence of a problem that a user experience not intended by a content creator is provided.

### Method 1-1-1

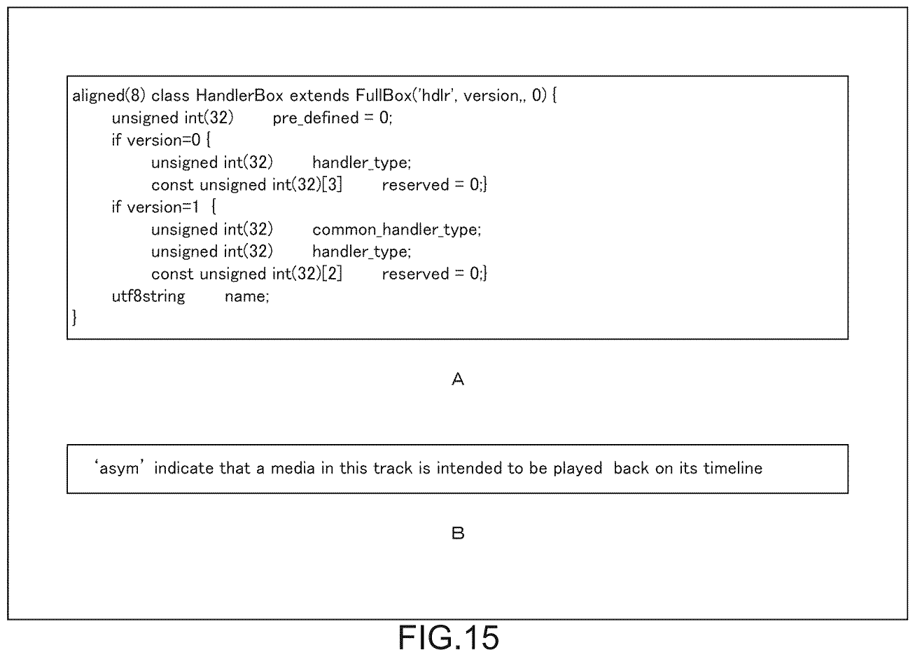

When Method 1-1 is applied, for example, as shown on the third row from the top of the table shown in FIG. 14, information indicating that the media is the asynchronous media may be stored as information indicating a handler type common to media types (Method 1-1-1). An example of the syntax of the handler box is shown in FIG. 15A. As shown in this figure, in the handler box, a handler type (handler_type) indicating the media type is set for the media. This handler box is extended so that a common handler type (common_handler_type) is set in addition to the handler type in Version 1. This common handler type (common_handler_type) is a handler type that does not depend on the media type (common). This common handler type indicates that the media is the asynchronous media. For example, ‘asym’ may be set for the asynchronous media as this common handler type. As shown in FIG. 15B this ‘asym’ is a common handler type indicating that the media in this track is to be reproduced on its timeline, that is, the media is the asynchronous media. In other words, when the media stored in the track is the asynchronous media, the version of the handler box may be set to “1”, and this common handler type (‘asym’) may be stored in the handler box as asynchronous media information indicating that the media data is of the asynchronous media.

For example, in the first information processing apparatus, the file generation unit may store the asynchronous media information in the handler box as the information indicating the handler type common to the media types. With such a configuration, the reproduction device can parse the common handler type (‘asym’) for sure, and perform reproduction while grasping that the media data is of the asynchronous media. In other words, when the reproduction device cannot parse the common handler type (‘asym’), reproduction of the asynchronous media is stopped. Therefore, the first information processing apparatus can suppress unauthorized reproduction of the asynchronous media without extending the handler type indicating the media type.

For example, in the second information processing apparatus, the parse processing unit may parse the asynchronous media information stored in the handler box as the information indicating the handler type common to the media types. With such a configuration, the second information processing apparatus can parse the common handler type (‘asym’) for sure, and perform reproduction while grasping that the media data is of the asynchronous media. Therefore, the second information processing apparatus can suppress unauthorized reproduction of the asynchronous media without extending the handler type indicating the media type.

### Method 1-1-2

When Method 1-1 is applied, for example, as shown on the bottom row of the table shown in FIG. 14, information indicating that the media is the asynchronous media may be stored as information indicating a handler type for each media type (Method 1-1-2). In other words, the handler type (handler_type) indicating the media type for the media may be extended to prepare a handler type indicating that the media is the asynchronous media. In that case, a handler type indicating that the media is the asynchronous media for each media type is prepared. In other words, in this case, the handler type indicates that the media is the asynchronous media, and also indicates the media type. Therefore, when the media stored in the track is the asynchronous media, a handler type that corresponds to the media type and indicates that the media is the asynchronous media is stored in the handler box.

Specifically, such a handler type may take any value as long as the handler type is different from existing handler types that indicate only the media type. For example, the handler type (‘ascv’) may indicate an asynchronous media of a video media. The handler type (‘asca’) may indicate an asynchronous media of an audio media. The handler type (‘asch’) may indicate an asynchronous media of a haptics media. The handler type (‘asct’) may indicate an asynchronous media of a text media. Other types of media may similarly be defined as ‘ascx’. It is noted that this x indicates a variable to which a letter corresponding to the media type is allocated.

For example, in the first information processing apparatus, the file generation unit may store the asynchronous media information in the handler box as information indicating a handler type for each media type. With such a configuration, the reproduction device can parse the handler type (‘ascx’) for sure, and perform reproduction while grasping that the media data is of the asynchronous media. In other words, when the reproduction device cannot parse the handler type (‘ascx’), reproduction of the asynchronous media is stopped. Therefore, the first information processing apparatus can suppress unauthorized reproduction of the asynchronous media without extending the version of the handler box.

For example, in the second information processing apparatus, the parse processing unit may parse the asynchronous media information stored in the handler box as information indicating a handler type of each media type. With such a configuration, the second information processing apparatus can parse the handler type (‘ascx’) for sure, and perform reproduction while grasping that the media data is of the asynchronous media. Therefore, the second information processing apparatus can suppress unauthorized reproduction of the asynchronous media without extending the version of the handler box.

### 5 . Method 1-2

### Notification by Track Reference

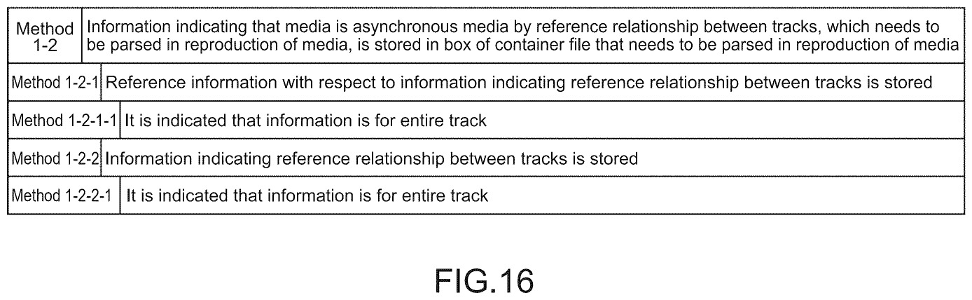

When Method 1 described above is applied, for example, as shown on the top row of the table shown in FIG. 16, information indicating that the media is the asynchronous media by a reference relationship between tracks, which needs to be parsed in the reproduction of the media, may be stored in a box of the container file that needs to be parsed in the reproduction of the media (Method 1-2). As described above, in ISOBMFF, a sample group that defines the reproduction method can be set. Also, a track reference that indicates the reference relationship between tracks can be set. Further, “sync track reference” can be extended so as to handle the asynchronous media to which such interaction-type reproduction is applied in ISOBMFF. In this regard, it is also possible to set an essential track reference that requires parsing by extending the sample group, and indicate that the media is the asynchronous media in the essential track reference.

For example, the first information processing apparatus may include: an encoding unit which encodes media data of an asynchronous media to be reproduced asynchronously, to generate media encoded data; and a file generation unit which generates a container file and stores the media encoded data and an essential track reference in the container file. It is noted that the essential track reference is information that indicates that the media data is of the asynchronous media by the reference relationship between tracks, and requires parsing for reproducing the asynchronous media.

Further, the first information processing method executed by the first information processing apparatus may include: encoding media data of an asynchronous media to be reproduced asynchronously, to generate media encoded data; and generating a container file and storing the media encoded data and an essential track reference in the container file. It is noted that the essential track reference is information that indicates that the media data is of the asynchronous media by the reference relationship between tracks, and requires parsing for reproducing the asynchronous media.

By storing the essential track reference in the container file as the asynchronous media information in this manner, the reproduction device parses this asynchronous media information (i.e., essential track reference) for sure when reproducing the asynchronous media. Therefore, the reproduction device performs reproduction while grasping for sure that the media data is of the asynchronous media. In other words, when the asynchronous media information cannot be parsed, reproduction of the asynchronous media is stopped. Therefore, the first information processing apparatus can suppress unauthorized reproduction of the asynchronous media. Accordingly, the first information processing apparatus can suppress an occurrence of a problem that a user experience not intended by a content creator is provided.

For example, the second information processing apparatus may include: a parse processing unit which parses an essential track reference stored in a container file; a decoding unit which decodes media encoded data stored in the container file in accordance with a result of the parsing and a reproduction condition, to generate media data of an asynchronous media to be reproduced asynchronously; and an output control unit which renders the media data to generate output information, and causes an output unit to output the output information, as reproduction of the asynchronous media. It is noted that the essential track reference is information that indicates that the media data is of the asynchronous media by the reference relationship between tracks, and requires parsing for reproducing the asynchronous media.

Further, the second information processing method executed by the second information processing apparatus may include: parsing an essential track reference stored in a container file; decoding media encoded data stored in the container file in accordance with a result of the parsing and a reproduction condition, to generate media data of an asynchronous media to be reproduced asynchronously; and rendering the media data to generate output information, and causing the output information to be output, as reproduction of the asynchronous media. It is noted that the essential track reference is information that indicates that the media data is of the asynchronous media by the reference relationship between tracks, and requires parsing for reproducing the asynchronous media.

By parsing the asynchronous media information (i.e., essential track reference) in this manner, the second information processing apparatus can perform reproduction while grasping that the media data is of the asynchronous media. Therefore, the second information processing apparatus can suppress unauthorized reproduction of the asynchronous media. Accordingly, the second information processing apparatus can suppress an occurrence of a problem that a user experience not intended by a content creator is provided.

### METHOD 1-2-1

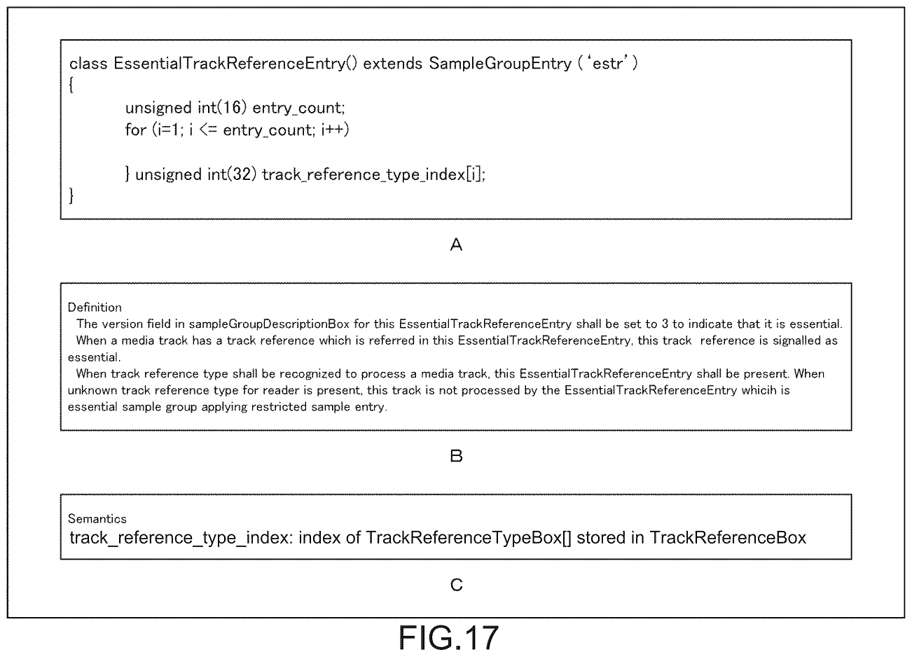

When Method 1-2 is applied, for example, as shown on the second row from the top of the table shown in FIG. 16, reference information with respect to information indicating the reference relationship between tracks may be stored in the essential track reference (Method 1-2-1). FIG. 17A is a diagram showing an example of a syntax of an essential track reference entry (EssentialTrackReferenceEntry( ) extends SampleGroupEntry (‘estr’)) obtained by extending the sample group entry.

This essential track reference entry is defined as in FIG. 17B, for example. For example, the version field (version) of the sample group description box (sampleGroupDescriptionBox) of this essential track reference entry (EssentialTrackReferenceEntry) is set to “3” to indicate that parsing is required. When this essential track reference entry is set in a media track, the use of the track reference (i.e., reference of track) indicated by the essential track reference is required in reproducing the media track. In other words, this track can be processed only when the track reference type indicated in this essential track reference can be recognized.

In this essential track reference entry, a track reference type index (track_reference_type_index) is set as shown in FIG. 17A. An example of the semantics of this track_reference_type_index is shown in FIG. 17C. As shown in this figure, track_reference_type_index is an index indicating the track reference type (TrackReferenceType) stored in the track reference box (TrackReferenceBox). In other words, by setting the track reference type index in the essential track reference entry, a track reference type that needs to be used is set.

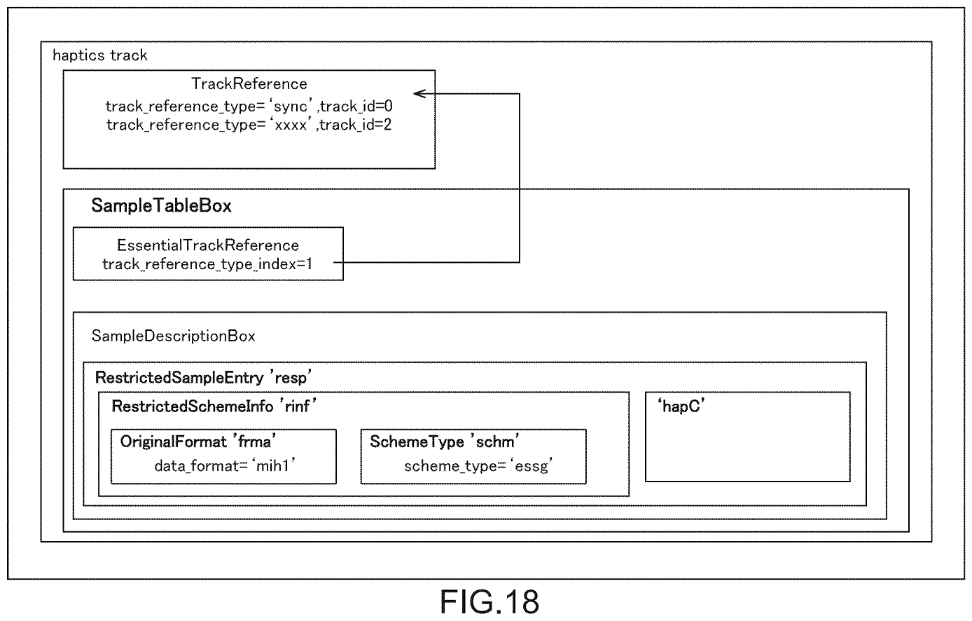

For example, as shown in FIG. 18, it is assumed that the essential track reference (EssentialTrackReference) is set in the sample table box (SampleTableBox) of a haptics track that stores a haptics media, and the track reference type index (track_reference_type_index=1) is set in the essential track reference. In this case, the essential track reference requires a track reference of a first track reference type (‘sync’) stored in the track reference box (TrackReferenceBox). Therefore, reproduction of the haptics media of this track is executed by using that reference.

For example, in the first information processing apparatus, the file generation unit may store, in the container file, an essential track reference that specifies an index indicating a track reference type that indicates that the media data is of the asynchronous media. With such a configuration, the reproduction device reproduces, for sure, the media using a track reference of a type corresponding to an index specified by the essential track reference. In other words, the reproduction device can perform reproduction while grasping that the media data is of the asynchronous media. In other words, when the reproduction device cannot recognize the track reference type, the reproduction of the asynchronous media is stopped. Therefore, the first information processing apparatus can suppress unauthorized reproduction of the asynchronous media.

Further, in the second information processing apparatus, the parse processing unit may parse a track reference of a type corresponding to an index specified in the essential track reference. With such a configuration, the second information processing apparatus reproduces the media using a track reference of a type corresponding to the index for sure. In other words, the second information processing apparatus can perform reproduction while grasping that the media data is of the asynchronous media. Therefore, the second information processing apparatus can suppress unauthorized reproduction of the asynchronous media.

It is noted that when the specifying of the index of the track reference type is omitted in the essential track reference, all track reference types may be considered as targets. In other words, when the specifying of the index is omitted, it may mean that all track reference types are required.

For example, in the first information processing apparatus, when reference to all track reference types is required, the file generation unit may store the essential track reference for which the specifying of the index has been omitted in the container file. Further, in the second information processing apparatus, when the specifying of the index is omitted in the essential track reference, the parse processing unit may parse the track references of all types. With such a configuration, it is possible to suppress an increase in the data amount of the container file in a case where a reference to all track reference types is required.

### Method 1-2-2

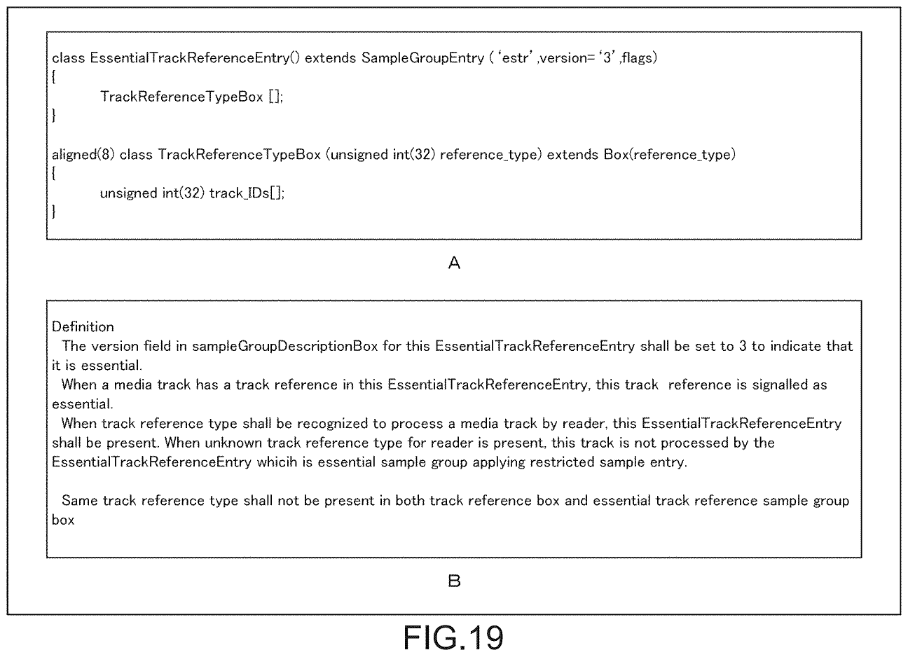

When Method 1-2 is applied, for example, as shown on the fourth row from the top of the table shown in FIG. 16, information indicating a reference relationship between tracks may be stored in the essential track reference (Method 1-2-2). FIG. 19A shows an example of the syntax of the essential track reference entry (EssentialTrackReferenceEntry( ) extends SampleGroupEntry (‘estr’)) obtained by extending the sample group entry.

This essential track reference entry is defined as in FIG. 19B, for example. For example, the version field (version) of the sample group description box (sampleGroupDescriptionBox) of this essential track reference entry (EssentialTrackReferenceEntry) is set to “3” to indicate that parsing is required. Then, when this essential track reference entry is set in a media track, the use of a track reference (i.e., reference of track) indicated by the essential track reference is required in reproducing the media track. In other words, this track can be processed only when the track reference type indicated in this essential track reference can be recognized.

In this essential track reference entry, as shown in FIG. 19A, a track reference type box (TrackReferenceTypeBox[ ]) is set, and track identification information (track_IDs[ ]) is set in the track reference type box. The track reference type box is a box for each type of track reference, and stores track identification information (track_IDs[ ]) that indicates the reference relationship corresponding to that type.

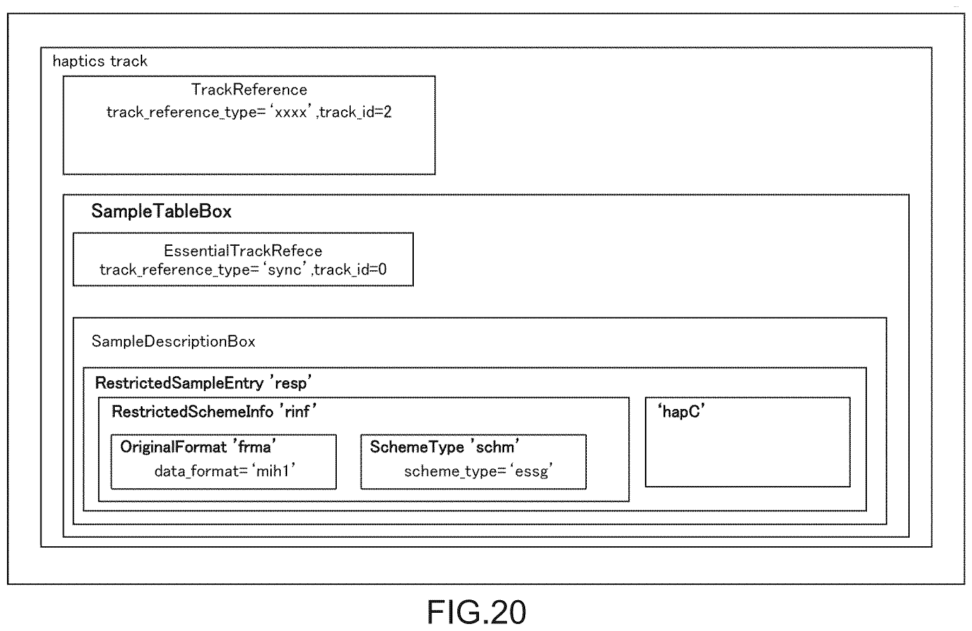

That is, in this case, as in the example shown in FIG. 20, a required track reference type and track identification information (track_id) are set in the essential track reference. It is noted that in this case, similar to the case of the example shown in FIG. 18, the track reference type is also set in the track reference box, but a type different from the sample group description box of the essential track reference is set. Therefore, in the example shown in FIG. 20, the track reference of the type ‘sync’ is set only in the sample group description box of the essential track reference.

For example, in the first information processing apparatus, the file generation unit may store, in the container file, an essential track reference that stores a track reference type indicating that the media data is of the asynchronous media. With such a configuration, the reproduction device reproduces the media using the track reference of a type indicated in the essential track reference for sure. In other words, the reproduction device can perform reproduction while grasping that the media data is of the asynchronous media. In other words, when the reproduction device cannot recognize the track reference type, the reproduction of the asynchronous media is stopped. Therefore, the first information processing apparatus can suppress unauthorized reproduction of the asynchronous media.

Further, in the second information processing apparatus, the parse processing unit may parse the track reference stored in the essential track reference. With such a configuration, the second information processing apparatus reproduces the media using the track reference of a type specified in the essential track reference for sure. In other words, the second information processing apparatus can perform reproduction while grasping that the media data is of the asynchronous media. Therefore, the second information processing apparatus can suppress unauthorized reproduction of the asynchronous media.

### Method 1-2-1-1 and Method 1-2-2-1

It is noted that when Method 1-2-1 is applied, for example, it is also possible to indicate that the information is for the entire track as shown on the third row from the top of the table shown in FIG. 16 (Method 1-2-1-1). Further, when Method 1-2-2 is applied, for example, it is also possible to indicate that the information is for the entire track as shown on the bottom row of the table shown in FIG. 16 (Method 1-2-2-1). In other words, it is also possible to indicate that the information is for the entire track by an application that requires a definition of the flag information (Flags) in the sample group description box.

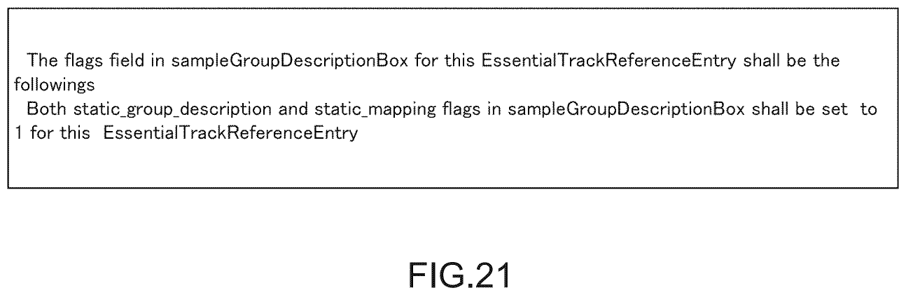

For example, as shown in FIG. 21, in the essential track reference, a static group description flag (static_group_description) and a static mapping flag (static_mapping) of the sample group description box may both be set to true (e.g., “1”). Setting the static group description flag to true (static_group_description=1) indicates that the sample group description is stored only in the movie box. In other words, it indicates that a sample group with a different value is not stored in the fragment movie. Also, setting the static mapping flag to true (static_mapping=1) indicates that the information is for the entire track. In other words, it indicates that the information cannot be associated with a sample by the sample to group (SampleToGroup) and is applied to all samples.

For example, in the first information processing apparatus, the file generation unit may further set flag information of the sample group description box of the essential track reference so as to indicate that the information is for the entire track. In that case, the file generation unit may set the values of statci_group_description and static_mapping, which are the flag information, to “1”.

Further, in the second information processing apparatus, the parse processing unit may parse flag information of the sample group description box of the essential track reference. In that case, the parse processing unit may parse statci_group_description and static_mapping which are the flag information. 98 With such a configuration, the essential track reference can be stored as information of the entire track.

### 6 . Method 2

### Timed Meta Item

Incidentally, a media having a time axis and whose contents change dynamically in a time direction will also be referred to as a timed media. For example, the asynchronous media such as a haptics media for which the interaction-type reproduction is performed is often a timed media of a relatively short time. Such a timed media having a short time has a relatively small amount of data and is easy to be managed. However, in ISOBMFF, the timed media is generally managed by tracks. For supporting various media, a mechanism for the management by tracks has been complicated, and a large amount of information has been required. Therefore, when tracks are applied to the management of the timed media having a short time as described above, the amount of information required for management increases with respect to the amount of media data, and thus there has been a fear that a load of reproduction processing will unnecessarily increase.

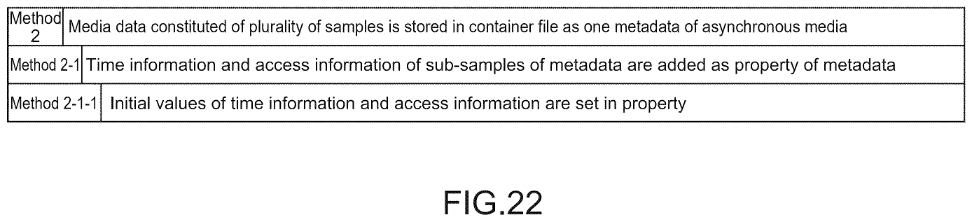

In this regard, as shown on the top row of the table shown in FIG. 22, media data constituted of a plurality of samples is stored in a container file as one metadata of a asynchronous media (Method 2). In other words, a timed media constituted of a plurality of samples is stored in a container file as one metadata. In the present specification, such metadata constituted of the timed media will also be referred to as a timed meta item.

For example, the first information processing apparatus includes: an encoding unit which encodes media data of an asynchronous media to be reproduced asynchronously, that is constituted of a plurality of samples, to generate media encoded data; and a file generation unit which generates a container file and stores the media encoded data in the container file as one metadata.

Further, the second information processing method executed by the second information processing apparatus includes: encoding media data of an asynchronous media to be reproduced asynchronously, that is constituted of a plurality of samples, to generate media encoded data; and generating a container file and storing the media encoded data in the container file as one metadata.

By storing the timed media in the container file as metadata in this manner, the first information processing apparatus can suppress an increase in the load of the reproduction processing for the timed media of a relatively short time as typified by the asynchronous media, as compared to the case of the management by tracks.

For example, the second information processing apparatus includes: a parse processing unit which parses information related to media encoded data of an asynchronous media to be reproduced asynchronously, that is stored in a container file; a decoding unit which decodes the media encoded data stored in the container file as one metadata in accordance with a result of the parsing and a reproduction condition, to generate media data of the asynchronous media, that is constituted of a plurality of samples; and an output control unit which renders the media data to generate output information, and causes an output unit to output the output information, as reproduction of the asynchronous media.

Further, the second information processing method executed by the second information processing apparatus includes: parsing information related to media encoded data of an asynchronous media to be reproduced asynchronously, that is stored in a container file; decoding the media encoded data stored in the container file as one metadata in accordance with a result of the parsing and a reproduction condition, to generate media data of the asynchronous media, that is constituted of a plurality of samples; and rendering the media data to generate output information, and causing the output information to be output, as reproduction of the asynchronous media.

In this manner, by reproducing the timed media stored in the container file as the metadata, the second information processing apparatus can suppress an increase in the load of the reproduction processing for the timed media of a relatively short time as typified by the asynchronous media, as compared to the case of the management by tracks.

### Method 2-1

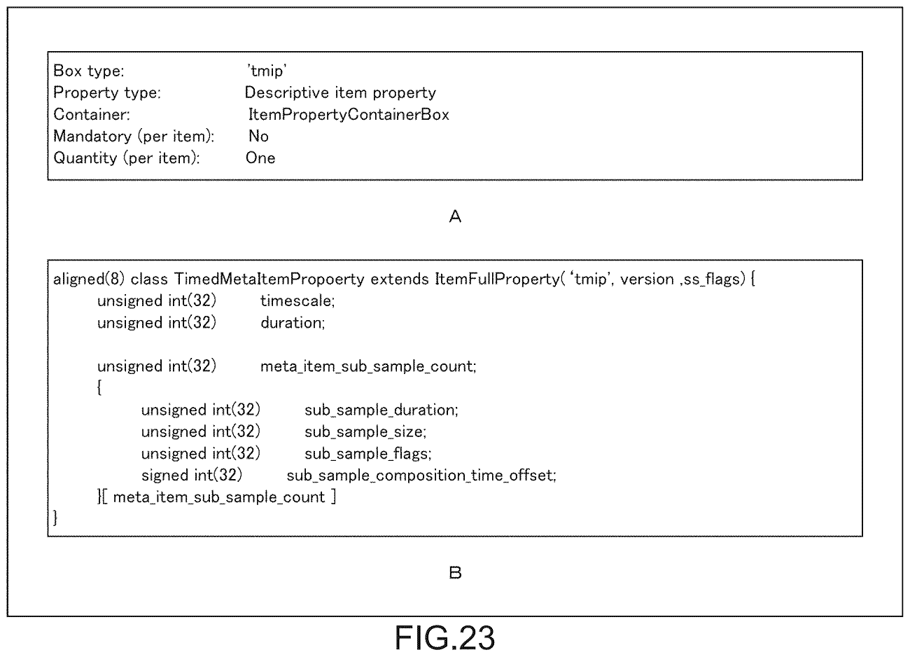

When Method 2 described above is applied, for example, as shown on the second row from the top of the table shown in FIG. 22, time information and access information of a sub-sample of metadata may be added as a property of the metadata (Method 2-1). For example, a timed meta item property (TimedMetaItemProperty(‘tmip’)), which is a box that stores property information of a timed meta item as shown in FIG. 23A may be defined. In this timed meta item property, for example, the time information and access information of the sub-sample of the metadata are defined. In other words, those pieces of information are added as the property information of the timed meta item. The time information is information related to a time of the sub-sample of the metadata. The access information is information used when accessing the sub-sample.

For example, in the first information processing apparatus, the file generation unit may add the time information related to the time of the sub-sample of the metadata and the access information used when accessing the sub-sample as the property of the metadata. Further, in the second information processing apparatus, the parse processing unit may parse the time information related to the time of the sub-sample of the metadata and the access information used when accessing the sub-sample, that have been added as the property of the metadata. With such a configuration, the time information and access information related to the sub-sample of the timed meta item can be transmitted to be used for the reproduction. Therefore, the timed media constituted of the plurality of samples can be transmitted as metadata and reproduced, and thus an increase in the load of the reproduction processing can be suppressed as compared to the case of the management by tracks.

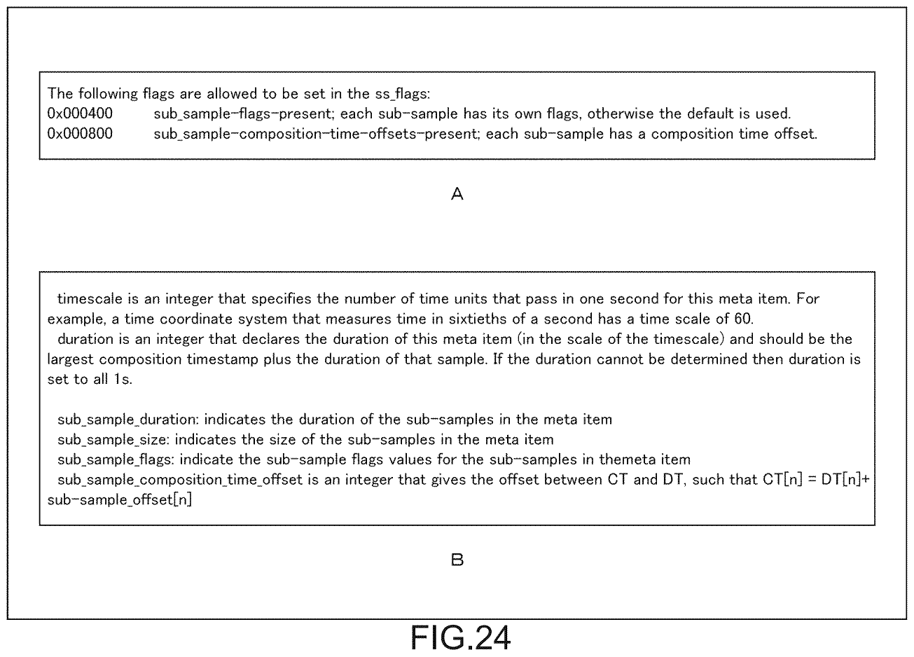

An example of the syntax of this timed meta item property is shown in FIG. 23B. As shown in this figure, flag information (ss_flag) is set in the timed meta item property. For example, as shown in FIG. 24A, when the value of this ss_flag is “0x000400”, it indicates that each sub-sample has its own flag information (will also be referred to as a sub-sample flag). In addition, when the value of this ss_flag is “0x000800”, it indicates that each sub-sample has a composition time offset.

Further, in the timed meta item property, a timescale and a duration are set. In addition, for each sub-sample, a sub-sample duration (sub_sample_duration), a sub-sample size (sub_sample_size), sub-sample flag information (sub_sample_flags), a sub-sample composition time offset (sub_sample_composition_time_offset), and the like are set. An example of the semantics of these is shown in FIG. 24B. The timescale is an integer that specifies the number of time units (will also be referred to as time units) of this meta item that pass in one second. The duration is an integer that specifies a period of this meta item (in a scale of the timescale described above). The sub-sample duration (sub_sample_duration) indicates a duration of the sub-sample in the meta item. The sub-sample size (sub_sample_size) indicates a size of the sub-sample in the meta item. The sub-sample flag information (sub_sample_flags) indicates a value of the flag information of the sub-sample in the meta item. The sub-sample composition time offset (sub_sample_composition_time_offset) is an integer that indicates an offset between CT and DT. More specifically, CT[n]=DT[n]+sub-sample_offset[n].

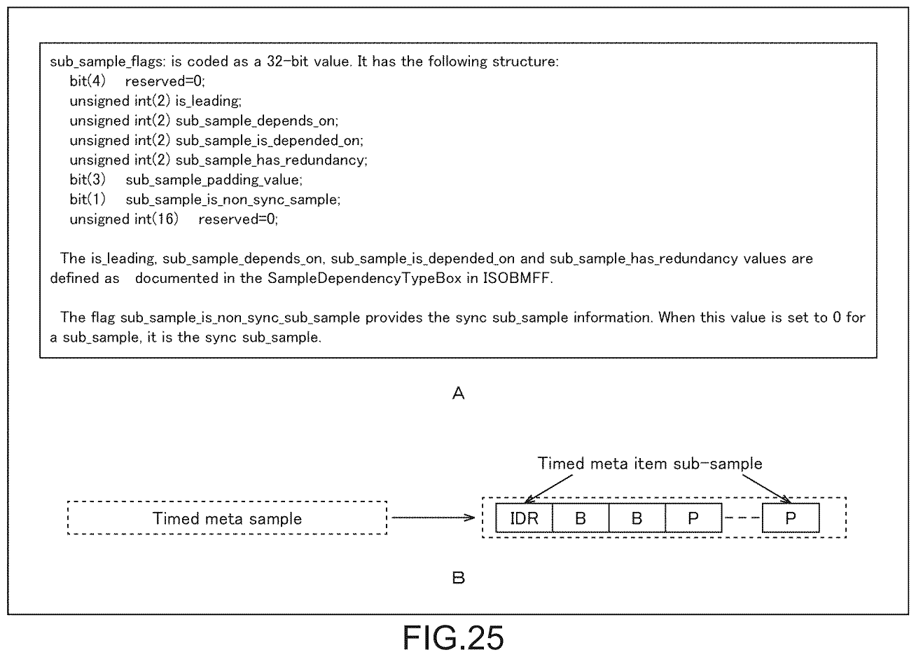

An example of the sub-sample flag information (sub_sample_flags) is shown in FIG. 25A. is_leading is flag information indicating whether or not the sample is a leading sample. sub_sample_depends_on is flag information indicating whether or not the sample is dependent on other samples. sub_sample_is_depended_on is flag information indicating whether or not other samples are dependent. sub_sample_has_redundancy is flag information indicating whether or not there is redundancy. sub_sample_padding_value is flag information indicating a padding value of the sub-sample. sub_sample_is_non_sync_sample is flag information indicating whether or not the sub-sample is a synchronous sub-sample.

The sub-samples of the timed meta item are stored as continuous data. For example, in a case where the timed meta item is a video media, each picture is configured as a sub-sample as in the example shown in FIG. 25B.

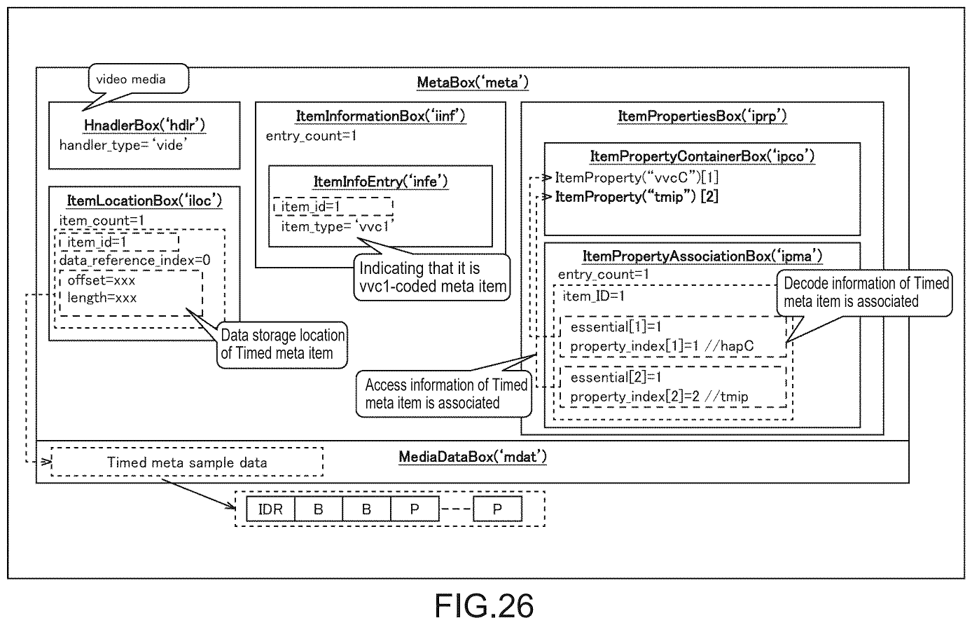

As in the example shown in FIG. 26, such a timed meta item including a plurality of sub-samples is stored in the media data box (MediaDataBox(‘mdat’)). In the handler box (HandlerBox(‘hdlr’)), a handler type for a video media (handler_type=‘vide’) is set. In the item info entry (ItemInfoEntry(‘infe’)) of the item information box (ItemInformationBox(‘iinf’)), item identification information (item_id=1) and item type (item_type=‘vvc1’) are set. In the item location box (ItemLocationBox(‘iloc’)), a storage location of the timed meta item in the media data box is specified by an offset (offset=xxx) and length (length=xxx). In the item property container box (ItemPropertiesContainerBox(‘ipco’)) of the item property box (ItemPropertiesBox(‘iprp’)), property information (ItemProperty(“vvcC”)[1] and ItemProperty(“tmip”)[2]) of this timed meta item is defined. ItemProperty(“vvcC”)[1] is a property that stores the codec information (information related to the codec) of the timed meta item. ItemProperty(“tmip”)[2] is a property that stores the time information and access information of the timed meta item. In addition, in the item property association box (ItemPropertyAssociationBox(‘ipma’)), those pieces of property information are associated with the timed meta item. With such a configuration, the timed media can be managed as the metadata.

That is, for example, the sub-sample duration (sub_sample_duration) may be included in the property information of the timed meta item as the time information related to the time of the sub-sample of the metadata. Further, for example, the sub-sample size (sub_sample_size) may be included in the property information of the timed meta item as the access information used when accessing the sub-sample of the metadata. Furthermore, the sub-sample flag information (sub_sample_flags) may be included in the property information of the timed meta item as the access information.

For example, in the first information processing apparatus, the time information that the file generation unit adds as the property of the metadata may include information indicating a duration of the sub-sample (e.g., sub_sample_duration). Also, the access information that the file generation unit adds as the property of the metadata may include information indicating the size of the sub-sample (e.g., sub_sample_size). Moreover, the access information may include flag information related to the sub-sample (e.g., sub_sample_flags).

Further, in the second information processing apparatus, the time information added as the property of the metadata, that is to be parsed by the parse processing unit, may include the information indicating the duration of the sub-sample (e.g., sub_sample_duration). Further, the access information added as the property of the metadata, that is to be parsed by the parse processing unit, may include the information indicating the size of the sub-sample (e.g., sub_sample_size). Moreover, the access information may also include the flag information related to the sub-sample (e.g., sub_sample_flags).

With the information as described above, it is possible to manage a timed media constituted of a plurality of samples. Therefore, it is possible to suppress an increase in the load of the reproduction processing as compared to the case of the management by tracks.

### Method 2-1-1

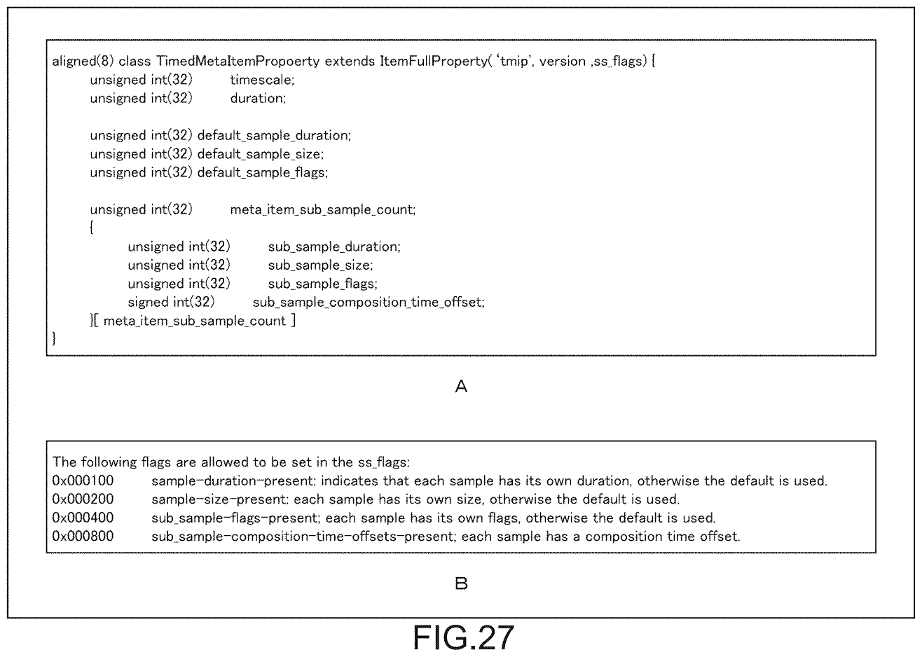

When Method 2-1 described above is applied, for example, as shown on the bottom row of the table shown in FIG. 22, initial values of the time information and access information may be set in the property (Method 2-1-1). An example of the syntax of the timed meta item property (TimedMetaItemProperty) in that case is shown in FIG. 27A. It is noted that in this case, values as those shown in FIG. 27B may be set in ss_flag. In this case, in the timed meta item property, a default sample duration (default_sample_duration), a default sample size (default_sample_size), and default sample flag information (default_sample_flags) are set. The default sample duration (default_sample_duration) indicates an initial value of the sub-sample duration (sub_sample_duration). In other words, when the setting of the sub-sample duration (sub_sample_duration) is omitted, the value of this default sample duration (default_sample_duration) is applied. The default sample size (default_sample_size) indicates an initial value of the sub-sample size (sub_sample_size). That is, when the setting of the sub-sample size (sub_sample_size) is omitted, the value of this default sample size (default_sample_size) is applied. The default sample flag information (default_sample_flags) indicates an initial value of the sub-sample flag information (sub_sample_flags). That is, when the setting of the sub-sample flag information (sub_sample_flags) is omitted, the value of this default sample flag information (default_sample_flags) is applied.

For example, in the first information processing apparatus, the file generation unit may add, as the property of the metadata, the initial value of the time information related to the time of the sub-sample of the metadata and the initial value of the access information used when accessing the sub-sample. For example, the initial value of the time information may include an initial value of information indicating a duration of the sub-sample (default sample duration (default_sample_duration)). Furthermore, the initial value of the access information may include an initial value of information indicating a size of the sub-sample (default sample size (default_sample_size)). Furthermore, the initial value of the access information may also include an initial value of flag information related to the sub-sample (default sample flag information (default_sample_flags)).

For example, in the second information processing apparatus, the parse processing unit may parse the initial value of the time information related to the time of the sub-sample of the metadata and the initial value of the access information used when accessing the sub-sample, that have been added as the property of the metadata. For example, the initial value of the time information may include an initial value of information indicating a duration of the sub-sample (default sample duration (default_sample_duration)). Furthermore, the initial value of the access information may include an initial value of information indicating a size of the sub-sample (default sample size (default_sample_size)). Furthermore, the initial value of the access information may include an initial value of flag information related to the sub-sample (default sample flag information (default_sample_flags)).

With such a configuration, it is possible to omit the setting of these pieces of information for each of the sub-samples. For example, when the values of these pieces of information are the same in all of the sub-samples, the values can be set as default values, and the setting of these pieces of information for each of the sub-samples can be omitted. Therefore, an increase in the amount of data can be suppressed.

### 7 . Method 3

### Fragment Movie

When the “media data constituted of a plurality of samples” described above in <6. Method 2> is regarded as a timed meta item, it has been difficult for the conventional reproduction device to understand access information thereof. In other words, it has been necessary to implement a new function for correctly parsing this access information in the reproduction device. Thus, there has been a fear that costs of the reproduction device will increase.

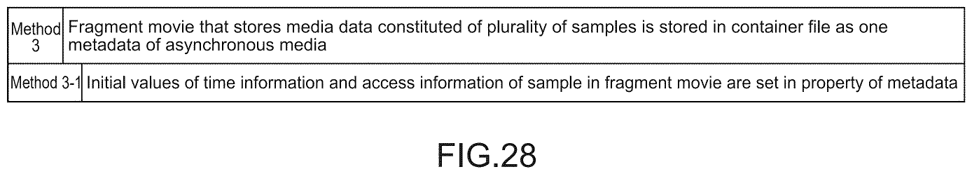

In this regard, as shown on the top row of the table shown in FIG. 28, a fragment movie that stores media data constituted of a plurality of samples is stored in a distribution file as one metadata of an asynchronous media (Method 3). In other words, an existing fragment movie is used to store a timed media constituted of a plurality of samples in the container file as one metadata.

For example, the first information processing apparatus includes: an encoding unit which encodes a fragment movie that stores media data of an asynchronous media to be reproduced asynchronously, that is constituted of a plurality of samples, to generate media encoded data; and a file generation unit which generates a container file and stores the media encoded data in the container file as one metadata.

Further, the second information processing method executed by the second information processing apparatus includes: encoding a fragment movie that stores media data of an asynchronous media to be reproduced asynchronously, that is constituted of a plurality of samples, to generate media encoded data; and generating a container file and storing the media encoded data in the container file as one metadata.

By storing the fragment movie in the container file as the metadata in this manner, the first information processing apparatus can suppress an increase in the load of the reproduction processing for the timed media of a relatively short time as typified by the asynchronous media, as compared to the case of the management by tracks. Also in this case, the reproduction device can understand the access information without requiring implementation of a new function. Therefore, an increase in costs can be suppressed. In addition, a decrease in versatility can be suppressed.

For example, the second information processing apparatus includes: a parse processing unit which parses information related to media encoded data of an asynchronous media to be reproduced asynchronously, that is stored in a container file; a decoding unit which decodes the media encoded data stored in the container file as one metadata in accordance with a result of the parsing and a reproduction condition, to generate a fragment movie that stores media data of the asynchronous media, that is constituted of a plurality of samples; and an output control unit which renders the fragment movie to generate output information, and causes an output unit to output the output information, as reproduction of the asynchronous media.

Further, the second information processing method executed by the second information processing apparatus includes: parsing information related to media encoded data of an asynchronous media to be reproduced asynchronously, that is stored in a container file; decoding the media encoded data stored in the container file as one metadata in accordance with a result of the parsing and a reproduction condition, to generate a fragment movie that stores media data of the asynchronous media, that is constituted of a plurality of samples; and rendering the fragment movie to generate output information, and causing the output information to be output, as reproduction of the asynchronous media.

In this manner, by reproducing the fragment movie stored in the container file as the metadata, the second information processing apparatus can suppress an increase in the load of the reproduction processing for the timed media of a relatively short time as typified by the asynchronous media, as compared to the case of the management by tracks. Also in this case, the second information processing apparatus can understand the access information without requiring implementation of a new function. Therefore, an increase in costs can be suppressed. In addition, a decrease in versatility can be suppressed.

### Timed Meta Item Header

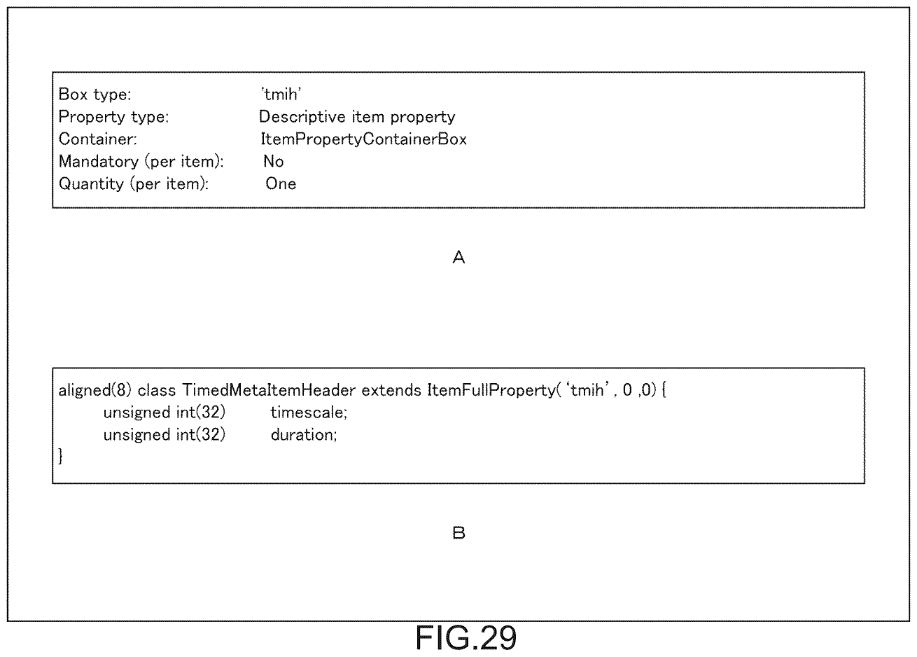

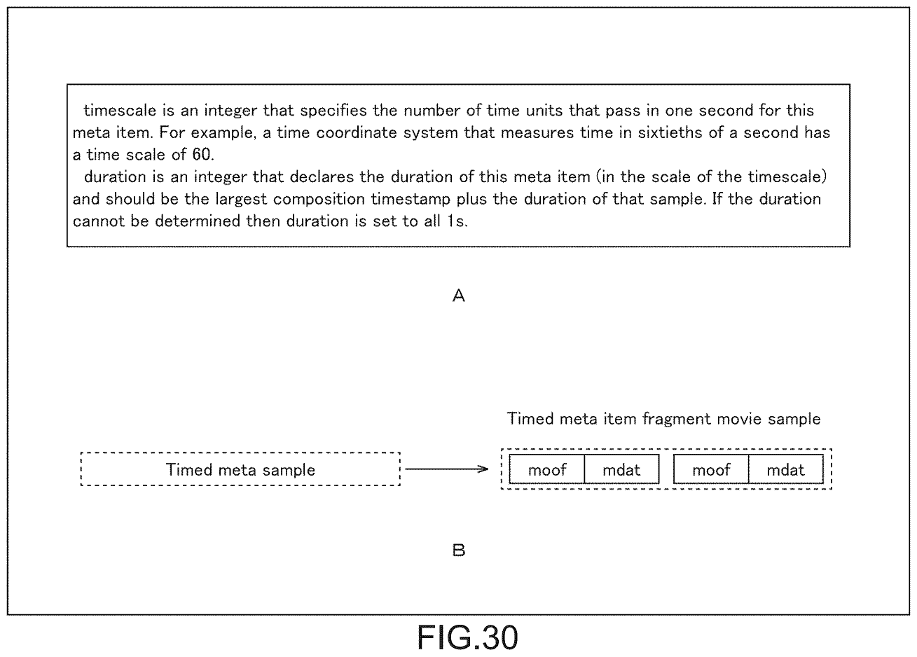

For example, as shown in FIG. 29A, header information of this timed meta item (timed meta item header (TimedMetaItemHeader(‘tmih’)) may be set. An example of the syntax of the timed meta item header (TimedMetaItemHeader(‘tmih’)) is shown in FIG. 29B. As shown in this figure, a timescale and duration may be set in the timed meta item header (TimedMetaItemHeader(‘tmih’)). An example of the semantics thereof is shown in FIG. 30A. The timescale is an integer that specifies the number of time units (will also be referred to as time units) of this meta item that pass in one second. The duration is an integer that specifies a period of this meta item (in a scale of the timescale described above).

When the timed meta item is a fragment movie (fragment movie sample) of a video media, the timed meta item is configured as an array of moof and mdat per predetermined time as in the example shown in FIG. 30B. However, the number of tracks in moof is limited to one.

The information of the sample entry stored in conventional intra moov is stored in the item property of the meta box. By limiting the sample entry index to be referenced from moof to “1” (sample_entry_index=1), it is indicated that the item property information of the meta box is to be used.

Also in this case, time information and access information of the sample in the fragment movie may be set in the timed meta item header. In other words, those pieces of information may be added as property information of the timed meta item. The time information is information related to a time of the sample in the fragment movie. The access information is information used when accessing the sample in the fragment movie.

For example, in the first information processing apparatus, the file generation unit may add time information related to a time of the sample in the fragment movie and access information used when accessing the sample as a property (header information) of the metadata. Further, in the second information processing apparatus, the parse processing unit may parse the time information related to the time of the sample in the fragment movie and the access information used when accessing the sample, which have been added as the property (header information) of the metadata. With such a configuration, the time information and access information related to the sample in the fragment movie can be transmitted to be used for reproduction. Therefore, the fragment movie that stores the timed media constituted of a plurality of samples can be transmitted as metadata and reproduced, and thus it is possible to suppress an increase in the load of the reproduction processing as compared to the case of the management by tracks. Therefore, an increase in costs can be suppressed. In addition, a decrease in versatility can be suppressed.

For example, in the timed meta item header, for each sample of the fragment movie, a sub-sample duration (sub_sample_duration), a sub-sample size (sub_sample_size), sub-sample flag information (sub_sample_flags), a sub-sample composition time offset (sub_sample_composition_time_offset), and the like may be set. As the sub-sample flag information (sub_sample_flags), is_leading, sub_sample_depends_on, sub_sample_is_depended_on, sub_sample_has_redundancy, sub_sample_padding_value, sub_sample_is_non_sync_sample, and the like may be set.

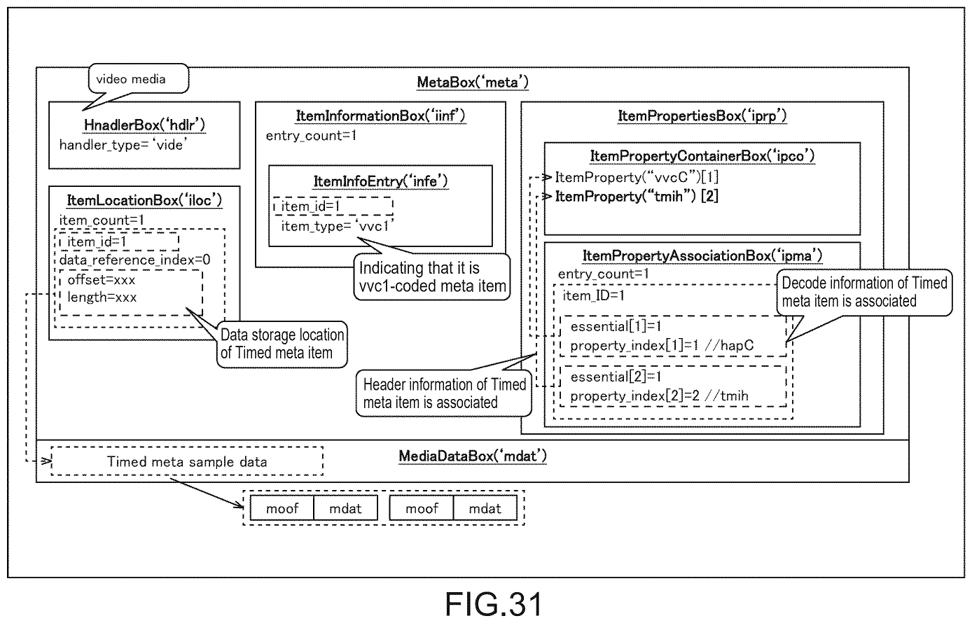

As in the example shown in FIG. 31, a fragment movie that stores such a timed meta item including a plurality of sub-samples is stored in the media data box (MediaDataBox(‘mdat’)). In the handler box (HandlerBox(‘hdlr’)), a handler type for a video media (handler_type=‘vide’) is set. In the item info entry (ItemInfoEntry(‘infe’)) of the item information box (ItemInformationBox(‘iinf’)), item identification information (item_id=1) and item type (item_type=‘vvc1’) are set. In the item location box (ItemLocationBox(‘iloc’)), a storage location of the timed meta item in the media data box is specified by an offset (offset=xxx) and length (length=xxx). In the item property container box (ItemPropertiesContainerBox(‘ipco’)) of the item property box (ItemPropertiesBox(‘iprp’)), the property information of this timed meta item (ItemProperty(“vvcC”)[1] and ItemProperty(“tmih”)[2]) is defined. ItemProperty(“vvcC”)[1] is a property that stores the codec information (information related to the codec) of the timed meta item. ItemProperty(“tmih”)[2] is a property that stores the time information and access information of the fragment movie. Further, in the item property association box (ItemPropertyAssociationBox(‘ipma’)), those pieces of property information are associated with the timed meta item. With such a configuration, the fragment movie can be managed as metadata.

That is, for example, the sub-sample duration (sub_sample_duration) may be included in the timed meta item header as the time information related to the time of the sample of the fragment movie. Further, for example, the sub-sample size (sub_sample_size) may be included in the timed meta item header as the access information used when accessing the sample of the fragment movie. Further, the sub-sample flag information (sub_sample_flags) may be included in the timed meta item header as the access information.

For example, in the first information processing apparatus, the time information that the file generation unit adds as the property of the metadata may include information indicating a duration of the sub-sample (e.g., sub_sample_duration). Further, the access information that the file generation unit adds as the property of the metadata may include information indicating a size of the sub-sample (e.g., sub_sample_size). Further, the access information may include flag information related to the sub-sample (e.g., sub_sample_flags).

Further, in the second information processing apparatus, the time information added as the property of the metadata, that is to be parsed by the parse processing unit, may include information indicating a duration of the sample in the fragment (e.g., sub_sample_duration). Further, the access information added as the property of the metadata, that is to be parsed by the parse processing unit, may include information indicating a size of the sample in the fragment (e.g., sub_sample_size). Further, the access information may include flag information related to the sample in the fragment (e.g., sub_sample_flags).

With the information as described above, it is possible to manage the timed media constituted of a plurality of samples. Therefore, it is possible to suppress an increase in the load of the reproduction processing as compared to the case of the management by tracks.

### Method 3-1

When Method 3 described above is applied, for example, as shown on the bottom row of the table shown in FIG. 28, initial values of the time information and access information of the sample in the fragment movie may be set in the property of the metadata (Method 3-1).

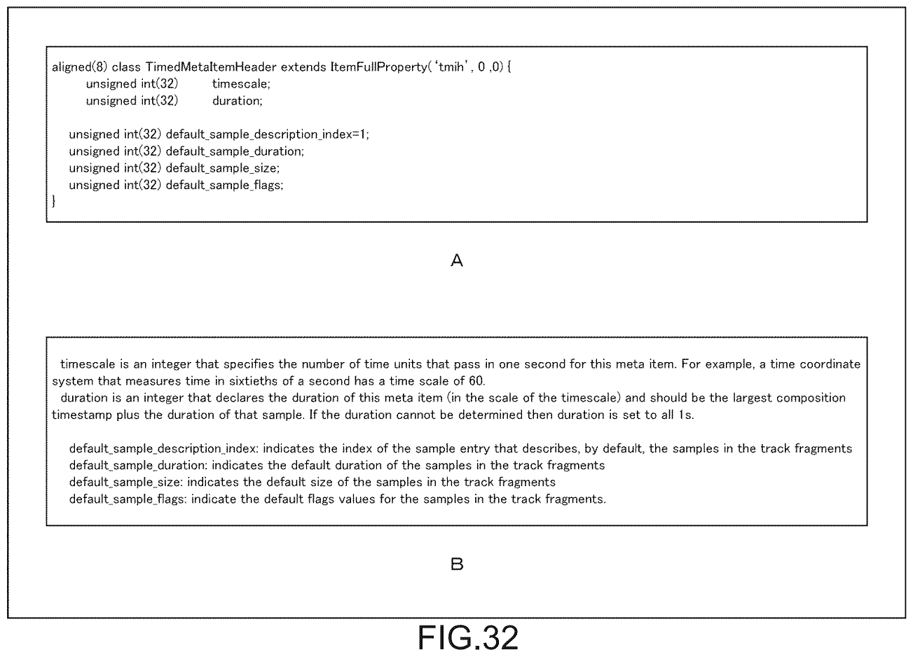

An example of the syntax of the timed meta item header in that case is shown in FIG. 32A. In addition, an example of the semantics of the timed meta item header is shown in FIG. 32B. In this case, in the timed meta item header, a default sample description index (default_sample_description_index=1), a default sample duration (default_sample_duration), a default sample size (default_sample_size), and default sample flag information (default_sample_flags) are set. The default sample description index (default_sample_description_index) indicates an initial value of the index of the sample entry that describes the sample in the track fragment. This default sample description index is set to “1”. In other words, when the setting of the index of the sample entry that describes the sample in the track fragment is omitted, the value of this default sample description index (default_sample_description_index) (i.e., “1”) is applied. The default sample duration (default_sample_duration) indicates an initial value of the duration of the sample in the fragment. In other words, when the setting of the duration of the sample in the fragment is omitted, the value of this default sample duration (default_sample_duration) is applied. The default sample size (default_sample_size) indicates an initial value of the size of the sample in the fragment. In other words, when the setting of the size of the sample in the fragment is omitted, the value of this default sample size (default_sample_size) is applied. The default sample flag information (default_sample_flags) indicates an initial value of flag information related to the sample in the fragment. In other words, when the setting of the flag information related to the sample in the fragment is omitted, the value of this default sample flag information (default_sample_flags) is applied.

For example, in the first information processing apparatus, the file generation unit may add, as the property of the metadata, the initial value of the time information related to the time of the sample in the fragment movie and the initial value of the access information used when accessing the sample in the fragment movie. For example, the initial value of the time information may include an initial value of information indicating a duration of the sample in the fragment movie (default sample duration (default_sample_duration)). Furthermore, the initial value of the access information may include an initial value of an index indicating a sample entry describing the sample in the track fragment (default sample description index (default_sample_description_index)). Furthermore, the initial value of the access information may include an initial value of information indicating a size of the sample in the fragment movie (default sample size (default_sample_size)). Furthermore, the initial value of the access information may include an initial value of flag information related to the sample in the fragment movie (default sample flag information (default_sample_flags)).

For example, in the second information processing apparatus, the parse processing unit may parse the time information related to the time of the sample in the fragment movie and the access information used when accessing the sample in the fragment movie, that have been added as the property of the metadata. For example, the initial value of the time information may include an initial value of information indicating a duration of the sample in the fragment movie (default sample duration (default_sample_duration)). Furthermore, the initial value of the access information may include an initial value of an index indicating a sample entry describing the sample in the track fragment (default sample description index (default_sample_description_index)). Furthermore, the initial value of the access information may include an initial value of information indicating a size of the sample in the fragment movie (default sample size (default_sample_size)). Furthermore, the initial value of the access information may include an initial value of flag information related to the sample in the fragment movie (default sample flag information (default_sample_flags)).

With such a configuration, it is possible to omit the setting of these pieces of information for each of the samples in the fragment movie. For example, when the values of these pieces of information are the same for all of the samples, it is possible to omit the setting of these pieces of information for each of the samples by setting the values as default values. Therefore, it is possible to suppress an increase in the amount of data.

### 8 . Combination

As long as no contradiction is caused, each of the methods described above may be applied in combination with any other method. Three or more of the methods may be applied in combination. For example, two or more methods out of Method 1, Method 2, and Method 3 may be applied in combination. In addition, the techniques that can be combined may include not just those shown in the tables of FIGS. 14, 16, 22, and 28 as “methods”, but also all of the elements described above. In addition, each of the methods described above may be applied in combination with other methods not described above.

It is noted that in the present specification, as long as no contradiction is caused, the descriptions on the higher-order methods also apply to the lower-order methods belonging to that method. For example, in the case of the description “Method 1 may be applied”, one or more of the lower-order methods such as Method 1-1 and Method 1-2 may be applied, or one or more of the further lower-order methods such as Method 1-1-1 and Method 1-1-2 may be applied.

For example, it is assumed that Method 1 is applied, and the first information processing apparatus includes: an encoding unit which encodes media data of an asynchronous media to be reproduced asynchronously, to generate media encoded data; and a file generation unit which generates a container file and stores the media encoded data and asynchronous media information in the container file. It is noted that the asynchronous media information is information that indicates that the media data is of the asynchronous media, and requires parsing for reproducing the asynchronous media. When Method 1 is applied, Method 1-1 may be applied so that the file generation unit stores the asynchronous media information in a handler box of the container file. Further, when Method 1-1 is applied, Method 1-1-1 may be applied so that the file generation unit stores the asynchronous media information in the handler box as information indicating a handler type common to media types. Further, when Method 1-1 is applied, Method 1-1-2 may be applied so that the file generation unit stores the asynchronous media information in the handler box as information indicating a handler type for each media type.

Further, when Method 1 is applied, Method 1-2 may be applied so that the file generation unit stores an essential track reference in the container file as the asynchronous media information. It is noted that the essential track reference is information that indicates that the media data is of the asynchronous media by the reference relationship between tracks, and requires parsing for reproducing the asynchronous media. Further, when Method 1-2 is applied, Method 1-2-1 may be applied so that the file generation unit stores, in the container file, an essential track reference specifying an index that indicates a track reference type indicating that the media data is of the asynchronous media. Further, when Method 1-2-1 is applied, Method 1-2-1-1 may be applied so that the file generation unit further sets flag information of a sample group description box of the essential track reference so as to indicate that the essential track reference is information of an entire track.

Furthermore, when Method 1-2 is applied, Method 1-2-2 may be applied so that the file generation unit stores, in the container file, an essential track reference that stores a track reference type indicating that the media data is of the asynchronous media. Furthermore, when Method 1-2-2 is applied, Method 1-2-2-1 may be applied so that the file generation unit further sets flag information of a sample group description box of the essential track reference so as to indicate that the essential track reference is information of an entire track.

Furthermore, when Method 1 is applied, Method 2 may be applied so that the encoding unit encodes the media data of the asynchronous media, that is constituted of a plurality of samples, to generate media encoded data, and the file generation unit stores the media encoded data in the container file as one metadata. Furthermore, when Methods 1 and 2 are applied, Method 2-1 may be applied so that the file generation unit adds time information related to a time of a sub-sample of the metadata and access information used when accessing the sub-sample as a property of the metadata. Furthermore, when Method 2-1 is applied, Method 2-1-1 may be applied so that the file generation unit adds an initial value of the time information and an initial value of the access information as the property of the metadata.

Furthermore, when Method 1 is applied, Method 3 may be applied so that the encoding unit encodes a fragment movie that stores media data of the asynchronous media, that is constituted of a plurality of samples, to generate media encoded data, and the file generation unit stores the media encoded data in the container file as one metadata. Furthermore, when Methods 1 and 3 are applied, Method 3-1 may be applied so that the file generation unit adds, as the property of the metadata, an initial value of time information related to a time of a sample in the fragment movie and an initial value of access information used when accessing the sample in the fragment movie.

For example, it is assumed that Method 1 is applied, and the second information processing apparatus includes: a parse processing unit which parses asynchronous media information stored in a container file; a decoding unit which decodes media encoded data stored in the container file in accordance with a result of the parsing and a reproduction condition, to generate media data of an asynchronous media to be reproduced asynchronously; and an output control unit which renders the media data to generate output information, and causes an output unit to output the output information, as reproduction of the asynchronous media. It is noted that the asynchronous media information is information that indicates that the media data is of the asynchronous media, and requires parsing for reproducing the asynchronous media. When Method 1 is applied, Method 1-1 may be applied so that the parse processing unit parses the asynchronous media information stored in a handler box of the container file. Further, when Method 1 is applied, Method 1-2 may be applied so that the parse processing unit parses an essential track reference stored in the container file as the asynchronous media information. It is noted that the essential track reference is information that indicates that the media data is of the asynchronous media by the reference relationship between tracks, and requires parsing for reproducing the asynchronous media. Furthermore, when Method 1 is applied, the parse processing unit may determine whether or not the asynchronous media information can be parsed, and when the asynchronous media information cannot be parsed, omit reproduction of the asynchronous media.

### 9 . Matryoshka Media Container

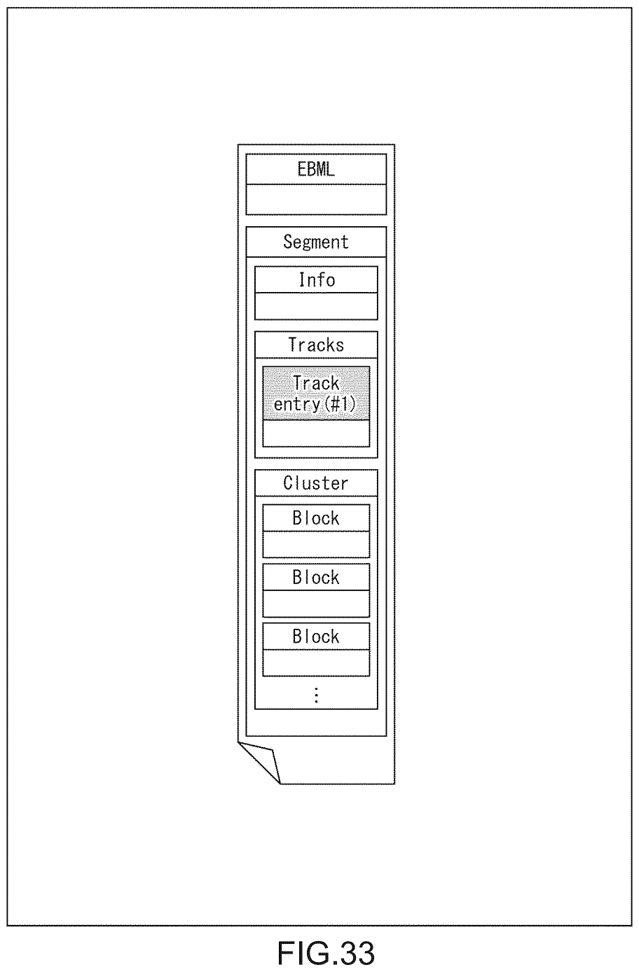

In the descriptions above, the ISOBMF file has been taken as an example of the container file, but the format and/or specifications of the container file for performing extended definition of a media associated with 3D data may be any format and/or specification and are not limited to ISOBMFF. For example, a Matryoshka media container as shown in FIG. 33 may be used. Of course, other formats may also be used.

### 10 . First Embodiment

### File Generation Device

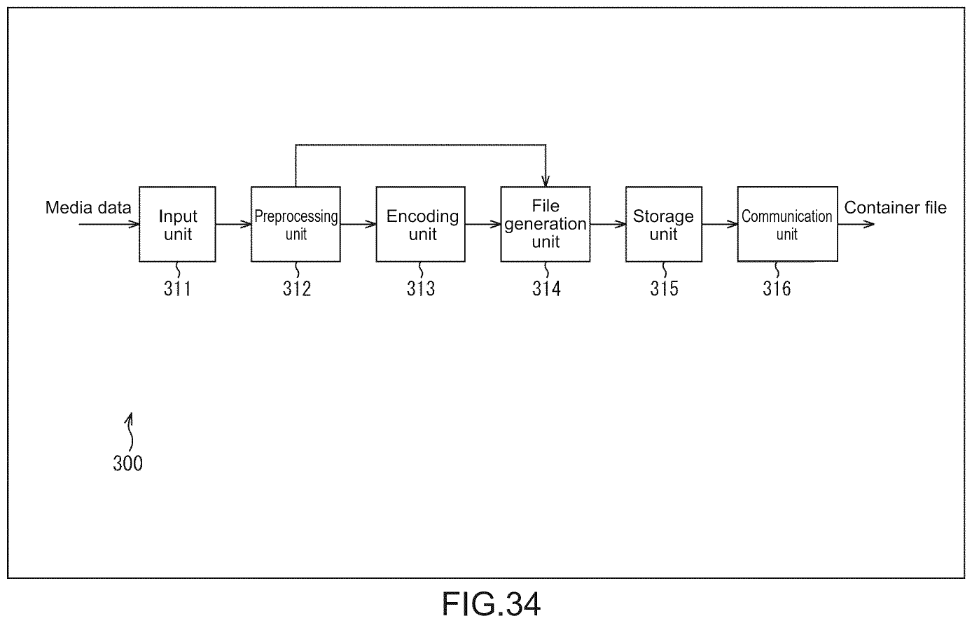

The present technology described above can be applied to any device. FIG. 34 is a block diagram showing an example of a configuration of a file generation device, which is one aspect of the information processing apparatus to which the present technology is applied. The file generation device 300 shown in FIG. 34 is a device that encodes media data and stores media encoded data thereof in a container file.

It is noted that FIG. 34 shows main processing units, data flows, and the like, and not everything is shown in FIG. 34. In other words, in the file generation device 300, there may be processing units that are not shown as blocks in FIG. 34, or there may be processing and data flows that are not shown as arrows and/or the like in FIG. 34.

As shown in FIG. 34, file generation device 300 includes an input unit 311, a preprocessing unit 312, an encoding unit 313, a file generation unit 314, a storage unit 315, and a communication unit 316.

The input unit 311 performs processing related to acquisition of data supplied from outside the file generation device 300. For example, the input unit 311 may acquire media data supplied to the file generation device 300. This media data may include a synchronous media and/or an asynchronous media. This media data may include a plurality of types of media. The input unit 311 may acquire other information related to the media data. The input unit 311 may supply the acquired media data and/or the like to the preprocessing unit 312. It is noted that herein, the media data may be stored in a media file. However, in descriptions below, descriptions on the media file will be omitted and descriptions will be given as media data.

The preprocessing unit 312 executes processing related to preprocessing performed on the data supplied from the input unit 311 before encoding. For example, the preprocessing unit 312 may acquire media data and/or the like supplied from the input unit 311. The preprocessing unit 312 may acquire meta information related to the media data from the acquired media data and/or the like. The preprocessing unit 312 may supply the acquired media data and/or the like to the encoding unit 313. The preprocessing unit 312 may supply the meta information acquired from the media data and/or the like (meta information related to the media data) to the file generation unit 314.

The encoding unit 313 executes processing related to encoding of 3D data. For example, the encoding unit 313 may acquire data (media data and the like) supplied from the preprocessing unit 312. The encoding unit 313 may encode the acquired media data using an encoding method corresponding to the media data, to generate media encoded data. This media encoded data may include encoded data of a synchronous media and/or an asynchronous media. This media encoded data may include encoded data of a plurality of types of media. The encoding unit 313 may also encode data other than media data. The encoding unit 313 may supply the generated media encoded data and/or the like to the file generation unit 314. It is noted that herein, the media encoded data and/or the like may be stored in a file (e.g., a media file and/or the like). However, in descriptions below, descriptions on the media file and/or the like will be omitted, and descriptions will be given as media encoded data and/or the like.

The file generation unit 314 performs processing related to generation of a container file and/or the like. For example, the file generation unit 314 may acquire media encoded data and/or the like supplied from the encoding unit 313. The file generation unit 314 may generate a container file (e.g., an ISOBMFF file or a Matryoshka media container) and store the acquired media encoded data and/or the like. The file generation unit 314 may acquire meta information (meta information related to media data) supplied from the preprocessing unit 312. The file generation unit 314 may store the meta information (meta information related to media data) in the container file. The file generation unit 314 may supply the generated container file to the storage unit 315.

The storage unit 315 includes, for example, an arbitrary storage medium such as a hard disk or a semiconductor memory, and executes processing related to data storage. For example, the storage unit 315 may acquire a container file supplied from the file generation unit 314. The storage unit 315 may store the acquired container file. The storage unit 315 may supply the stored container file to the communication unit 316 in response to a request from a user, the communication unit 316, or the like, or at a predetermined timing. It is noted that the storage unit 315 may be a removable medium that is detachable from the file generation device 300. Thus, the container file may be output from the file generation device 300 (supplied to the outside of the file generation device 300) by removing the storage unit 315 from the file generation device 300. In other words, the container file may be output from the file generation device 300 (supplied to the outside of the file generation device 300) via the storage unit 315, which is the removable medium. Therefore, the storage unit 315 can also be referred to as an output unit (or supply unit).

The communication unit 316 has a communication function for communicating with the outside of the file generation device 300 (e.g., a distribution server for the container file, a reproduction device, or the like), and executes processing related to supply of the container file via that communication. For example, the communication unit 316 may acquire a container file supplied from the storage unit 315. The communication unit 316 may communicate with the outside of the file generation device 300 using the communication function, and supply the acquired container file to the communication partner (output to the outside of the file generation device 300) via that communication. Therefore, the communication unit 316 can also be referred to as an output unit (or supply unit).

Using the file generation device 300 configured as described above as the first information processing apparatus described above, one or more of the present technology described above from <3. Method 1> to <9. Matryoshka media container> may be applied.

For example, Method 1 may be applied so that, in the file generation device 300, the encoding unit 313 encodes media data of an asynchronous media to be reproduced asynchronously, to generate media encoded data. Then, the file generation unit 314 may generate a container file and store the media encoded data and asynchronous media information in the container file. It is noted that the asynchronous media information is information that indicates that the media data is of the asynchronous media, and requires parsing for reproducing the asynchronous media. With such a configuration, the file generation device 300 can suppress unauthorized reproduction of the asynchronous media.

Further, Method 1-1 may be applied so that, in the file generation device 300, the encoding unit 313 encodes media data of an asynchronous media to be reproduced asynchronously, to generate media encoded data. Then, file generation unit 314 may generate a container file, store the media encoded data in the container file, and further store asynchronous media information indicating that the media data is of the asynchronous media in a handler box of the container file. With such a configuration, the file generation device 300 can suppress unauthorized reproduction of the asynchronous media.

Further, Method 1-1-1 may be applied so that the file generation unit 314 stores the asynchronous media information in the handler box as information indicating a handler type common to media types. With such a configuration, the file generation device 300 can suppress unauthorized reproduction of the asynchronous media without extending the handler type indicating the media type. Furthermore, Method 1-1-2 may be applied so that the file generation unit 314 stores the asynchronous media information in the handler box as information indicating a handler type of each media type. With such a configuration, the file generation device 300 can suppress unauthorized reproduction of the asynchronous media without extending the version of the handler box.

Further, Method 1-2 may be applied so that, in the file generation device 300, the encoding unit 313 encodes media data of an asynchronous media to be reproduced asynchronously, to generate media encoded data. Then, the file generation unit 314 may generate a container file and store the media encoded data and an essential track reference in the container file. It is noted that the essential track reference is information that indicates that the media data is of the asynchronous media by the reference relationship between tracks, and requires parsing for reproducing the asynchronous media. With such a configuration, the file generation device 300 can suppress unauthorized reproduction of the asynchronous media.

Further, Method 1-2-1 may be applied so that the file generation unit 314 stores, in the container file, an essential track reference specifying an index that indicates a track reference type indicating that the media data is of the asynchronous media. With such a configuration, the file generation device 300 can suppress unauthorized reproduction of the asynchronous media. In addition, when reference to all track reference types is required, the file generation unit 314 may store, in the container file, an essential track reference for which specifying of the index has been omitted. With such a configuration, the file generation device 300 can suppress an increase in the amount of data of the container file when reference to all track reference types is required.

Further, Method 1-2-2 may be applied so that the file generation unit 314 stores, in the container file, an essential track reference that stores a track reference type indicating that the media data is of the asynchronous media. With such a configuration, the file generation device 300 can suppress unauthorized reproduction of the asynchronous media.

Further, Method 1-2-1-1 or Method 1-2-2-1 may be applied so that the file generation unit 314 further sets flag information of a sample group description box of the essential track reference so as to indicate that the essential track reference is information of an entire track. In that case, the file generation unit 314 may set the values of statci_group_description and static_mapping, that are the flag information, to “1”. With such a configuration, the file generation device 300 can store the essential track reference as information of an entire track.

Further, Method 2 may be applied so that, in the file generation device 300, the encoding unit 313 encodes media data of an asynchronous media to be reproduced asynchronously, that is constituted of a plurality of samples, to generate media encoded data. Then, the file generation unit 314 may generate a container file and store the media encoded data in the container file as one metadata. With such a configuration, the file generation device 300 can suppress an increase in the load of the reproduction processing as compared to the case of the management by tracks.

Further, Method 2-1 may be applied so that the file generation unit 314 adds, as a property of the metadata, time information related to a time of a sub-sample of the metadata and access information used when accessing the sub-sample. For example, the time information may include information indicating a duration of the sub-sample (e.g., sub_sample_duration). Further, the access information may include information indicating a size of the sub-sample (e.g., sub_sample_size). Further, the access information may include flag information related to the sub-sample (e.g., sub_sample_flags). With such a configuration, the file generation device 300 can suppress an increase in the load of the reproduction processing as compared to the case of the management by tracks.

Further, Method 2-1-1 may be applied so that the file generation unit 314 adds, as a property of the metadata, an initial value of time information related to a time of a sub-sample of the metadata and an initial value of access information used when accessing the sub-sample. For example, the initial value of the time information may include an initial value of information indicating a duration of the sub-sample (default sample duration (default_sample_duration)). Further, the initial value of the access information may include an initial value of information indicating a size of the sub-sample (default sample size (default_sample_size)). Further, the initial value of the access information may include an initial value of flag information related to the sub-sample (default sample flag information (default_sample_flags)). With such a configuration, the file generation device 300 can suppress an increase in the amount of data.

Further, Method 3 may be applied so that, in the file generation device 300, the encoding unit 313 encodes a fragment movie that stores media data of an asynchronous media to be reproduced asynchronously, that is constituted of a plurality of samples, to generate media encoded data. Then, the file generation unit 314 may generate a container file and store the media encoded data in the container file as one metadata. With such a configuration, the file generation device 300 can suppress an increase in the load of the reproduction processing as compared to the case of the management by tracks. In addition, an increase in costs can be suppressed. In addition, a decrease in versatility can be suppressed.

Further, Method 3-1 may be applied so that the file generation unit 314 adds, as a property of the metadata, an initial value of time information related to a time of the sample in the fragment movie and an initial value of access information used when accessing the sample in the fragment movie. For example, the initial value of the time information may include an initial value of information indicating a duration of the sample in the fragment movie (default sample duration (default_sample_duration)). Further, the initial value of the access information may include an initial value of an index indicating a sample entry describing the sample in the track fragment (default sample description index (default_sample_description_index)). Further, the initial value of the access information may include an initial value of information indicating a size of the sample in the fragment movie (default sample size (default_sample_size)). Further, the initial value of the access information may include an initial value of flag information related to the sample in the fragment movie (default sample flag information (default_sample_flags)). With such a configuration, the file generation device 300 can suppress an increase in the amount of data.

### File Generation Processing Flow 1

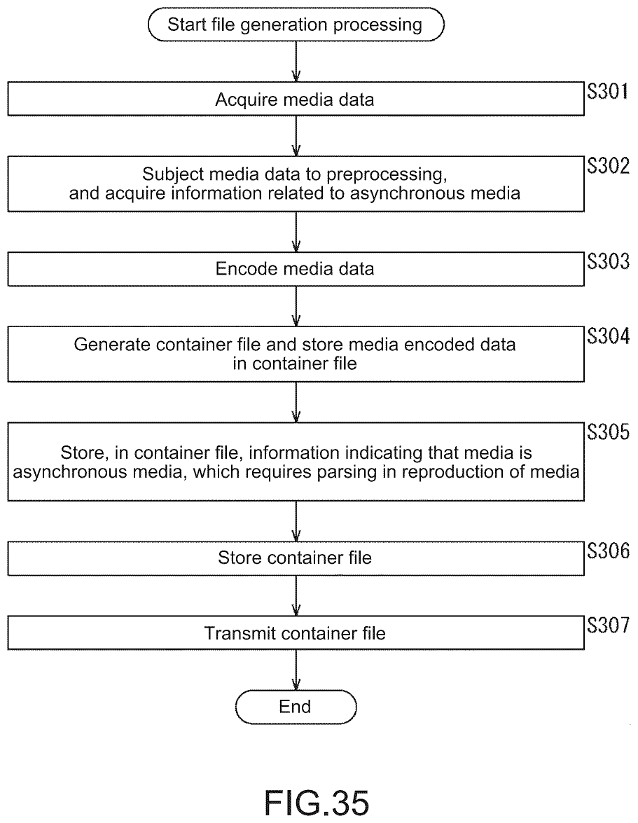

Next, descriptions will be given on file generation processing executed by the file generation device 300. An example of a flow of the file generation processing in the case where Method 1 is applied will be described with reference to the flowchart shown in FIG. 35.

When the file generation processing is started, the input unit 311 of the file generation device 300 acquires media data in Step S301.

In Step S302, the preprocessing unit 312 preprocesses the media data and acquires information related to an asynchronous media.

In Step S303, the encoding unit 313 encodes the media data to generate media encoded data. For example, the encoding unit 313 encodes media data of an asynchronous media to be reproduced asynchronously, to generate media encoded data.

In Step S304, the file generation unit 314 generates a container file and stores the generated media encoded data in the container file.

In Step S305, the file generation unit 314 stores, in the container file, asynchronous media information that indicates that the media data is of the asynchronous media, and requires parsing for reproducing the asynchronous media. For example, the file generation unit 314 may store the asynchronous media information that indicates that the media data is of the asynchronous media in a handler box of the container file. The file generation unit 314 may also store, in the container file, an essential track reference that indicates that the media data is of the asynchronous media by a reference relationship between tracks, and requires parsing for reproducing the asynchronous media.

In Step S306, the storage unit 315 stores the container file.

In Step S307, the communication unit 316 reads the container file from the storage unit 315 and transmits the container file.

When the processing of Step S307 ends, the file generation processing ends.

By executing each processing in this manner, the file generation device 300 can suppress unauthorized reproduction of the asynchronous media.

### File Generation Processing Flow 2

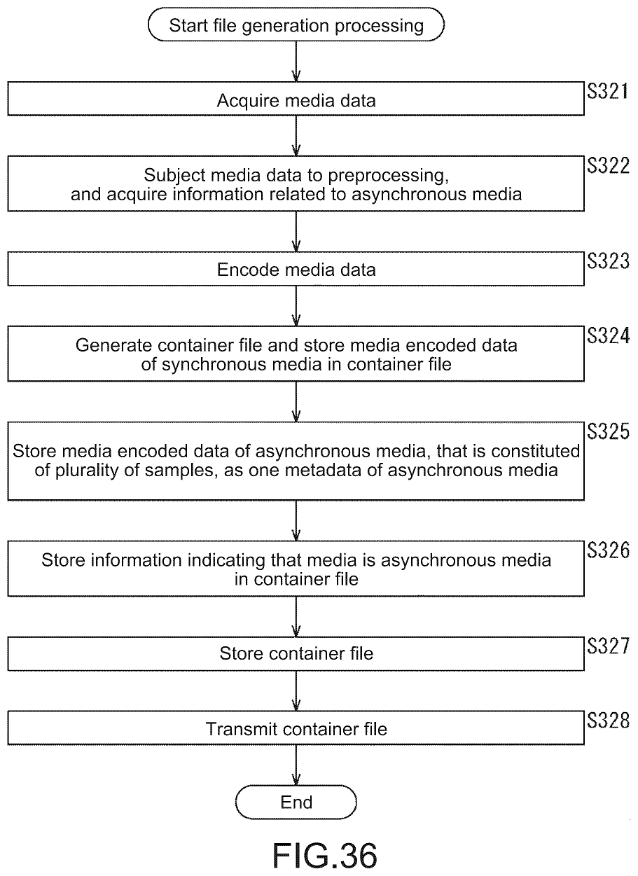

Next, an example of a flow of the file generation processing in the case where Method 2 is applied will be described with reference to the flowchart shown in FIG. 36.

When the file generation processing is started, the input unit 311 of the file generation device 300 acquires media data in Step S321.

In Step S322, the preprocessing unit 312 preprocesses the media data and acquires information related to an asynchronous media.

In Step S323, the encoding unit 313 encodes the media data to generate media encoded data. For example, the encoding unit 313 encodes media data of an asynchronous media to be reproduced asynchronously, that is constituted of a plurality of samples, to generate media encoded data.

In Step S324, the file generation unit 314 generates a container file and stores media encoded data of a synchronous media in the container file.

In Step S325, the file generation unit 314 stores, in the container file, the media encoded data of the asynchronous media that is constituted of a plurality of samples as one metadata of the asynchronous media.

In Step S326, the file generation unit 314 stores information indicating that the media is the asynchronous media in the container file.

In Step S327, the storage unit 315 stores the container file.

In Step S328, the communication unit 316 reads the container file from the storage unit 315 and transmits the container file.

When the processing of Step S328 ends, the file generation processing ends.

By executing each processing in this manner, the file generation device 300 can suppress an increase in the load of the reproduction processing as compared to the case of the management by tracks.

### File Generation Processing Flow 3

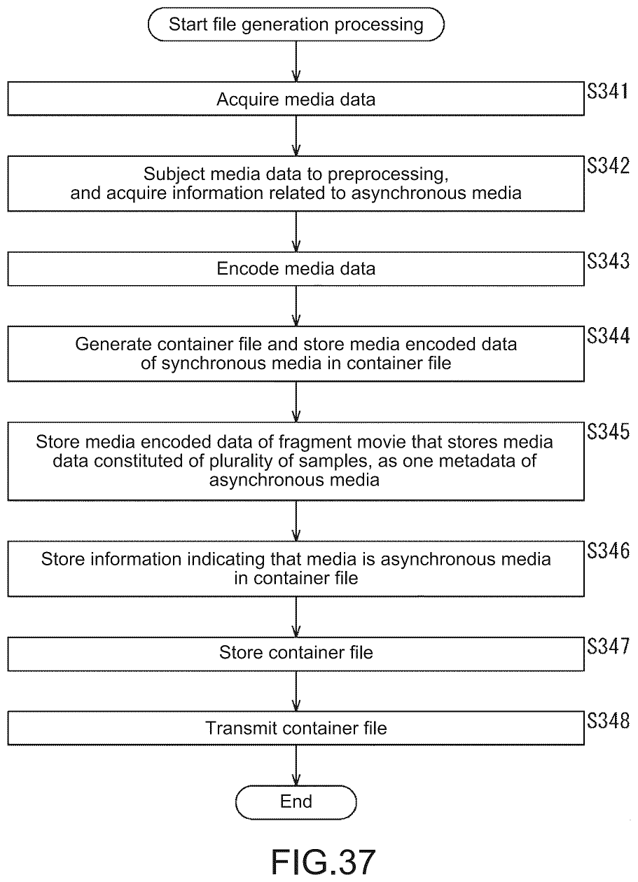

Next, an example of a flow of the file generation processing in the case where Method 3 is applied will be described with reference to the flowchart shown in FIG. 37.

When the file generation processing is started, the input unit 311 of the file generation device 300 acquires media data in Step S341.

In Step S342, the preprocessing unit 312 preprocesses the media data and acquires information related to an asynchronous media.

In Step S343, the encoding unit 313 encodes the media data to generate media encoded data. For example, the encoding unit 313 encodes a fragment movie that stores media data of an asynchronous media to be reproduced asynchronously, that is constituted of a plurality of samples, to generate media encoded data.

In Step S344, the file generation unit 314 generates a container file and stores media encoded data of a synchronous media in the container file.

In Step S345, the file generation unit 314 stores the media encoded data of the fragment movie constituted of the plurality of samples in the container file as one metadata of the asynchronous media.

In Step S346, the file generation unit 314 stores information indicating that the media is the asynchronous media in the container file.

In Step S347, the storage unit 315 stores the container file.

In Step S348, the communication unit 316 reads the container file from the storage unit 315 and transmits the container file.

When the processing of Step S348 ends, the file generation processing ends.

By executing each processing in this manner, the file generation device 300 can suppress an increase in the load of the reproduction processing as compared to the case of the management by tracks. In addition, an increase in costs can be suppressed. In addition, a decrease in versatility can be suppressed.

### 11. Second Embodiment

### Reproduction Device

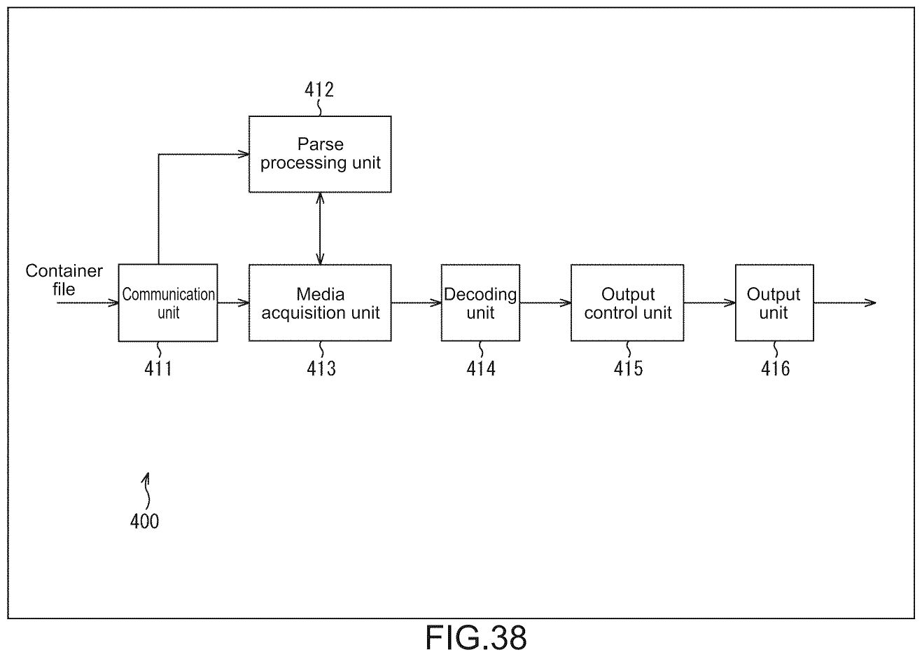

The present technology described above can be applied to any device. FIG. 38 is a block diagram showing an example of a configuration of a reproduction device, which is one aspect of the information processing apparatus to which the present technology is applied. The reproduction device 400 shown in FIG. 38 is a reproduction device that performs reproduction processing of media data. For example, the reproduction device 400 acquires a container file generated by the file generation device 300, and acquires and reproduces media data stored in the container file.

It is noted that FIG. 38 shows main processing units, data flows, and the like, and not everything is shown in FIG. 38. In other words, in the reproduction device 400, there may be processing units that are not shown as blocks in FIG. 38, or there may be processing and data flows that are not shown as arrows and/or the like in FIG. 38.

As shown in FIG. 38, the reproduction device 400 includes a communication unit 411, a parse processing unit 412, a media acquisition unit 413, a decoding unit 414, an output control unit 415, and an output unit 416.

The communication unit 411 has a communication function for communicating with the outside of the reproduction device 400 (e.g., a distribution server for a container file, the file generation device 300, and the like), and executes processing related to acquisition of a container file via that communication. For example, the communication unit 411 may communicate with the outside of the reproduction device 400 to acquire a container file supplied from the communication partner via that communication. The communication unit 411 may supply the acquired container file to the parse processing unit 412. The communication unit 411 may also supply the acquired container file to the media acquisition unit 413. Therefore, the communication unit 411 can also be referred to as an acquisition unit (or input unit).

The parse processing unit 412 executes processing related to parsing. For example, the parse processing unit 412 may acquire a container file supplied from the communication unit 411. The parse processing unit 412 may parse information stored in the container file (information for managing media data stored in the container file). The parse processing unit 412 may supply a parsing result to the media acquisition unit 413.

The media acquisition unit 413 executes processing related to acquisition of media data stored in a container file. For example, the media acquisition unit 413 may acquire a container file supplied from the communication unit 411. The media acquisition unit 413 may acquire the parsing result supplied from the parse processing unit 412. The media acquisition unit 413 may acquire desired media encoded data from the container file based on the parsing result. For example, the media acquisition unit 413 may acquire media encoded data of a synchronous media from the container file based on the parsing result. The media acquisition unit 413 may also acquire media encoded data of an asynchronous media from the container file based on the parsing result and a predetermined reproduction condition. The media acquisition unit 413 may supply the acquired media encoded data to the decoding unit 414.

The decoding unit 414 executes processing related to decoding of the media encoded data. For example, the decoding unit 414 may acquire the media encoded data supplied from the media acquisition unit 413. The decoding unit 414 may decode the media encoded data using an encoding method corresponding to the media, to generate media data. That is, the decoding unit 414 may decode the media encoded data stored in the container file based on the parsing result and/or the like. For example, the decoding unit 414 may decode the media encoded data stored in the container file based on the parsing result, to generate media data of a synchronous media. The decoding unit 414 may also decode the media encoded data stored in the container file based on the parsing result and a predetermined reproduction condition, to generate media data of an asynchronous media. The decoding unit 414 may supply the generated media data to the output control unit 415.

The output control unit 415 performs processing related to output control of media data. For example, the output control unit 415 may acquire media data supplied from the decoding unit 414. The output control unit 415 may render the media data to generate output information (e.g., image information to be displayed on a display device such as a monitor, an audio signal to be output from an audio output device such as a speaker, a vibration signal for causing a haptics device such as a vibration device to vibrate, and/or the like). The output control unit 415 may supply the generated output information to the output unit 416. In other words, the output control unit 415 may output the output information from an output device that supports the media (e.g., a monitor, a speaker, a vibration device, or the like). Therefore, the output control unit 415 can also be referred to as a display control unit, an audio output control unit, a vibration output control unit, or the like.

The output unit 416 includes a display device, an audio output device, a haptics device, and/or the like, and performs processing related to the output of information (image display, audio output, haptics media output (e.g., vibration output), and the like). For example, the output unit 416 may acquire output information supplied from the output control unit 415. The output unit 416 may output the output information using the output device that supports the media. Therefore, the output unit 416 can also be referred to as a display unit, an audio output unit, a vibration output unit, and/or the like.

Using the reproduction device 400 configured as described above as the second information processing apparatus described above, one or more of the present technology described above from <3. Method 1> to <9. Matryoshka media container> may be applied.

For example, Method 1 may be applied so that, in the reproduction device 400, the parse processing unit 412 parses asynchronous media information stored in a container file. Then, the decoding unit 414 may decode media encoded data stored in the container file in accordance with a result of the parsing and a reproduction condition, to generate media data of an asynchronous media to be reproduced asynchronously. Then, the output control unit 415 may render the media data to generate output information, and cause the output unit 416 to output the output information, as reproduction of the asynchronous media. It is noted that the asynchronous media information is information that indicates that the media data is of the asynchronous media, and requires parsing for reproducing the asynchronous media. Further, the parse processing unit 412 may determine whether or not the asynchronous media information can be parsed, and when the asynchronous media information cannot be parsed, omit the reproduction of the asynchronous media. With such a configuration, the reproduction device 400 can suppress unauthorized reproduction of the asynchronous media.

Further, Method 1-1 may be applied so that, in the reproduction device 400, the parse processing unit 412 parses asynchronous media information that is stored in a handler box of a container file and indicates that media encoded data stored in the container file is of an asynchronous media to be reproduced asynchronously. Then, the decoding unit 414 may decode the media encoded data in accordance with a result of the parsing and a reproduction condition, to generate media data of the asynchronous media. Then, the output control unit 415 may render the media data to generate output information, and cause the output unit 416 to output the output information, as reproduction of the asynchronous media. With such a configuration, the reproduction device 400 can suppress unauthorized reproduction of the asynchronous media.

Further, Method 1-1-1 may be applied so that the parse processing unit 412 parses asynchronous media information stored in the handler box as information indicating a handler type common to media types. With such a configuration, the reproduction device 400 can suppress unauthorized reproduction of the asynchronous media without extending the handler type indicating a media type. Further, Method 1-1-2 may be applied so that the parse processing unit 412 parses the asynchronous media information stored in the handler box as information indicating a handler type of each media type. With such a configuration, the reproduction device 400 can suppress unauthorized reproduction of the asynchronous media without extending a version of the handler box.

Further, Method 1-2 may be applied so that, in the reproduction device 400, the parse processing unit 412 parses an essential track reference stored in the container file. Then, the decoding unit 414 may decode media encoded data stored in the container file in accordance with a result of the parsing and a reproduction condition, to generate media data of an asynchronous media to be reproduced asynchronously. Then, the output control unit 415 may render the media data to generate output information, and cause the output unit to output the output information, as reproduction of the asynchronous media. It is noted that the essential track reference is information that indicates that the media data is of the asynchronous media by a reference relationship between tracks, and requires parsing for reproducing the asynchronous media. With such a configuration, the reproduction device 400 can suppress unauthorized reproduction of the asynchronous media.

Further, Method 1-2-1 may be applied so that the parse processing unit 412 parses a track reference of a type corresponding to an index specified in the essential track reference. With such a configuration, the reproduction device 400 can suppress unauthorized reproduction of the asynchronous media. Further, the parse processing unit 412 may parse all types of track references when the specifying of the index is omitted in the essential track reference. With such a configuration, the reproduction device 400 can suppress an increase in the amount of data of the container file when reference to all track reference types is required.

Further, Method 1-2-2 may be applied so that the parse processing unit 412 parses a track reference stored in the essential track reference. With such a configuration, the reproduction device 400 can suppress unauthorized reproduction of the asynchronous media.

Further, Method 1-2-1-1 or Method 1-2-2-1 may be applied so that the parse processing unit 412 parses flag information of a sample group description box of the essential track reference. In that case, the parse processing unit 412 may parse statci_group_description and static_mapping, that are the flag information. With such a configuration, the reproduction device 400 can store the essential track reference as information of an entire track.

Further, Method 2 may be applied so that, in the reproduction device 400, the parse processing unit 412 parses information related to media encoded data of an asynchronous media to be reproduced asynchronously, that is stored in a container file. Then, the decoding unit 414 may decode the media encoded data stored in the container file as one metadata in accordance with a result of the parsing and a reproduction condition, to generate media data of the asynchronous media, that is constituted of a plurality of samples. Then, the output control unit 415 may render the media data to generate output information, and cause the output unit 416 to output the output information, as reproduction of the asynchronous media. With such a configuration, the reproduction device 400 can suppress an increase in the load of the reproduction processing as compared to the case of the management by tracks.

Further, Method 2-1 may be applied so that the parse processing unit 412 parses time information related to a time of a sub-sample of the metadata and access information used when accessing the sub-sample, that have been added as a property of the metadata. For example, the time information may include information indicating a duration of the sub-sample (e.g., sub_sample_duration). Further, the access information may include information indicating a size of the sub-sample (e.g., sub_sample_size). Further, the access information may include flag information related to the sub-sample (e.g., sub_sample_flags). With such a configuration, the reproduction device 400 can suppress an increase in the load of the reproduction processing as compared to the case of the management by tracks.

Further, Method 2-1-1 may be applied so that the parse processing unit 412 parses an initial value of time information related to a time of a sub-sample of the metadata and an initial value of access information used when accessing the sub-sample, that have been added as a property of the metadata. For example, the initial value of the time information may include an initial value of information indicating a duration of the sub-sample (default sample duration (default_sample_duration)). Further, the initial value of the access information may include an initial value of information indicating a size of the sub-sample (default sample size (default_sample_size)). Further, the initial value of the access information may include an initial value of flag information related to the sub-sample (default sample flag information (default_sample_flags)). With such a configuration, the reproduction device 400 can suppress an increase in the amount of data.

Further, Method 3 may be applied so that, in the reproduction device 400, the parse processing unit 412 parses information related to media encoded data of an asynchronous media to be reproduced asynchronously, that is stored in the container file. Then, the decoding unit 414 may decode the media encoded data stored in the container file as one metadata in accordance with a result of the parsing and a reproduction condition, to generate a fragment movie that stores media data of the asynchronous media, that is constituted of a plurality of samples. Then, the output control unit 415 may render the fragment movie to generate output information, and cause the output unit 416 to output the output information, as reproduction of the asynchronous media. With such a configuration, the reproduction device 400 can suppress an increase in the load of the reproduction processing as compared to the case of the management by tracks. In addition, an increase in costs can be suppressed. In addition, a decrease in versatility can be suppressed.

Further, Method 3-1 may be applied so that the parse processing unit 412 parses time information related to a time of the sample in the fragment movie and access information used when accessing the sample in the fragment movie, that have been added as a property of the metadata. For example, an initial value of the time information may include an initial value of information indicating a duration of the sample in the fragment movie (default sample duration (default_sample_duration)). Further, an initial value of the access information may include an initial value of an index indicating a sample entry describing the sample in a track fragment (default sample description index (default_sample_description_index)). Further, an initial value of the access information may include an initial value of information indicating a size of the sample in the fragment movie (default sample size (default_sample_size)). Further, the initial value of the access information may include an initial value of flag information related to the sample in the fragment movie (default sample flag information (default_sample_flags)). With such a configuration, the reproduction device 400 can suppress an increase in the amount of data.

### Reproduction Processing Flow 1

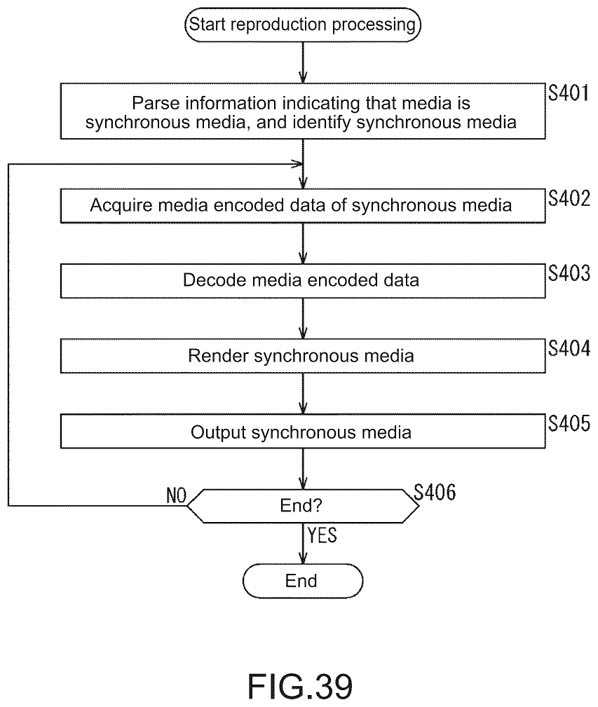

Next, the reproduction processing executed by the reproduction device 400 will be described. An example of a flow of the reproduction processing in the case of a synchronous media will be described with reference to the flowchart shown in FIG. 39. This flow of the reproduction processing can be applied to the case of any of Methods 1, 2, and 3.

The reproduction device 400 executes the reproduction processing on a container file acquired by the communication unit 411. When the reproduction processing is started, in Step S401, the parse processing unit 412 of the reproduction device 400 parses information that is stored in the container file and indicates that a media is a synchronous media, and identifies the synchronous media.

In Step S402, the media acquisition unit 413 acquires media encoded data of the identified synchronous media, that is stored in the container file.

In Step S403, the decoding unit 414 decodes the acquired media encoded data to generate media data of the synchronous media.

In Step S404, the output control unit 415 renders the synchronous media to generate output information.

In Step S405, the output control unit 415 supplies the output information to the output unit 416 and causes the output unit 416 to output the output information. Based on this control, the output unit 416 outputs the synchronous media using an output device that supports the media.

In Step S406, the media acquisition unit 413 determines whether or not to end the reproduction processing. When there is an unprocessed synchronous media and it is thus determined that the reproduction processing is not to be ended, the processing returns to Step S402, and the subsequent processing is executed.

On the other hand, when it is determined in Step S406 that the reproduction processing is to be ended, the reproduction processing ends.

### Reproduction Processing Flow 2

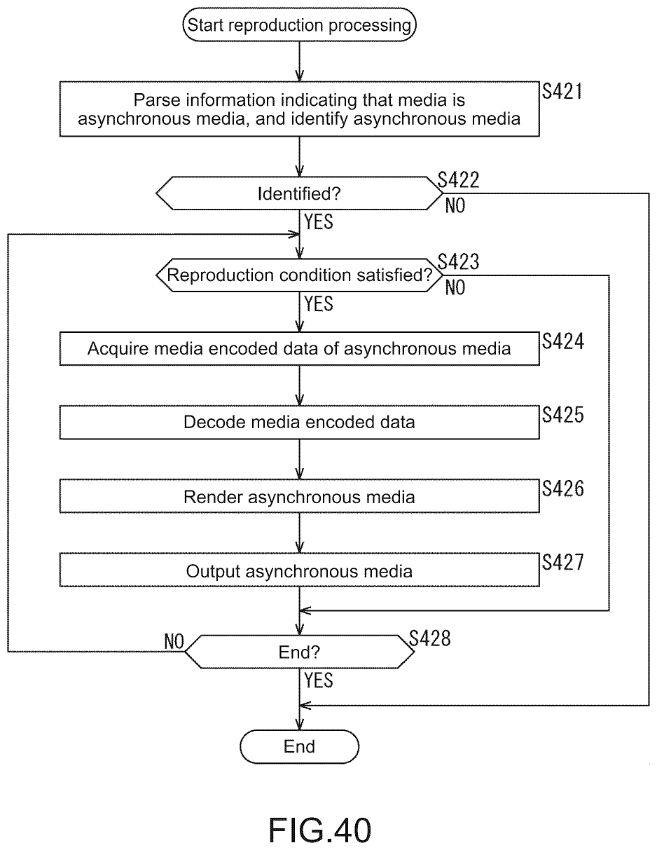

Next, an example of a flow of the reproduction processing in a case where the media is an asynchronous media and Method 1 is applied will be described with reference to the flowchart shown in FIG. 40.

The reproduction device 400 executes the reproduction processing on a container file acquired by the communication unit 411. When the reproduction processing is started, in Step S421, the parse processing unit 412 of the reproduction device 400 parses information indicating that the media is an asynchronous media, that is stored in the container file, and identifies the asynchronous media. For example, the parse processing unit 412 may parse asynchronous media information that is stored in a handler box of the container file and indicates that media encoded data stored in the container file is of an asynchronous media to be reproduced asynchronously. Alternatively, the parse processing unit 412 may parse an essential track reference that is stored in the container file, indicates that the media data is of the asynchronous media by a reference relationship between tracks, and requires parsing for reproducing the asynchronous media.

In Step S422, the parse processing unit 412 determines whether or not the asynchronous media has been identified. When the parsing is executed correctly and it is determined that the asynchronous media has been identified, the processing proceeds to Step S423.

In Step S423, the media acquisition unit 413 determines whether or not a reproduction condition of the asynchronous media is satisfied. For example, when it is determined that a predetermined reproduction condition is satisfied, such as an occurrence of a predetermined event, the processing proceeds to Step S424.

In Step S424, the media acquisition unit 413 acquires media encoded data of the identified asynchronous media, that is stored in the container file.

In Step S425, the decoding unit 414 decodes the acquired media encoded data to generate media data of the asynchronous media. That is, the decoding unit 414 decodes the media encoded data stored in the container file in accordance with a result of the parsing result and the reproduction condition, to generate media data of the asynchronous media to be reproduced asynchronously.

In Step S426, the output control unit 415 renders the asynchronous media to generate output information.

In Step S427, the output control unit 415 supplies the output information to the output unit 416, and causes the output unit 416 to output the output information. Based on this control, the output unit 416 outputs the asynchronous media using an output device that supports the media.

When the processing of Step S427 ends, the processing proceeds to Step S428. When it is determined in Step S423 that the reproduction condition of the asynchronous media is not satisfied, such as a case where a predetermined event has not occurred, for example, the processing of Steps S424 to S427 is skipped, and the processing proceeds to Step S428.

In Step S428, the media acquisition unit 413 determines whether or not to end the reproduction processing. When there is an unprocessed synchronous media and it is thus determined that the reproduction processing is not to be ended, the processing returns to Step S423, and the subsequent processing is executed.

On the other hand, when it is determined in Step S428 that the reproduction processing is to be ended, the reproduction processing ends. Further, when it is determined in Step S422 that the parsing has been unable to be executed correctly and it has been impossible to identify the asynchronous media, such as a case where incomprehensible information is detected, for example, the reproduction processing ends.

By executing each processing in this manner, the reproduction device 400 can suppress unauthorized reproduction of the asynchronous media.

### Reproduction Processing Flow 3

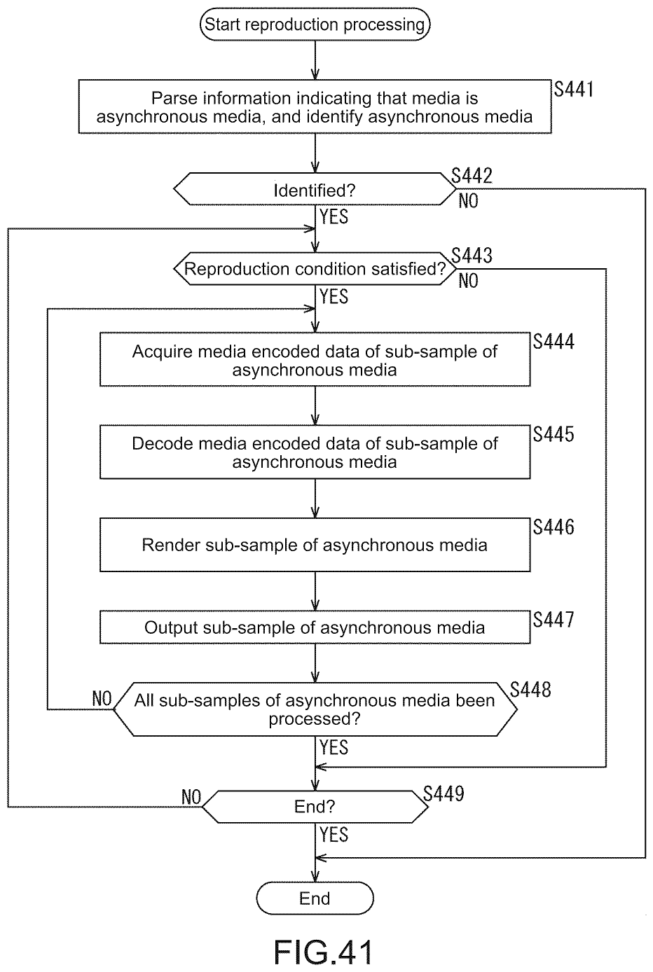

Next, an example of a flow of the reproduction processing in a case where the media is an asynchronous media and Method 2 is applied will be described with reference to the flowchart shown in FIG. 41.

The reproduction device 400 executes the reproduction processing on a container file acquired by the communication unit 411. When the reproduction processing is started, in Step S441, the parse processing unit 412 of the reproduction device 400 parses information related to media encoded data of an asynchronous media to be reproduced asynchronously, that is stored in the container file, and identifies the asynchronous media.

In Step S442, the parse processing unit 412 determines whether or not the asynchronous media has been identified. When the parsing is executed correctly and it is thus determined that the asynchronous media has been identified, the processing proceeds to Step S443.

In Step S443, the media acquisition unit 413 determines whether or not a reproduction condition of the asynchronous media is satisfied. For example, when it is determined that a predetermined reproduction condition is satisfied, such as an occurrence of a predetermined event, the processing proceeds to Step S444.

In Step S444, the media acquisition unit 413 acquires media encoded data of a sub-sample of the identified asynchronous media, that is stored in the container file.

In Step S445, the decoding unit 414 decodes the acquired media encoded data to generate media data of the sub-sample of the asynchronous media. That is, the decoding unit 414 decodes the media encoded data stored in the container file as one metadata in accordance with a result of the parsing and the reproduction condition, to generate media data of the asynchronous media, that is constituted of a plurality of samples.

In Step S446, the output control unit 415 renders the sub-sample of the asynchronous media to generate output information.

In Step S447, the output control unit 415 supplies the output information to the output unit 416, and causes the output unit 416 to output the output information. Based on this control, the output unit 416 outputs the sub-sample of the asynchronous media using an output device that supports the media.

In Step S448, the media acquisition unit 413 determines whether all of the sub-samples of the asynchronous media have been processed. When it is determined that there is an unprocessed sub-sample, the processing returns to Step S444, and the subsequent processing is executed. On the other hand, when it is determined in Step S448 that all of the sub-samples of the asynchronous media have been processed, the processing proceeds to Step S449.

Further, when it is determined in Step S443 that the reproduction condition of the asynchronous media is not satisfied, such as a case where a predetermined event has not occurred, for example, the processing of Steps S444 to S448 is skipped, and the processing proceeds to Step S449.

In Step S449, the media acquisition unit 413 determines whether or not to end the reproduction processing. When there is an unprocessed synchronous media and it is thus determined that the reproduction processing is not to be ended, the processing returns to Step S443, and the subsequent processing is executed.

On the other hand, when it is determined in Step S449 that the reproduction processing is to be ended, the reproduction processing ends. Further, when it is determined in Step S442 that the parsing has been unable to be executed correctly and it has been impossible to identify the asynchronous media, such as a case where incomprehensible information is detected, for example, the reproduction processing ends.

By executing each processing in this manner, the reproduction device 400 can suppress an increase in the load of the reproduction processing as compared to the case of the management by tracks.

### Reproduction Processing Flow 4

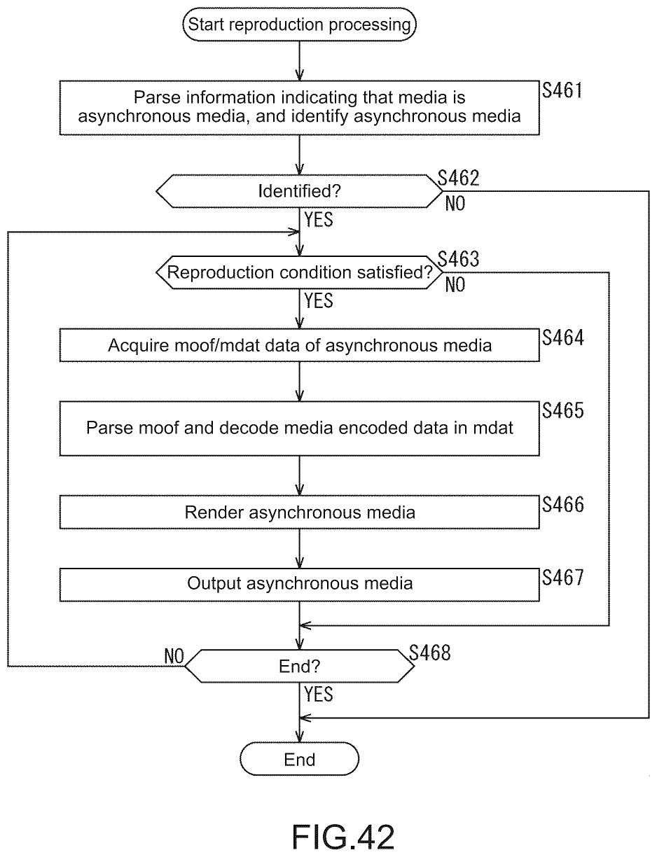

Next, an example of a flow of the reproduction processing in a case where the media is an asynchronous media and Method 3 is applied will be described with reference to the flowchart shown in FIG. 42.

The reproduction device 400 executes the reproduction processing on a container file acquired by the communication unit 411. When the reproduction processing is started, in Step S461, the parse processing unit 412 of the reproduction device 400 parses information related to media encoded data of an asynchronous media to be reproduced asynchronously, that is stored in the container file, and identifies the asynchronous media.

In Step S462, the parse processing unit 412 determines whether or not the asynchronous media has been identified. When the parsing is executed correctly and it is thus determined that the asynchronous media has been identified, the processing proceeds to Step S463.

In Step S463, the media acquisition unit 413 determines whether or not a reproduction condition of the asynchronous media is satisfied. For example, when it is determined that a predetermined reproduction condition is satisfied, such as an occurrence of a predetermined event, the processing proceeds to Step S464.

In Step S464, the media acquisition unit 413 acquires moof data and mdat data (media encoded data) of the identified asynchronous media, that are stored in the container file.

In Step S465, the decoding unit 414 parses the acquired moof data, and decodes the media encoded data in mdat based on a result of the parsing, to generate media data of the asynchronous media (samples of a fragment movie). That is, the decoding unit 414 decodes the media encoded data stored in the container file as one metadata in accordance with the result of the parsing and the reproduction condition, to generate a fragment movie that stores the media data of the asynchronous media, that is constituted of a plurality of samples.

In Step S466, the output control unit 415 renders the asynchronous media (the samples of the fragment movie) to generate output information.

In Step S467, the output control unit 415 supplies the output information to the output unit 416, and causes the output unit 416 to output the output information. Based on this control, the output unit 416 outputs the asynchronous media (the samples of the fragment movie) using an output device that supports the media.

When the processing of Step S467 ends, the processing proceeds to Step S468. Further, when it is determined in Step S463 that the reproduction condition of the asynchronous media is not satisfied, such as a case where a predetermined event has not occurred, for example, the processing of Steps S464 to S467 is skipped, and the processing proceeds to Step S468.

In Step S468, the media acquisition unit 413 determines whether or not to end the reproduction processing. When there is an unprocessed synchronous media and it is thus determined that the reproduction processing is not to be ended, the processing returns to Step S463, and the subsequent processing is executed.

On the other hand, when it is determined in Step S468 that the reproduction processing is to be ended, the reproduction processing ends. Further, when it is determined in Step S462 that the parsing has been unable to be executed correctly and it has been impossible to identify the asynchronous media, such as a case where incomprehensible information is detected, for example, the reproduction processing ends.

By executing each processing in this manner, the reproduction device 400 can suppress an increase in the load of the reproduction processing as compared to the case of the management by tracks. In addition, an increase in costs can be suppressed. In addition, a decrease in versatility can be suppressed.

### 12. Notes

### Computer

The series of processing described above can be executed by hardware or can be executed by software. When the series of processing is executed by software, a program configuring the software is installed in a computer. Herein, the computer includes a computer incorporated into dedicated hardware, a general-purpose personal computer, for example, that is capable of installing various programs therein to execute various functions, and the like.

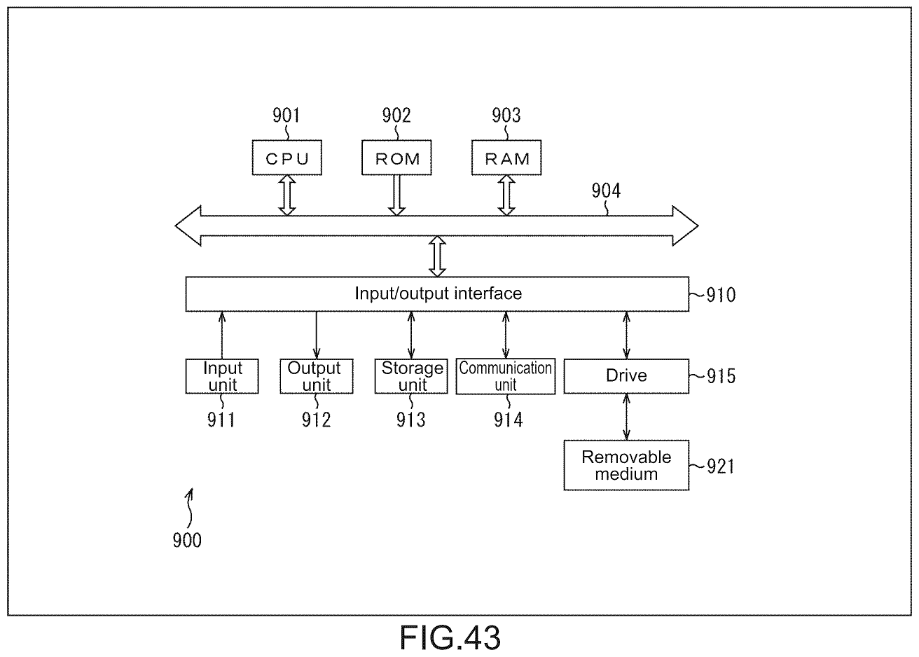

FIG. 43 is a block diagram showing a hardware configuration example of a computer that executes the series of processing described above by a program.

In a computer 900 shown in FIG. 43, a CPU (Central Processing Unit) 901, a ROM (Read Only Memory) 902, and a RAM (Random Access Memory) 903 are mutually connected via a bus 904.

An input/output interface 910 is also connected to the bus 904. Connected to the input/output interface 910 are an input unit 911, an output unit 912, a storage unit 913, a communication unit 914, and a drive 915.

The input unit 911 is constituted of, for example, a keyboard, a mouse, a microphone, a touch panel, an input terminal, and the like. The output unit 912 is constituted of, for example, a display, a speaker, an output terminal, and the like. The storage unit 913 is constituted of, for example, a hard disk, a RAM disk, a nonvolatile memory, and the like. The communication unit 914 is constituted of, for example, a network interface. The drive 915 drives a removable medium 921 such as a magnetic disc, an optical disc, a magneto optical disc, or a semiconductor memory.

In the computer configured as described above, the CPU 901 loads a program stored in the storage unit 913 into the RAM 903 via the input/output interface 910 and the bus 904 and executes it, to carry out the series of processing described above, for example. Data required for the CPU 901 to execute various types of processing, and the like are also stored in the RAM 903 as appropriate.

The program executed by the computer can be applied by being recorded onto the removable medium 921 as a package medium or the like, for example. In that case, the program can be installed in the storage unit 913 via the input/output interface 910 by loading the removable medium 921 into the drive 915.

Further, this program can also be provided via wired or wireless transmission media such as a local area network, the Internet, and digital satellite broadcasting. In that case, the program can be received by the communication unit 914 to be installed in the storage unit 913.

Alternatively, this program can be installed in advance in the ROM 902 or the storage unit 913. A container file that is generated by the file generation unit described above and stores media data and metadata can be provided to the reproduction device via wired or wireless transmission media such as a local area network, the Internet, and digital satellite broadcasting. Moreover, after being generated, the container file can also be stored in, directly or via the transmission medium, a non-volatile storage medium such as a hard disk, an optical disk, or a flash memory, or an electronic device having the non-volatile storage medium incorporated therein.

### Applicable Target of Present Technology

The present technology can be applied to arbitrary encoding/decoding methods.

The present technology can also be applied to arbitrary configurations. For example, the present technology may be applied to various electronic devices.

Moreover, for example, the present technology can be executed as a partial configuration of an apparatus, such as a processor as a system LSI (Large Scale Integration) or the like (e.g., video processor), a module that uses a plurality of processors and the like (e.g., video module), a unit that uses a plurality of modules and the like (e.g., video unit), or a set obtained by adding other functions to the unit (e.g., video set). In particular, the respective units shown in FIG. 34 such as the preprocessing unit, the encoding unit, and the file generation unit and the respective units shown in FIG. 38 such as the parse processing unit, the media acquisition unit, and the decoding unit may each be configured as independent modules or processors, or one or a plurality of modules or processors may be configured to perform the processing of the plurality of units.

Further, for example, the present technology can also be applied to a network system constituted of a plurality of apparatuses. For example, the present technology may be executed as cloud computing in which the plurality of apparatuses share and cooperate to process via a network. For example, the present technology may be executed in, for example, a cloud service that provides a service related to images (moving images) to an arbitrary terminal such as a computer, an AV (Audio Visual) apparatus, a mobile information processing terminal, and an IoT (Internet of Things) device.

It is noted that in the present specification, the system refers to an aggregation of a plurality of constituent elements (apparatuses, modules (components), and the like), and whether or not all of the constituent elements are within the same housing is irrelevant. Accordingly, a plurality of apparatuses that are housed in separate housings and are connected via a network and a single apparatus in which a plurality of modules are housed in a single housing are both systems.

### Fields/Uses to Which Present Technology can be Applied

The systems, apparatuses, processing units, and the like to which the present technology is applied can be used in arbitrary fields of, for example, traffic, medical care, crime prevention, agriculture, livestock business, mining, beauty care, industrial plants, home electrical appliance, weather, natural surveillance, and the like. In addition, uses thereof are also arbitrary.

For example, the present technology can be applied to systems and devices used for providing contents to be viewed, and the like. Further, for example, the present technology can also be applied to systems and devices used for traffic, such as monitoring of traffic conditions and automated driving control. Furthermore, for example, the present technology can also be applied to systems and devices used for security. Furthermore, for example, the present technology can also be applied to systems and devices used for automatic control of machines and the like. Furthermore, for example, the present technology can also be applied to systems and devices used for agriculture and livestock business. Furthermore, for example, the present technology can also be applied to systems and devices that monitor states of nature, such as volcanoes, forests, and oceans, wildlife, and the like. Furthermore, for example, the present technology can also be applied to systems and devices used for sports.

### Others

It is noted that “flag” used in the present specification is information for identifying a plurality of states and includes not only information used when identifying two states of true (1) and false (0) but also information with which three or more states can be identified. Accordingly, values that this “flag” may take may be, for example, binary as in 1/0 or ternary or more. In other words, a bit count configuring this “flag” is arbitrary and may be 1 bit or a plurality of bits. Further, since identification information (also including flag) may take not only a form in which the identification information is incorporated in a bit stream but also a form in which differential information of the identification information with respect to certain information that becomes a reference is incorporated in a bit stream, in the present specification, the “flag” or “identification information” includes not only that information but also differential information with respect to information that becomes a reference.

In addition, various types of information (metadata etc.) related to encoded data (bit stream) may be transmitted or recorded in any form as long as the information is associated with the encoded data. Herein, the term “associate” means enabling, when processing one of the data, the other data to be used (to be linked). In other words, the data associated with each other may be compiled as one piece of data or may each be regarded as individual data. For example, information associated with encoded data (image) may be transmitted on a transmission path different from that of the encoded data (image). Further, for example, information associated with encoded data (image) may be recorded on a recording medium different from that of the encoded data (image) (or in a different recording area in the same recording medium). It is noted that this “associate” may be applied to not only the entire data but also a part of the data. For example, an image and information corresponding to the image may be associated with each other in an arbitrary unit including a plurality of frames, one frame, one portion in a frame, or the like.

It is noted that in the present specification, the terms “synthesize”, “multiplex”, “add”, “integrate”, “incorporate”, “store”, “put into”, “inset”, “insert”, and the like mean compiling a plurality of objects into one, such as compiling encoded data and metadata into one piece of data, for example, and refer to one method of “associate” described above.

Further, embodiments of the present technology are not limited to the embodiments described above and can be variously modified without departing from the gist of the present technology.

For example, the configuration described as one apparatus (or processing unit) may be divided to be configured as a plurality of apparatuses (or processing units). Conversely, the configuration described above as a plurality of apparatuses (or processing units) may collectively be configured as one apparatus (or processing unit). Furthermore, configurations other than those described above may of course be added to the configurations of the respective apparatuses (or the respective processing units). In addition, as long as configurations and operations as the entire system are substantially the same, a part of a configuration of a certain apparatus (or processing unit) may be incorporated into a configuration of another apparatus (or another processing unit).

Furthermore, for example, the program described above may be executed in an arbitrary apparatus. In that case, the apparatus only needs to have necessary functions (functional blocks etc.) so as to be capable of acquiring necessary information.

Moreover, for example, respective steps of a single flowchart may be executed by a single apparatus, or may be shared by a plurality of apparatuses to be executed. In addition, when a plurality of processing is included in a single step, the plurality of processing may be executed by a single apparatus, or may be shared by a plurality of apparatuses to be executed. In other words, the plurality of processing included in a single step can be executed as processing of a plurality of steps. Conversely, processing described as a plurality of steps can collectively be executed as a single step.

Furthermore, for example, regarding the program executed by the computer, the processing of the steps describing the program may be executed in time series in the order described in the present specification, or may be executed in parallel or individually at necessary timings, such as when invoked. In other words, as long as no contradiction is caused, the processing of the respective steps may be executed in an order different from the order described above. In addition, the processing of the steps describing the program may be executed in parallel with processing of other programs, or may be executed in combination with the processing of other programs.

Further, for example, as long as no contradiction is caused, the plurality of technologies related to the present technology can each be executed independently and individually. Of course, a plurality of arbitrary present technologies can be executed in combination. For example, a part or all of the present technology described in any of the embodiments can be executed in combination with a part or all of the present technology described in the other embodiments. Moreover, a part or all of the arbitrary present technology described above can be executed in combination with other technologies not described above.

It is noted that the present technology can also take the following configurations.
(1) An information processing apparatus, including:
   an encoding unit which encodes media data of an asynchronous media to be reproduced asynchronously, to generate media encoded data; and
   a file generation unit which generates a container file and stores the media encoded data and asynchronous media information in the container file, in which
   the asynchronous media information indicates that the media data is of the asynchronous media, and requires parsing for reproducing the asynchronous media.
(2) An information processing method, including:
   encoding media data of an asynchronous media to be reproduced asynchronously, to generate media encoded data; and
   generating a container file and storing the media encoded data and asynchronous media information in the container file, in which
   the asynchronous media information indicates that the media data is of the asynchronous media, and requires parsing for reproducing the asynchronous media.
(11 ) An information processing apparatus, including:
   a parse processing unit which parses asynchronous media information stored in a container file;
   a decoding unit which decodes media encoded data stored in the container file in accordance with a result of the parsing and a reproduction condition, to generate media data of an asynchronous media to be reproduced asynchronously; and
   an output control unit which renders the media data to generate output information, and causes an output unit to output the output information, as reproduction of the asynchronous media, in which
   the asynchronous media information indicates that the media data is of the asynchronous media, and requires the parsing for reproducing the asynchronous media.
(12) The information processing apparatus according to (11), in which
   the parse processing unit determines whether or not the asynchronous media information can be parsed, and when the asynchronous media information cannot be parsed, omits reproduction of the asynchronous media.
(13) An information processing method, including:
   parsing asynchronous media information stored in a container file;
   decoding media encoded data stored in the container file in accordance with a result of the parsing and a reproduction condition, to generate media data of an asynchronous media to be reproduced asynchronously; and
   rendering the media data to generate output information, and causing the output information to be output, as reproduction of the asynchronous media, in which
   the asynchronous media information indicates that the media data is of the asynchronous media, and requires the parsing for reproducing the asynchronous media.
(21 ) An information processing apparatus, including:
   an encoding unit which encodes media data of an asynchronous media to be reproduced asynchronously, to generate media encoded data; and
   a file generation unit which generates a container file, stores the media encoded data in the container file, and further stores asynchronous media information that indicates that the media data is of the asynchronous media in a handler box of the container file. (22) The information processing apparatus according to
(21), in which
   the file generation unit stores the asynchronous media information in the handler box as information indicating a handler type common to media types.
(23) The information processing apparatus according to (21) or (22), in which
   the file generation unit stores the asynchronous media information in the handler box as information indicating a handler type of each media type.
(24) An information processing method, including:
   encoding media data of an asynchronous media to be reproduced asynchronously, to generate media encoded data; and
   generating a container file, storing the media encoded data in the container file, and further storing asynchronous media information that indicates that the media data is of the asynchronous media in a handler box of the container file.
(31 ) An information processing apparatus, including:
   a parse processing unit which parses asynchronous media information that is stored in a handler box of a container file and indicates that media encoded data stored in the container file is an asynchronous media to be reproduced asynchronously;
   a decoding unit which decodes the media encoded data in accordance with a result of the parsing and a reproduction condition, to generate media data of the asynchronous media; and
   an output control unit which renders the media data to generate output information, and causes an output unit to output the output information, as reproduction of the asynchronous media.
(32) The information processing apparatus according to (31), in which
   the parse processing unit parses the asynchronous media information stored in the handler box as information indicating a handler type common to media types.
(33) The information processing apparatus according to (31) or (32), in which
   the parse processing unit parses the asynchronous media information stored in the handler box as information indicating a handler type of each media type.
(34) An information processing method, including:
   parsing asynchronous media information that is stored in a handler box of a container file and indicates that media encoded data stored in the container file is an asynchronous media to be reproduced asynchronously;
   decoding the media encoded data in accordance with a result of the parsing and a reproduction condition, to generate media data of the asynchronous media; and
   rendering the media data to generate output information, and causing the output information to be output, as reproduction of the asynchronous media.
(41 ) An information processing apparatus, including:
   an encoding unit which encodes media data of an asynchronous media to be reproduced asynchronously, to generate media encoded data; and
   a file generation unit which generates a container file and stores the media encoded data and an essential track reference in the container file, in which
   the essential track reference indicates that the media data is of the asynchronous media by a reference relationship between tracks, and requires parsing for reproducing the asynchronous media.
(42) The information processing apparatus according to (41), in which
   the file generation unit stores, in the container file, the essential track reference specifying an index that indicates a track reference type indicating that the media data is of the asynchronous media.
(43) The information processing apparatus according to (42), in which
   the file generation unit stores, when all track reference types need to be referenced, the essential track reference for which the specifying of the index has been omitted in the container file.
(44) The information processing apparatus according to (42) or (43), in which
   the file generation unit further sets flag information of a sample group description box of the essential track reference so as to indicate that the essential track reference is information of an entire track.
(45) The information processing apparatus according to (44), in which
   the file generation unit sets values of statci_group_description and static_mapping, which are the flag information, to “1”.
(46) The information processing apparatus according to any one of (41) to (45), in which
   the file generation unit stores, in the container file, the essential track reference that stores a track reference type indicating that the media data is of the asynchronous media.
(47) The information processing apparatus according to (46), in which
   the file generation unit further sets flag information of a sample group description box of the essential track reference so as to indicate that the essential track reference is information of an entire track.
(48) The information processing apparatus according to (47), in which
   the file generation unit sets the values of statci_group_description and static_mapping, which are the flag information, to “1”.
(49) An information processing method, including:
   encoding media data of an asynchronous media to be reproduced asynchronously, to generate media encoded data; and
   generating a container file and storing the media encoded data and an essential track reference in the container file, in which
   the essential track reference indicates that the media data is of the asynchronous media by a reference relationship between tracks, and requires parsing for reproducing the asynchronous media.
(50 ) An information processing apparatus, including:
   a parse processing unit which parses an essential track reference stored in a container file;
   a decoding unit which decodes media encoded data stored in the container file in accordance with a result of the parsing and a reproduction condition, to generate media data of an asynchronous media to be reproduced asynchronously; and
   an output control unit which renders the media data to generate output information, and causes an output unit to output the output information, as reproduction of the asynchronous media, in which
   the essential track reference indicates that the media data is of the asynchronous media by a reference relationship between tracks, and requires the parsing for reproducing the asynchronous media.
(52) The information processing apparatus according to (51), in which
   the parse processing unit parses a track reference of a type corresponding to an index specified in the essential track reference.
(53) The information processing apparatus according to (52), in which
   the parse processing unit parses all types of track references when the specifying of the index is omitted in the essential track reference.
(54) The information processing apparatus according to (52) or (53), in which
   the parse processing unit parses flag information of a sample group description box of the essential track reference.
(55) The information processing apparatus according to (54), in which
   the parse processing unit parses statci_group_description and static_mapping, which are the flag information.
(56) The information processing apparatus according to any one of (51) to (55), in which
   the parse processing unit parses the track reference stored in the essential track reference.
(57) The information processing apparatus according to (56), in which
   the parse processing unit parses the flag information of the sample group description box of the essential track reference.
(58) The information processing apparatus according to (57), in which
   the parse processing unit parses statci_group_description and static_mapping, which are the flag information.
(59) An information processing method, including:
   parsing an essential track reference stored in a container file;
   decoding media encoded data stored in the container file in accordance with a result of the parsing and a reproduction condition, to generate media data of an asynchronous media to be reproduced asynchronously; and
   rendering the media data to generate output information, and causing the output information to be output, as reproduction of the asynchronous media, in which
   the essential track reference indicates that the media data is of the asynchronous media by a reference relationship between tracks, and requires the parsing for reproducing the asynchronous media.
(61 ) An information processing apparatus, including:
   an encoding unit which encodes media data of an asynchronous media to be reproduced asynchronously, that is constituted of a plurality of samples, to generate media encoded data; and
   a file generation unit which generates a container file and stores the media encoded data in the container file as one metadata.
(62) The information processing apparatus according to (61), in which
   the file generation unit adds, as a property of the metadata, time information related to a time of a sub-sample of the metadata and access information used when accessing the sub-sample.
(63) The information processing apparatus according to (62), in which
   the time information includes information indicating a duration of the sub-sample.
(64) The information processing apparatus according to (62) or (63), in which
   the access information includes information indicating a size of the sub-sample.
(65) The information processing apparatus according to any one of (62) to (64), in which
   the access information includes flag information related to the sub-sample.
(66) The information processing apparatus according to any one of (62) to (65), in which
   the file generation unit adds, as the property, an initial value of the time information and an initial value of the access information.
(67) The information processing apparatus according to (66), in which
   the initial value of the time information includes an initial value of the information indicating the duration of the sub-sample.
(68) The information processing apparatus according to (66) or (67), in which
   the initial value of the access information includes an initial value of the information indicating the size of the sub-sample.
(69) The information processing apparatus according to any one of (66) to (68), in which
   the initial value of the access information includes an initial value of the flag information related to the sub-sample.
(70) An information processing method, including:
   encoding media data of an asynchronous media to be reproduced asynchronously, that is constituted of a plurality of samples, to generate media encoded data; and
   generating a container file and storing the media encoded data in the container file as one metadata.
(81 ) An information processing apparatus, including:
   a parse processing unit which parses information related to media encoded data of an asynchronous media to be reproduced asynchronously, that is stored in a container file;
   a decoding unit which decodes the media encoded data stored in the container file as one metadata in accordance with a result of the parsing and a reproduction condition, to generate media data of the asynchronous media, that is constituted of a plurality of samples; and
   an output control unit which renders the media data to generate output information, and causes an output unit to output the output information, as reproduction of the asynchronous media.
(82) The information processing apparatus according to (81), in which
   the parse processing unit parses time information related to a time of a sub-sample of the metadata and access information used when accessing the sub-sample, that have been added as a property of the metadata.
(83) The information processing apparatus according to (82), in which
   the time information includes information indicating a duration of the sub-sample.
(84) The information processing apparatus according to (82) or (83), in which
   the access information includes information indicating a size of the sub-sample.
(85) The information processing apparatus according to any one of (82) to (84), in which
   the access information includes flag information related to the sub-sample.
(86) The information processing apparatus according to any one of (82) to (85), in which
   the parse processing unit parses an initial value of the time information and an initial value of the access information that have been added as the property.
(87) The information processing apparatus according to (86), in which
   the initial value of the time information includes an initial value of the information indicating the duration of the sub-sample.
(88) The information processing apparatus according to (86) or (87), in which
   the initial value of the access information includes an initial value of the information indicating the size of the sub-sample.
(89) The information processing apparatus according to any one of (86) to (88), in which
   the initial value of the access information includes an initial value of the flag information related to the sub-sample.
(90) An information processing method, including:
   parsing information related to media encoded data of an asynchronous media to be reproduced asynchronously, that is stored in a container file;
   decoding the media encoded data stored in the container file as one metadata in accordance with a result of the parsing and a reproduction condition, to generate media data of the asynchronous media, that is constituted of a plurality of samples; and
   rendering the media data to generate output information, and causing the output information to be output, as reproduction of the asynchronous media.
(101 ) An information processing apparatus, including:
   an encoding unit which encodes a fragment movie that stores media data of an asynchronous media to be reproduced asynchronously, that is constituted of a plurality of samples, to generate media encoded data; and
   a file generation unit which generates a container file and stores the media encoded data in the container file as one metadata.
(102) The information processing apparatus according to (101), in which
   the file generation unit adds, as a property of the metadata, an initial value of time information related to a time of the sample in the fragment movie and an initial value of access information used when accessing the sample in the fragment movie.
(103) The information processing apparatus according to (102), in which
   the initial value of the time information includes an initial value of information indicating a duration of the sample in the fragment movie.
(104) The information processing apparatus according to (102) or (103), in which
   the initial value of the access information includes an initial value of an index indicating a sample entry describing the sample in a track fragment.
(105) The information processing apparatus according to any one of (102) to (104), in which
   the initial value of the access information includes an initial value of information indicating a size of the sample in the fragment movie.
(106) The information processing apparatus according to any one of (102) to (105), in which
   the initial value of the access information includes an initial value of flag information related to the sample in the fragment movie.
(107) An information processing method, including:
   encoding a fragment movie that stores media data of an asynchronous media to be reproduced asynchronously, that is constituted of a plurality of samples, to generate media encoded data; and
   generating a container file and storing the media encoded data in the container file as one metadata.
(111 ) An information processing apparatus, including:
   a parse processing unit which parses information related to media encoded data of an asynchronous media to be reproduced asynchronously, that is stored in a container file;
   a decoding unit which decodes the media encoded data stored in the container file as one metadata in accordance with a result of the parsing and a reproduction condition, to generate a fragment movie that stores media data of the asynchronous media, that is constituted of a plurality of samples; and
   an output control unit which renders the fragment movie to generate output information, and causes an output unit to output the output information, as reproduction of the asynchronous media.
(112) The information processing apparatus according to (111), in which
   the parse processing unit parses time information related to a time of the sample in the fragment movie and access information used when accessing the sample in the fragment movie, that have been added as a property of the metadata.
(113) The information processing apparatus according to (112), in which
   an initial value of the time information includes an initial value of information indicating a duration of the sample in the fragment movie.
(114) The information processing apparatus according to (112) or (113), in which
   an initial value of the access information includes an initial value of an index indicating a sample entry describing the sample in a track fragment.
(115) The information processing apparatus according to any one of (112) to (114), in which
   the initial value of the access information includes an initial value of information indicating a size of the sample in the fragment movie.
(116) The information processing apparatus according to any one of (112) to (115), in which
   the initial value of the access information includes an initial value of flag information related to the sample in the fragment movie.
(117) An information processing method, including:
   parsing information related to media encoded data of an asynchronous media to be reproduced asynchronously, that is stored in a container file;
   decoding the media encoded data stored in the container file as one metadata in accordance with a result of the parsing and a reproduction condition, to generate a fragment movie that stores media data of the asynchronous media, that is constituted of a plurality of samples; and
   rendering the fragment movie to generate output information, and causing the output information to be output, as reproduction of the asynchronous media.

### REFERENCE SIGNS LIST

300 file generation device
311 input unit
312 preprocessing unit
313 encoding unit
314 file generation unit
315 storage unit
316 communication unit
400 reproduction device
411 communication unit
412 parse processing unit
413 media acquisition unit
414 decoding unit
415 output control unit
416 output unit
900 computer

1. An information processing apparatus, comprising:
an encoding unit which encodes media data of an asynchronous media to be reproduced asynchronously, to generate media encoded data; and
a file generation unit which generates a container file and stores the media encoded data and asynchronous media information in the container file, wherein
the asynchronous media information indicates that the media data is of the asynchronous media, and requires parsing for reproducing the asynchronous media.

2. The information processing apparatus according to claim 1, wherein
the file generation unit stores the asynchronous media information in a handler box of the container file.

3. The information processing apparatus according to claim 2, wherein
the file generation unit stores the asynchronous media information in the handler box as information indicating a handler type common to media types.

4. The information processing apparatus according to claim 2, wherein
the file generation unit stores the asynchronous media information in the handler box as information indicating a handler type of each media type.

5. The information processing apparatus according to claim 1, wherein
the file generation unit stores an essential track reference in the container file as the asynchronous media information, and
the essential track reference indicates that the media data is of the asynchronous media by a reference relationship between tracks, and requires the parsing for reproducing the asynchronous media.

6. The information processing apparatus according to claim 5, wherein
the file generation unit stores, in the container file, the essential track reference specifying an index that indicates a track reference type indicating that the media data is of the asynchronous media.

7. The information processing apparatus according to claim 6, wherein
the file generation unit further sets flag information of a sample group description box of the essential track reference so as to indicate that the essential track reference is information of an entire track.

8. The information processing apparatus according to claim 5, wherein
the file generation unit stores, in the container file, the essential track reference that stores a track reference type indicating that the media data is of the asynchronous media.

9. The information processing apparatus according to claim 8, wherein
the file generation unit further sets flag information of a sample group description box of the essential track reference so as to indicate that the essential track reference is information of an entire track.

10. The information processing apparatus according to claim 1, wherein
the encoding unit encodes the media data of the asynchronous media, that is constituted of a plurality of samples, to generate the media encoded data, and
the file generation unit stores the media encoded data in the container file as one metadata.

11. The information processing apparatus according to claim 10, wherein
the file generation unit adds, as a property of the metadata, time information related to a time of a sub-sample of the metadata and access information used when accessing the sub-sample.

12. The information processing apparatus according to claim 11, wherein
the file generation unit adds, as the property, an initial value of the time information and an initial value of the access information.

13. The information processing apparatus according to claim 1, wherein
the encoding unit encodes a fragment movie that stores the media data of the asynchronous media, that is constituted of a plurality of samples, to generate the media encoded data, and
the file generation unit stores the media encoded data in the container file as one metadata.

14. The information processing apparatus according to claim 13, wherein
the file generation unit adds, as a property of the metadata, an initial value of time information related to a time of the sample in the fragment movie and an initial value of access information used when accessing the sample in the fragment movie.

15. An information processing method, comprising:
encoding media data of an asynchronous media to be reproduced asynchronously, to generate media encoded data; and
generating a container file and storing the media encoded data and asynchronous media information in the container file, wherein
the asynchronous media information indicates that the media data is of the asynchronous media, and requires parsing for reproducing the asynchronous media.

16. An information processing apparatus, comprising:
a parse processing unit which parses asynchronous media information stored in a container file;
a decoding unit which decodes media encoded data stored in the container file in accordance with a result of the parsing and a reproduction condition, to generate media data of an asynchronous media to be reproduced asynchronously; and
an output control unit which renders the media data to generate output information, and causes an output unit to output the output information, as reproduction of the asynchronous media, wherein
the asynchronous media information indicates that the media data is of the asynchronous media, and requires the parsing for reproducing the asynchronous media.

17. The information processing apparatus according to claim 16, wherein
the parse processing unit parses the asynchronous media information stored in a handler box of the container file.

18. The information processing apparatus according to claim 16, wherein
the parse processing unit parses an essential track reference stored in the container file as the asynchronous media information, and
the essential track reference indicates that the media data is of the asynchronous media by a reference relationship between tracks, and requires the parsing for reproducing the asynchronous media.

19. The information processing apparatus according to claim 16, wherein
the parse processing unit determines whether or not the asynchronous media information can be parsed, and when the asynchronous media information cannot be parsed, omits reproduction of the asynchronous media.

20. An information processing method, comprising:
parsing asynchronous media information stored in a container file;
decoding media encoded data stored in the container file in accordance with a result of the parsing and a reproduction condition, to generate media data of an asynchronous media to be reproduced asynchronously; and
rendering the media data to generate output information, and causing the output information to be output, as reproduction of the asynchronous media, wherein
the asynchronous media information indicates that the media data is of the asynchronous media, and requires the parsing for reproducing the asynchronous media.
